(19) United States
(12) Patent Application Publication
(10) Pub. No.: US 2026/0125496 A1
(43) Pub. Date: May 7, 2026

(54) MONOMERS AND CURABLE COMPOSITIONS FOR CRYSTALLINITY CONTROL IN POLYMERIC MATERIALS FOR 3D-PRINTED DENTAL DEVICES

(71) Applicant: Align Technology, Inc., San Jose, CA (US)

(72) Inventors: Michael Christopher Cole, San Jose, CA (US); Jenny Shao, San Jose, CA (US); Umesh Upendra Choudhary, Scotts Valley, CA (US)

(21) Appl. No.: 19/379,452

(22) Filed: Nov. 4, 2025

Related U.S. Application Data
(60) Provisional application No. 63/716,609, filed on Nov. 5, 2024.

(51) Int. Cl. C08F 20/30; A61C 7/08

(52) U.S. Cl. CPC C08F 20/30; A61C 7/08

(57) ABSTRACT

The present disclosure provides monomers and curable compositions comprising such monomers for preparing polymeric materials with controlled crystallinity. Orthodontic appliances made from these polymeric materials are also provided.

### PRIORITY CLAIM AND CROSS-REFERENCE

This application claims the benefit of U.S. Provisional Patent Application No. 63/716,609, filed Nov. 5, 2024, which is incorporated by reference herein in its entirety.

### BACKGROUND

Orthodontic procedures involve repositioning a patient's teeth to correct malocclusions and enhance aesthetics. This is typically accomplished using orthodontic appliances such as braces, retainers, and shell aligners, which guide the tooth through controlled movements. Periodic adjustments, often requiring modification or replacement of these appliances, are necessary to achieve optimal results. Polymeric materials play a crucial role in the fabrication of orthodontic appliances due to their ability to support controlled tooth repositioning. Polymeric materials that exhibit both stiffness and elasticity are particularly desirable, as are 3D printable resins suitable for producing such polymeric materials.

### BRIEF SUMMARY

Provided herein are monomers and curable compositions comprising such monomers, which enable control over the degree of crystallinity in the resulting polymeric materials. Also provided herein are methods for making orthodontic appliances using these compositions, as well as orthodontic appliances comprising polymeric materials with controlled crystallinity.

In one aspect, provided is a monomer having the following structure (I):

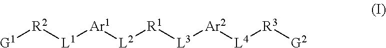

wherein Ar¹ and Ar² are independently an arylene or heteroarylene group; L¹ and L² are independently an ether or ester linkage; L³ and L⁴ are independently an ether or ester linkage; R¹ is an alkylene, cycloalkylene, heteroalklyene or heteroatomic linker, wherein the alkylene or heteroalkylene is optionally interrupted by —OC(O)O—, —C(O)—, —C(O)O—, arylene or heteroarylene; R² and R³ are independently an optional alkylene or heteroalklyene linker; and G¹ and G² are independently a reactive functional group comprising an ethylenically unsaturated moiety or a thiol moiety.

In some embodiments, Ar¹ and Ar² are independently phenylene, naphthalene, thienylene or furanylene. In some embodiments, L¹ and L² are the same or different. In some embodiments, L¹ and L² are each an ester linkage. In some embodiments, L¹ is an ether linkage, and L² is an ester linkage. In some embodiments, L¹ is an ester linkage, and L² is an ether linkage. In some embodiments, L³ and L⁴ are the same or different. In some embodiments, L³ and L⁴ are each an ester linkage. In some embodiments, L³ is an ether linkage, and L⁴ is an ester linkage. In some embodiments, L³ is an ester linkage, and L⁴ is an ether linkage.

In some embodiments, Ar¹ and Ar² are each phenylene, and L¹, L², L³, and L⁴ are each an ester linkage, the monomer having the following structure (IA):

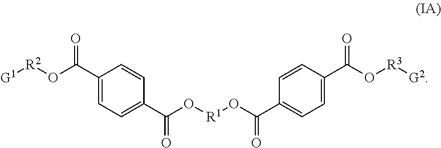

In some embodiments, Ar¹ and Ar² are each phenylene, L¹ and L⁴ are each an ether linkage, and L² and L³ are each an ester linkage, the monomer having the following structure (IB):

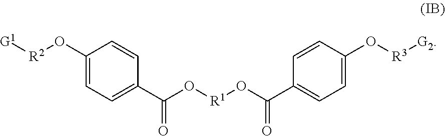

In some embodiments, Ar¹ and Ar² are each phenylene, L¹ and L⁴ are each an ester linkage, and L² and L³ are each an ether linkage, the monomer having the following structure (IC):

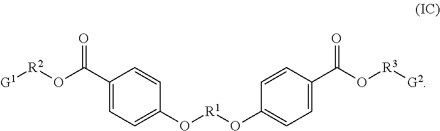

In some embodiments, R¹ is C₁₋₁₂ alkylene, wherein the C₂₋₁₂ alkylene is optionally interrupted by —OC(O)O—, —C(O)—, —C(O)O—, arylene or heteroarylene. In some embodiments, R¹ has one of the following structures:

—(CH₂)ₓ—; —(CH₂)_{y}—O—(CH₂)_{z}—; —(CH₂)_{y}—S—(CH₂)_{z}—;

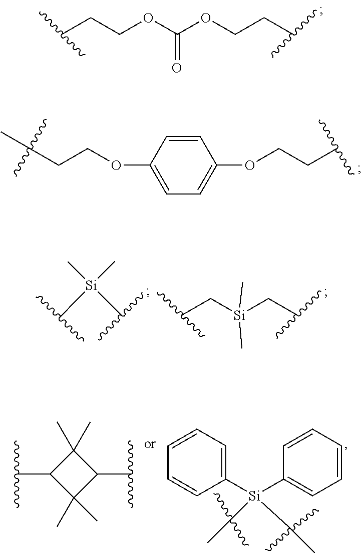

wherein x, y and z are independently an integer from 1 to 12.

In some embodiments, R² and R³ independently have one of the following structures:

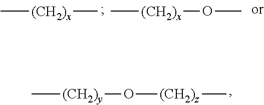

wherein x, y and z are independently an integer from 1 to 12.

In another aspect, provided is a monomer having the following structure (II):

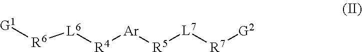

wherein Ar is an arylene or heteroarylene group; R⁴ and R⁵ are independently an optional alkylene linker; L⁶ and L⁷ are independently a carbonate, ether, or ester linkage; R⁶ and R⁷ are independently an optional alkylene or heteroalklyene linker, wherein the alkylene or heteroalkylene is optionally interrupted by —OC(O)O—, —C(O)— or —C(O)O—; and G¹ and G² are independently a reactive functional group comprising an ethylenically unsaturated moiety or a thiol moiety.

In some embodiments, Ar is phenylene, naphthalene, thienylene or furanylene. In some embodiments, R⁴ and R⁵ are each a direct bond. In some embodiments, R⁴ and R⁵ are each a linear or branched C₁₋₁₂ alkylene. In some embodiments, R⁴ and R⁵ are each methylene or (dimethyl)methylene. In some embodiments, L⁶ and L⁷ are the same.

In some embodiments, Ar is phenylene, R⁴ and R⁵ are each a direct bond, and L⁶ and L⁷ are each an ester linkage, the monomer having the following structure IIA):

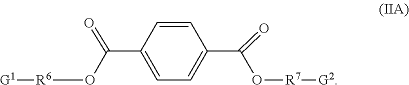

In some embodiments, Ar is phenylene, R⁴ and R⁵ are each a direct bond, and L⁶ and L⁷ are each an ether linkage, the monomer having the following structure (IIB):

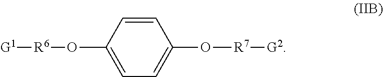

In some embodiments, Ar is phenylene, R⁴ and R⁵ are independently an optionally substituted linear or branched C₁₋₄ alkylene, and L⁶ and L⁷ are each a carbonate linkage, the monomer having the following structure (IIC):

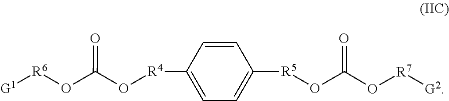

In some embodiments, R⁶ and R⁷ independently have one of the following structures:
—(CH₂)ₓ—; —(CH₂)_{y}—O—(CH₂)_{z}—;

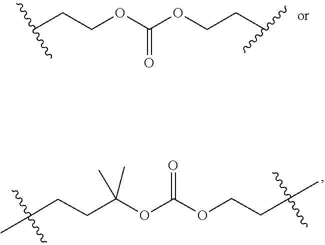

wherein x, y and z are independently an integer from 1 to 12.

In some embodiments, G¹ and G² each comprise an ethylenically unsaturated moiety. In some embodiments, G¹ and G² each comprise a thiol moiety. In some embodiments, G¹ comprises an ethylenically unsaturated moiety, and G² comprises a thiol moiety.

In some embodiments, G¹ and G² independently have one of the following structures:

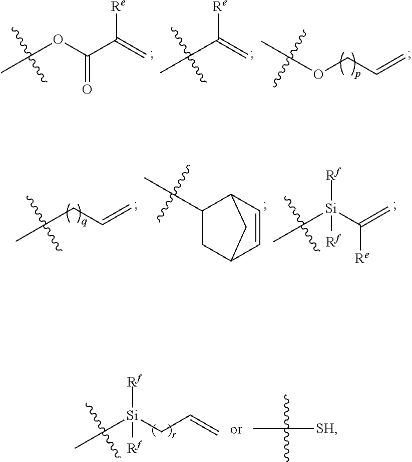

wherein R^{e}, at each occurrence, independently H, halogen or C₁-C₃ alkyl; R^{f}, at each occurrence, independently H, halogen, C₁-C₃ alkyl, C₁-C₆ alkoxy and aryl; and p, q and r are independently an integer from 1 to 6.

In some embodiments, G¹ and G² independently have one of the following structures:

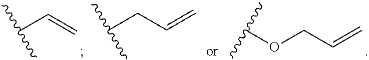

In some embodiments, G¹ and G² are each

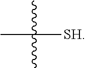 [SMILES: *S]

In some embodiments, G¹ is

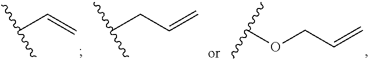

### and G² is

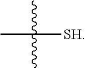 [SMILES: *S]

In some embodiments, the monomer is a compound selected from Table 1 or 2.

In still another aspect, provided is a curable composition comprising a monomer of structure (I) or (II).

In still another aspect, provided is a curable composition comprising a monomer having the following structure (III):

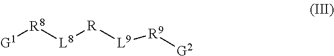

wherein R is an alkylene or heteroalkylene group; L⁸ and L⁹ are independently an optional carbonate, ether, or ester linkage; R⁸ and R⁹ are independently an optional alkylene or heteroalkylene linker; and G¹ and G² are independently a reactive functional group comprising an ethylenically unsaturated moiety or a thiol moiety.

In some embodiments, R⁸ and R⁹ are each a direct bond. In some embodiments, R⁸ and R⁹ are independently C₁₋₁₂ alkylene.

In some embodiments, L⁸ and L⁹ are each a carbonate linkage, and R⁸ and R⁹ are each a direct bond, the monomer having the following structure (IIIA):

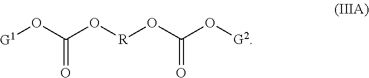

In some embodiments, L⁸ and L⁹ are each an ether linkage, and R⁸ and R⁹ are each a direct bond, the monomer having the following structure (IIIB):

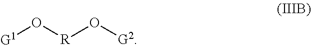

In some embodiments, is an optionally substituted linear or branched C₁₋₁₂ alkylene. In some embodiments, R has the following structure:

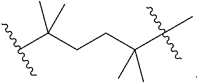 [SMILES: *C(C)(C)CCC(*)(C)C]

In some embodiments, G¹ and G² each comprise an ethylenically unsaturated moiety. In some embodiments, G¹ and G² each comprise a thiol moiety. In some embodiments, G¹ comprises an ethylenically unsaturated moiety, and G² comprises a thiol moiety. In some embodiments, G¹ and G² independently have one of the following structures:

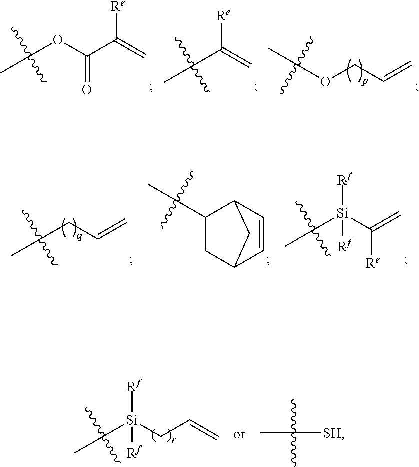

wherein R^{e}, at each occurrence, independently H, halogen or C₁-C₃ alkyl; R^{f}, at each occurrence, independently H, halogen, C₁-C₃ alkyl, C₁-C₆ alkoxy and aryl; and p, q and r are independently an integer from 1 to 6.

In some embodiments G¹ and G² independently have one of the following structures:

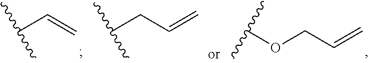

In some embodiments, G¹ and G² are

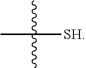 [SMILES: *S]

In some embodiments, G¹ is

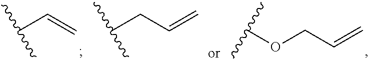

### and G² is

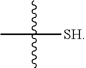 [SMILES: *S]

In some embodiments, the monomer is a compound of Table 3.

In some embodiments, G¹ and G² each comprise an ethylenically unsaturated moiety, and the composition further includes a dithiol monomer selected from a monomer of structure (I), (II) or (III), an alkylene dithiol, a cycloalkylene dithiol, a heteroalkylene dithiol, an arylene dithiol or a heteroarylene dithiol.

In some embodiments, G¹ and G² each comprise a thiol moiety, the composition further comprises a diene monomer selected from a monomer of structure (I), (II) or (III), an alkylene diene, a cycloalkylene diene, an heteroalkylene diene, an arylene diene, or heteroarylene diene.

In still another aspect, provided is a curable composition comprising a diene monomer and a dithiol monomer. The diene monomer comprises a diene monomer of structure or structure (II). The dithiol monomer comprises a dithiol monomer of structure (I) or structure (II), an alkylene dithiol, a cycloalkylene dithiol, a heteroalkylene dithiol, an arylene dithiol or a heteroarylene dithiol.

In some embodiments, the dithiol monomer comprises 1,2-ethanedithiol (EDT), 1,3-propanedithiol, 1,4-butanedithiol, 1,5-pentanedithiol (PDT), 1,6-hexanedithiol (HDT), 1,10-decanedithiol (DDT), 2,2′-thiodiethanethiol (TDET), 2,2′-(ethylenedioxy)diethanethiol (EDDT), 1,4-bis(3-mercaptobutylyloxy)butane, poly(ethylene glycol) dithiol or tetra(ethylene glycol) dithiol.

In still another aspect, provided is a curable composition comprising a diene monomer and a dithiol monomer. The diene monomer comprises a diene monomer of structure (I) or structure (II), an alkylene diene, a cycloalkylene diene, an heteroalkylene diene, an arylene diene, or heteroarylene diene.

In some embodiments, the diene monomer comprises diallyl terephthalate (DAT), butanediol diacrylate, tricyclo[5.2.1.02,6]decanedimethanol diacrylate, poly(ethylene glycol) diacrylate, diallyl phthalate, diallyl maleate, trimethylolpropane diallyl ether, ethylene glycol dicyclopentenyl ether acrylate, diallyl carbonate, diallylurea or 1,6-hexanediol diacrylate.

In some embodiments, a molar ration of the diene monomer to dithiol monomer ranges from 1.0:0.8 to 1.0:1.5.

In still another aspect, provided is a curable composition comprising a thiol-ene monomer of structure (I), (II) or (III).

In some embodiments, the curable composition further comprises a crosslinker. In some embodiments, the crosslinker comprises tricyclodecanediol di(meth)acrylate, pentaerythritol tetrakis(3-mercaptopropionate) (PETMP), trimethyl-1,3,5-benzenetricarboxylate, 1,2,4-trivinylcyclohexane or triallyl isocyanurate. In some embodiments, the curable composition further comprises a reactive diluent. In some embodiments, the reactive diluent comprises homosalic methacrylate (HSMA), syringyl methacrylate (SMA), isobornyl methacrylate (IBOMA) or isobornyl acrylate (IBOA). In some embodiments, the initiator comprises a photoinitiator. In some embodiments, the photoinitiator comprises 2,4,6-trimethylbenzoyl diphenyl phosphine oxide (TPO) or ethyl(2,4,6-trimethylbenzoyl)phenyl phosphinate (TPO-L). In some embodiments, the curable composition comprises 0.01-10 wt % of initiator. In some embodiments, the curable composition further comprises one or more reagents selected from the group consisting of a glass transition temperature modifier, a toughness modifier, a polymerization catalyst, a polymerization inhibitor, a light blocker, a plasticizer, a surface energy modifier, a pigment, a dye, a filler, a biologically significant chemical, a solvent and combinations thereof. In some embodiments, the curable composition is capable of being 3D printed at a printing temperature greater than 25° C. In some embodiments, the printing temperature is at least 30° C., 40° C., 50° C., 60° C., 80° C. or 100° C. In some embodiments, the curable composition has a viscosity from 30 cP to 50,000 cP at a printing temperature. In some embodiments, the printing temperature is from 25° C. to 150° C. In some embodiments, the curable composition comprises less than 20 wt % hydrogen bonding units. In some embodiments, the curable composition is a liquid at a temperature from about 40° C. to about 100° C. In some embodiments, the curable composition is a liquid at a temperature above about 40° C. with a viscosity less than about 20 Pa s. In some embodiments, the curable composition is a liquid at a temperature of above about 40° C. with a viscosity less than about 1 Pa s. In some embodiments, at least a portion of the curable composition melts at a temperature between about 60° C. and about 100° C.

In still another aspect, provided is a polymeric material formed from one of the curable compositions disclosed herein. The polymeric material includes sulfur atoms incorporated into the polymer backbone. In some embodiments, the polymeric material has one or more of the following characteristics: (A) a storage modulus greater than or equal to 200 MPa at 37° C.; (B) a flexural stress and/or flexural modulus of greater than or equal to 1.5 MPa remaining after 24 hours in a wet environment at 37° C.; (C) an elongation at break greater than or equal to 5% before and after 24 hours in a wet environment at 37° C.; (D) a water uptake of less than 25 wt % when measured after 24 hours in a wet environment at 37° C.; (E) transmission of at least 30% of visible light through the polymeric material after 24 hours in a wet environment at 37° C.; and (F) comprises a plurality of polymeric phases, wherein at least one polymeric phase of the one or more polymeric phases has a Tg of at least 60° C., 80° C., 90° C., 100° C., or at least 110° C. In some embodiments, the polymeric material is characterized by a water uptake of less than 20 wt %, less than 15 wt %, less than 10 wt %, less than 5 wt %, less than 4 wt %, less than 3 wt %, less than 2 wt %, less than 1 wt %, less than 0.5 wt %, less than 0.25 wt %, or less than 0.1 wt % when measured after 24 hours in a wet environment at 37° C. In some embodiments, the polymeric material has greater than 60% conversion of double bonds to single bonds compared to the curable composition, as measured by FTIR. In some embodiments, the polymeric material has greater than 60% conversion of double bonds to single bonds compared to the curable composition, as measured by FTIR. In some embodiments, the polymeric material has an ultimate tensile strength from 10 MPa to 100 MPa, from 15 MPa to 80 MPa, from 20 MPa to 60 MPa, from 10 MPa to 50 MPa, from 10 MPa to 45 MPa, from 25 MPa to 40 MPa, from 30 MPa to 45 MPa, or from 30 MPa to 40 MPa after 24 hours in a wet environment at 37° C. In some embodiments, the polymeric material is characterized by an elongation at break greater than 10%, an elongation at break greater than 20%, an elongation at break greater than 30%, an elongation at break of 5% to 250%, an elongation at break of 20% to 250%, or an elongation at break value between 40% and 250% before and after 24 hours in a wet environment at 37° C. In some embodiments, the polymeric material is characterized by a storage modulus of 0.1 MPa to 4000 MPa, a storage modulus of 300 MPa to 3000 MPa, or a storage modulus of 750 MPa to 3000 MPa after 24 hours in a wet environment at 37° C. In some embodiments, the polymeric material has a flexural stress and/or flexural modulus of 400 MPa or more, 300 MPa or more, 200 MPa or more, 180 MPa or more, 160 MPa or more, 120 MPa or more, 100 MPa or more, 80 MPa or more, 70 MPa or more, 60 MPa or more, after 24 hours in a wet environment at 37° C. In some embodiments, at least 40%, 50%, 60%, or 70% of visible light passes through the polymeric material after 24 hours in a wet environment at 37° C. In some embodiments, the polymeric material is biocompatible, bioinert, or a combination thereof.

In still another aspect, provided is a polymeric film comprising a polymeric material disclosed herein. In some embodiments, the polymeric film has a thickness of at least 100 μm and not more than 3 mm.

In still another aspect, provided is an orthodontic appliance comprising a polymeric material or a polymeric film disclosed herein. In some embodiments, the orthodontic appliance is an aligner, expander or spacer.

In still another aspect, provided is a method of forming a polymeric material disclosed herein comprising: providing a curable composition disclosed herein; exposing the curable composition to a light source; and curing the curable composition to form the polymeric material. In some embodiments, the light source is an ultraviolet (UV) or visible light source. In some embodiments, the method further comprises inducing phase separation during photo-curing. In some embodiments, inducing phase separation comprises generating one or more polymeric phases in the polymeric material during photo-curing. In some embodiments, at least one polymeric phase of the one or more polymeric phases is an amorphous phase having a glass transition temperature (Tg) of at least 60° C., 80° C., 90° C., 100° C., or at least 110° C. In some embodiments, at least 25%, 50%, or 75% of polymeric phases generated during photo-curing are amorphous phases having a glass transition temperature (Tg) of at least 60° C., 80° C., 90° C., 100° C., or at least 110° C. In some embodiments, at least one polymeric phase of the one or more polymeric phases is a crystalline phase comprising a crystalline polymeric material. In some embodiments, the crystalline polymeric material has a melting point of at least 60° C., 80° C., 90° C., 100° C., or at least 110° C. In some embodiments, at least one polymeric phase of the one or more polymeric phases is 3-dimensional and has at least one dimension with a length of less than 1000 μm, less than 500 μm, less than 250 μm, or less than 200 μm. In some embodiments, the method further comprises fabricating an orthodontic appliance with the polymeric material.

In still another aspect, provided is a method for preparing an article by an additive manufacturing process comprising: providing a curable composition disclosed herein; heating the curable composition to a processing temperature; exposing the curable composition to radiation; curing the curable composition layer-by-layer based on a predefined design, thereby polymerizing and crosslinking polymerizable components in the curable composition to form a polymeric material; and fabricating the article with the polymeric material. In some embodiments, the processing temperature is from about 50° C. to about 120° C. In some embodiments, the processing temperature is from about 90° C. to about 110° C., from about 100° C. to about 120° C., from about 105° C. to about 115° C., or from about 108° C. to about 110° C. In some embodiments, the additive manufacturing process is a 3D printing process. In some embodiments, the article is a medical device. In some embodiments, the medical device is an orthodontic appliance.

In still another aspect, provided is a method of repositioning a patient's teeth comprising: generating a treatment plan for the patient, the plan comprising a plurality of intermediate tooth arrangements for moving teeth along a treatment path from an initial tooth arrangement toward a final tooth arrangement; producing an orthodontic appliance according to any of claims 86-87, or an orthodontic appliance comprising the polymeric material disclosed herein; and moving on-track, with the orthodontic appliance, at least one of the patient's teeth toward an intermediate tooth arrangement or the final tooth arrangement. In some embodiments, producing the orthodontic appliance comprises 3D printing of the orthodontic appliance. In some embodiments, the method further comprises tracking progression of the patient's teeth along the treatment path after administration of the orthodontic appliance to the patient, the tracking comprising comparing a current arrangement of the patient's teeth to a planned arrangement of the patient's teeth. In some embodiments, greater than 60% of the patient's teeth are on track with the treatment plan after 2 weeks of treatment. In some embodiments, the orthodontic appliance has a retained repositioning force to the at least one of the patient's teeth after 2 days that is at least 10%, at least 20%, at least 30%, at least 40%, at least 50%, at least 60%, or at least 70% of repositioning force initially provided to the at least one of the patient's teeth.

### BRIEF DESCRIPTION OF THE SEVERAL VIEWS OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A illustrates a tooth repositioning appliance, in accordance with some embodiments.

FIG. 1B illustrates a tooth repositioning system, in accordance with some embodiments.

FIG. 1C illustrates a method of orthodontic treatment using a plurality of appliances, in accordance with some embodiments.

FIG. 2 is a partially schematic illustration of a system for additive manufacturing, in accordance with some embodiments.

FIG. 3 illustrates a method for designing an orthodontic appliance, in accordance with some embodiments.

FIG. 4 illustrates a method for digitally planning an orthodontic treatment, in accordance with some embodiments.

FIG. 5 shows generating and administering treatment, in accordance with some embodiments.

FIG. 6 shows a schematic configuration of a high temperature additive manufacturing device used for curing curable compositions of the present disclosure by using a 3D printing process, in accordance with some embodiments.

FIG. 7 shows a DSC thermogram of 9-decene-1-thiol homopolymer.

### DETAILED DESCRIPTION

In the following description, certain specific details are set forth to provide a thorough understanding of various embodiments of the disclosure. However, one skilled in the art will understand that the disclosure may be practiced without these details.

Unless the context requires otherwise, throughout the present specification and claims, the word “comprise” and variations thereof, such as, “comprises” and “comprising” are to be construed in an open, inclusive sense, that is, as “including, but not limited to”.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Number ranges are to be understood as inclusive, i.e., including the indicated lower and upper limits. Furthermore, the term “about”, as used herein, and unless clearly indicated otherwise, generally refers to and encompasses plus or minus 10% of the indicated numerical value(s). For example, “about 10%” may indicate a range of 9% to 11%, and “about 1” may include the range 0.9-1.1.

As used herein, the term “polymer” generally refers to a molecule composed of repeating structural units connected by covalent chemical bonds and characterized by a substantial number of repeating units (e.g., equal to or greater than 20 repeating units and often equal to or greater than 100 repeating units and often equal to or greater than 200 repeating units) and a number average molecular weight greater than or equal to 5,000 Daltons (Da) or 5 kDa, such as greater than or equal to 10 kDa, 15 kDa, 20 kDa, 30 kDa, 40 kDa, 50 kDa, or 100 kDa. Polymers are commonly the polymerization product of one or more monomer precursors. The term “polymer” includes homopolymers, i.e., polymers consisting essentially of a single repeating monomer species. The term “polymer” also includes copolymers which are formed when two or more different types of monomers are linked in the same polymer. Copolymers may comprise two or more monomer subunits, and include random, block, alternating, segmented, grafted, tapered and other copolymers. The term “cross-linked polymers” generally refers to polymers having one or multiple links between at least two polymer chains, which can result from multivalent monomers forming cross-linking sites upon polymerization.

As used herein, the term “oligomer” generally refers to a molecule composed of repeating structural units connected by covalent chemical bonds and characterized by a number of repeating units less than that of a polymer (e.g., equal to or less than 10 repeating units) and a lower molecular weight than polymers (e.g., less than 5,000 Da or 2,000 Da). In some cases, oligomers may be the polymerization product of one or more monomer precursors. In an embodiment, an oligomer or a monomer cannot be considered a polymer in its own right.

As used herein, the terms “telechelic polymer” and “telechelic oligomer” generally refer to a polymer or oligomer that is capable of entering, through reactive groups, into further polymerization.

As used herein, the term “reactive diluent” generally refers to a substance which reduces the viscosity of another substance, such as a monomer or curable resin. A reactive diluent may become part of another substance, such as a polymer obtained by a polymerization process. In some examples, a reactive diluent is a curable monomer which, when mixed with a curable resin, reduces the viscosity of the resultant formulation and is incorporated into the polymer that results from polymerization of the formulation.

Oligomer and polymer mixtures can be characterized and differentiated from other mixtures of oligomers and polymers by measurements of molecular weight and molecular weight distributions.

The average molecular weight (M) is the average number of repeating units n times the molecular weight or molar mass (Mᵢ) of the repeating unit. The number average molecular weight (Mₙ) is the arithmetic mean, representing the total weight of the molecules present divided by the total number of molecules.

Photoinitiators described in the present disclosure can include those that can be activated with light and initiate polymerization of the polymerizable components of the formulation. In some embodiments, a photoinitiator may be a free radical initiator that can produce radical species and/or promote radical reactions upon exposure to radiation (e.g., UV or visible light). In some other embodiments, a photoinitiator may be an ionic initiator that can produce ionic species upon exposure to radiation (e.g., UV or visible light). In some embodiments, the ionic initiator is a cationic initiator. In some embodiments, the ionic initiator is an anionic initiator.

Thermal initiators described in the present disclosure can include those that can be activated with heat and initiate polymerization of the polymerizable components of the formulation. A “thermal initiator”, as used herein, may generally refer to a compound that can produce radical species and/or promote radical reactions upon exposure to heat. In some other embodiments, a thermal initiator may be an ionic initiator that produces ionic species upon exposure to heat.

The term “biocompatible,” as used herein, refers to a material that does not elicit an immunological rejection or detrimental effect, referred herein as an adverse immune response, when it is disposed within an in-vivo biological environment. For example, in some embodiments, a biological marker indicative of an immune response changes less than 10%, or less than 20%, or less than 25%, or less than 40%, or less than 50% from a baseline value when a human or animal is exposed to or in contact with the biocompatible material. Alternatively, immune response may be determined histologically, wherein localized immune response is assessed by visually assessing markers, including immune cells or markers that are involved in the immune response pathway, in and adjacent to the material. In an aspect, a biocompatible material or device does not observably change immune response as determined histologically. In some embodiments, the disclosure provides biocompatible devices configured for long-term use, such as on the order of weeks to months, without invoking an adverse immune response. Biological effects may be initially evaluated by measurement of cytotoxicity, sensitization, irritation and intracutaneous reactivity, acute systemic toxicity, pyrogenicity, subacute/subchronic toxicity and/or implantation. Biological tests for supplemental evaluation include testing for chronic toxicity.

“Bioinert” refers to a material that does not elicit an immune response from a human or animal when it is disposed within an in-vivo biological environment. For example, a biological marker indicative of an immune response remains substantially constant (plus or minus 5% of a baseline value) when a human or animal is exposed to or in contact with the bioinert material. In some embodiments, the disclosure provides bioinert devices.

When a group of substituents is disclosed herein, it is understood that all individual members of that group and all subgroups, including any isomers, enantiomers, and diastereomers of the group members, are disclosed separately. When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomer and enantiomer of the compound described individually or in any combination. Additionally, unless otherwise specified, all isotopic variants of compounds disclosed herein are intended to be encompassed by the disclosure. Specific names of compounds are intended to be exemplary, as it is known that one of ordinary skill in the art can name the same compounds differently.

As used herein, the term “group” may refer to a functional group of a chemical compound. Groups of the present compounds refer to an atom or a collection of atoms that are a part of the compound. Groups of the present disclosure may be attached to other atoms of the compound via one or more covalent bonds. Groups may also be characterized with respect to their valence state. The present disclosure includes groups characterized as monovalent, divalent, trivalent, etc., valence states.

As used herein, the term “substituted” refers to a compound (e.g., an alkyl chain) wherein a hydrogen is replaced by another functional group or atom, as described herein.

As used herein, a broken line in a chemical structure can be used to indicate a bond to the rest of the molecule. For example,

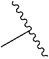

in, e.g.,

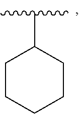 [SMILES: *C1CCCCC1]

is used to indicate that the given moiety, the cyclohexyl moiety in this example, is attached to a molecule via the bond that is “capped” with the wavy line.

As used herein, a “linker” refers to a contiguous chain of at least one atom, such as carbon, oxygen, nitrogen, sulfur, phosphorous, and combinations thereof, which connects a portion of a molecule to another portion of the same molecule or to a different molecule, moiety or solid support (e.g., microparticle). Linkers may connect the molecule via a covalent bond or other means, such as ionic or hydrogen bond interactions. In some embodiments, the linker is a heteroatomic linker (e.g., comprising 1-10 Si, N, O, P, or S atoms), a heteroalkylene (e.g., comprising 1-10 Si, N, O, P, or S atoms and an alkylene chain) or an alkylene linker (e.g., comprising 1-12 carbon atoms). In some embodiments, the linker may contain an ether (—O—), ester (—OC(═O)—), or carbonate (—OC(═O)O—) linkage.

“Aliphatic” or “aliphatic group” as used herein means a straight-chain or branched C₁₋₁₂ hydrocarbon chain that is completely saturated or that contains one or more units of unsaturation, or a monocyclic C₃₋₈ hydrocarbon or bicyclic C₈₋₁₂ hydrocarbon that is completely saturated or that contains one or more units of unsaturation, but which is not aromatic (also referred to herein as “cycloalkyl”), that has a single point of attachment to the rest of the molecule wherein any individual ring in said bicyclic ring system has 3-7 members. For example, suitable aliphatic groups include, but are not limited to, linear or branched alkyl, alkenyl, alkynyl groups and hybrids thereof such as (cycloalkyl)alkyl, (cycloalkenyl)alkyl or (cycloalkyl)alkenyl.

“Alkyl” refers to a straight or branched hydrocarbon chain radical consisting solely of carbon and hydrogen atoms, which is saturated, and having, for example, from one to thirty carbon atoms and particularly from one to six carbon atoms and which is attached to the rest of the molecule by a single bond. Alkyl groups can include small alkyl groups having 1 to 3 carbon atoms, medium length alkyl groups having from 4-10 carbon atoms, as well as long alkyl groups having more than 10 carbon atoms, particularly those having 10-30 carbon atoms. The term “cycloalkyl” specifically refers to an alky group having a ring structure such as ring structure comprising 3-30 carbon atoms, optionally 3-20 carbon atoms and optionally 3-10 carbon atoms, including an alkyl group having one or more rings. Cycloalkyl groups include those having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkyl groups can also carry alkyl groups. Cycloalkyl groups can include bicyclic and tricyclic alkyl groups. Alkyl groups are optionally substituted, as described herein. Substituted alkyl groups can include, among others, those which are substituted with aryl groups, which in turn can be optionally substituted. Specific alkyl groups include methyl, ethyl, n-propyl, iso-propyl, cyclopropyl, n-butyl, s-butyl, t-butyl, cyclobutyl, n-pentyl, branched-pentyl, cyclopentyl, n-hexyl, branched hexyl, and cyclohexyl groups, all of which are optionally substituted. Unless otherwise defined herein, substituted alkyl groups include fully halogenated or semihalogenated alkyl groups, such as alkyl groups having one or more hydrogens replaced with one or more fluorine atoms, chlorine atoms, bromine atoms and/or iodine atoms. Thus, substituted alkyl groups can include fully fluorinated or semifluorinated alkyl groups, such as alkyl groups having one or more hydrogens replaced with one or more fluorine atoms. An alkoxy group is an alkyl group that has been modified by linkage to oxygen and can be represented by the formula R—O and can also be referred to as an alkyl ether group. Examples of alkoxy groups include, but are not limited to, methoxy, ethoxy, propoxy, butoxy and heptoxy. Alkoxy groups include substituted alkoxy groups wherein the alky portion of the groups is substituted as provided herein in connection with the description of alkyl groups. As used herein MeO— refers to CH₃O—. Moreover, a thioalkoxy group, as used herein is an alkyl group that has been modified by linkage to sulfur atom (instead of an oxygen) and can be represented by the formula R—S.

“Alkenyl” refers to an alkyl which is unsaturated comprising at least one carbon-carbon double bond. Alkenyl groups include straight-chain, branched and cyclic alkenyl groups. Alkenyl groups include those having 1, 2 or more double bonds and those in which two or more of the double bonds are conjugated double bonds. Unless otherwise defined herein, alkenyl groups include those having from 2 to 20 carbon atoms. Alkenyl groups include small alkenyl groups having 2 to 3 carbon atoms. Alkenyl groups include medium length alkenyl groups having from 4-10 carbon atoms. Alkenyl groups include long alkenyl groups having more than 10 carbon atoms, particularly those having 10-20 carbon atoms. Cycloalkenyl groups include those in which a double bond is in the ring or in an alkenyl group attached to a ring. The term “cycloalkenyl” specifically refers to an alkenyl group having a ring structure, including an alkenyl group having a 3-, 4-, 5-, 6-, 7-, 8-, 9- or 10-member carbon ring(s) and particularly those having a 3-, 4-, 5-, 6-, 7- or 8-member ring(s). The carbon rings in cycloalkenyl groups can also carry alkyl groups. Cycloalkenyl groups can include bicyclic and tricyclic alkenyl groups. Alkenyl groups are optionally substituted. Unless otherwise defined herein, substituted alkenyl groups include, among others, those that are substituted with alkyl or aryl groups, which groups in turn can be optionally substituted. Specific alkenyl groups include ethenyl, prop-1-enyl, prop-2-enyl, cycloprop-1-enyl, but-1-enyl, but-2-enyl, cyclobut-1-enyl, cyclobut-2-enyl, pent-1-enyl, pent-2-enyl, branched pentenyl, cyclopent-1-enyl, hex-1-enyl, branched hexenyl, cyclohexenyl, all of which are optionally substituted. Substituted alkenyl groups can include fully halogenated or semihalogenated alkenyl groups, such as alkenyl groups having one or more hydrogens replaced with one or more fluorine atoms, chlorine atoms, bromine atoms and/or iodine atoms. Substituted alkenyl groups include fully fluorinated or semifluorinated alkenyl groups, such as alkenyl groups having one or more hydrogen atoms replaced with one or more fluorine atoms.

“Aryl” refers to a ring system comprising at least one carbocyclic aromatic ring. In some embodiments, an aryl comprises from 5 to 18 carbon atoms. Aryl groups include groups having one or more 5-, 6-, 7- or 8-membered aromatic rings, including heterocyclic aromatic rings. The term “heteroaryl” specifically refers to aryl groups having at least one 5-, 6-, 7- or 8-member heterocyclic aromatic rings. Aryl groups can contain one or more fused aromatic rings, including one or more fused heteroaromatic rings, and/or a combination of one or more aromatic rings and one or more nonaromatic rings that may be fused or linked via covalent bonds. Heterocyclic aromatic rings can include one or more N, O, P, or S atoms in the ring. Heterocyclic aromatic rings can include those with one, two or three N atoms, those with one or two O atoms, and those with one or two S atoms, or combinations of one, two or three N, O or S atoms. Aryl groups are optionally substituted. Substituted aryl groups include, among others, those that are substituted with alkyl or alkenyl groups, which groups in turn can be optionally substituted. Specific aryl groups include phenyl, biphenyl groups, pyrrolidinyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, and naphthyl groups, all of which are optionally substituted. Substituted aryl groups include fully halogenated or semihalogenated aryl groups, such as aryl groups having one or more hydrogens replaced with one or more fluorine atoms, chlorine atoms, bromine atoms and/or iodine atoms. Substituted aryl groups include fully fluorinated or semifluorinated aryl groups, such as aryl groups having one or more hydrogens replaced with one or more fluorine atoms. Aryl groups include, but are not limited to, aromatic group-containing or heterocyclic aromatic group-containing groups corresponding to any one of the following: benzene, naphthalene, naphthoquinone, diphenylmethane, fluorene, anthracene, anthraquinone, phenanthrene, tetracene, tetracenedione, pyridine, quinoline, isoquinoline, indoles, isoindole, pyrrole, imidazole, oxazole, thiazole, pyrazole, pyrazine, pyrimidine, purine, benzimidazole, furans, benzofuran, dibenzofuran, carbazole, acridine, acridone, phenanthridine, thiophene, benzothiophene, dibenzothiophene, xanthene, xanthone, flavone, coumarin, azulene or anthracycline. As used herein, a group corresponding to the groups listed above expressly includes an aromatic or heterocyclic aromatic group, including monovalent, divalent and polyvalent groups, of the aromatic and heterocyclic aromatic groups listed herein provided in a covalently bonded configuration in the compounds of the disclosure at any suitable point of attachment. In some embodiments, aryl groups contain one aromatic or heteroaromatic six-member ring and one or more additional five- or six-member aromatic or heteroaromatic ring. In some embodiments, aryl groups contain between five and eighteen carbon atoms in the rings. Aryl groups optionally have one or more aromatic rings or heterocyclic aromatic rings having one or more electron donating groups, electron withdrawing groups and/or targeting ligands provided as substituents.

“Arylalkyl” groups are alkyl groups substituted with one or more aryl groups wherein the alkyl groups optionally carry additional substituents and the aryl groups are optionally substituted. Specific arylalkyl groups are phenyl-substituted alkyl groups, e.g., phenylmethyl groups. “Alkylaryl” groups are alternatively described as aryl groups substituted with one or more alkyl groups wherein the alkyl groups optionally carry additional substituents and the aryl groups are optionally substituted. Specific alkylaryl groups are alkyl-substituted phenyl groups such as methylphenyl. Substituted arylalkyl groups include fully halogenated or semihalogenated arylalkyl groups, such as arylalkyl groups having one or more alkyl and/or aryl groups having one or more hydrogens replaced with one or more fluorine atoms, chlorine atoms, bromine atoms and/or iodine atoms.

The terms “alkylene” and “alkylene group” are used synonymously and refer to a divalent group “—CH₂—” derived from an alkyl group as defined herein. The disclosure includes compounds having one or more alkylene groups. Alkylene groups in some compounds function as attaching and/or spacer groups. Compounds of the disclosure may have substituted and/or unsubstituted C₁-C₂₀ alkylene, C₁-C₁₀ alkylene and C₁-C₆ alkylene groups.

The terms “cycloalkylene” and “cycloalkylene group” are used synonymously and refer to a divalent group derived from a cycloalkyl group as defined herein. The disclosure includes compounds having one or more cycloalkylene groups. Cycloalkyl groups in some compounds function as attaching and/or spacer groups. Compounds of the disclosure may have substituted and/or unsubstituted C₃-C₃₀ cycloalkylene, C₃-C₁₈ cycloalkylene and C₃-C₆ cycloalkylene groups.

The terms “arylene” and “arylene group” are used synonymously and refer to a divalent group derived from an aryl group as defined herein. The disclosure includes compounds having one or more arylene groups. In some embodiments, an arylene is a divalent group derived from an aryl group by removal of hydrogen atoms from two intra-ring carbon atoms of an aromatic ring of the aryl group. Arylene groups in some compounds function as attaching and/or spacer groups. Arylene groups in some compounds function as chromophore, fluorophore, aromatic antenna, dye and/or imaging groups. Compounds of the disclosure include substituted and/or unsubstituted C₅-C₃₀ arylene, C₅-C₁₈ arylene and C₆-C₁₀ arylene groups.

The terms “heteroarylene” and “heteroarylene group” are used synonymously and refer to a divalent group derived from a heteroaryl group as defined herein. The disclosure includes compounds having one or more heteroarylene groups. In some embodiments, a heteroarylene is a divalent group derived from a heteroaryl group by removal of hydrogen atoms from two intra-ring carbon atoms or intra-ring nitrogen atoms of a heteroaromatic or aromatic ring of the heteroaryl group. Heteroarylene groups in some compounds function as attaching and/or spacer groups. Heteroarylene groups in some compounds function as chromophore, aromatic antenna, fluorophore, dye and/or imaging groups. Compounds of the disclosure include substituted and/or unsubstituted C₃-C₃₀ heteroarylene, C₃-C₁₈ heteroarylene and C₃-C₆ heteroarylene groups.

The terms “alkenylene” and “alkenylene group” are used synonymously and refer to a divalent group derived from an alkenyl group as defined herein. This disclosure includes compounds having one or more alkenylene groups. Alkenylene groups in some compounds function as attaching and/or spacer groups. Compounds of the disclosure include substituted and/or unsubstituted C₂-C₂₀ alkenylene, C₂-C₁₀ alkenylene and C₂-C₅ alkenylene groups.

The terms “cycloalkenylene” and “cycloalkenylene group” are used synonymously and refer to a divalent group derived from a cycloalkenyl group as defined herein. The disclosure includes compounds having one or more cycloalkenylene groups. Cycloalkenylene groups in some compounds function as attaching and/or spacer groups. Compounds of the disclosure include substituted and/or unsubstituted C₃-C₃₀ cycloalkenylene, C₃-C₁₈ cycloalkenylene and C₃-C₆ cycloalkenylene groups.

The terms “alkynylene” and “alkynylene group” are used synonymously and refer to a divalent group derived from an alkynyl group as defined herein. The disclosure includes compounds having one or more alkynylene groups. Alkynylene groups in some compounds function as attaching and/or spacer groups. Compounds of the disclosure include substituted and/or unsubstituted C₂-C₂₀ alkynylene, C₂-C₁₀ alkynylene and C₂-C₅ alkynylene groups.

The terms “halo” and “halogen” can be used interchangeably and refer to a halogen group such as a fluoro (—F), chloro (—Cl), bromo (—Br) or iodo (—I).

The term “heterocyclic” refers to ring structures containing at least one other kind of atom, in addition to carbon, in the ring. Examples of such heteroatoms include nitrogen, oxygen and sulfur. Heterocyclic rings include heterocyclic alicyclic rings and heterocyclic aromatic rings. Examples of heterocyclic rings include, but are not limited to, pyrrolidinyl, piperidyl, imidazolidinyl, tetrahydrofuryl, tetrahydrothienyl, furyl, thienyl, pyridyl, quinolyl, isoquinolyl, pyridazinyl, pyrazinyl, indolyl, imidazolyl, oxazolyl, thiazolyl, pyrazolyl, pyridinyl, benzoxadiazolyl, benzothiadiazolyl, triazolyl and tetrazolyl groups. Atoms of heterocyclic rings can be bonded to a wide range of other atoms and functional groups, for example, provided as substituents.

The term “carbocyclic” refers to ring structures containing only carbon atoms in the ring. Carbon atoms of carbocyclic rings can be bonded to a wide range of other atoms and functional groups, for example, provided as substituents.

The term “alicyclic ring” refers to a ring, or plurality of fused rings, that is not an aromatic ring. Alicyclic rings include both carbocyclic and heterocyclic rings.

The term “aromatic ring” refers to a ring, or a plurality of fused rings, that includes at least one aromatic ring group. The term “aromatic ring” includes aromatic rings comprising carbon, hydrogen and heteroatoms. Aromatic ring includes carbocyclic and heterocyclic aromatic rings. Aromatic rings are components of aryl groups.

The term “fused ring” or “fused ring structure” refers to a plurality of alicyclic and/or aromatic rings provided in a fused ring configuration, such as fused rings that share at least two intra ring carbon atoms and/or heteroatoms.

The term “alkoxyalkyl” refers to a substituent of the formula alkyl-O-alkyl.

The term “polyhydroxyalkyl” refers to a substituent having from 2 to 12 carbon atoms and from 2 to 5 hydroxyl groups, such as the 2,3-dihydroxypropyl, 2,3,4-trihydroxybutyl or 2,3,4,5-tetrahydroxypentyl residue.

The term “polyalkoxyalkyl” refers to a substituent of the formula alkyl-(alkoxy)n-alkoxy wherein n is an integer from 1 to 10, e.g., 1 to 4, and, in some embodiments, 1 to 3.

The term “heteroalkyl” refers to an alkyl group as defined herein, wherein at least one carbon atom of the alkyl group is replaced with a heteroatom. In some instances, heteroalkyl groups may contain from 1 to 18 non-hydrogen atoms (carbon and heteroatoms) in the chain, or from 1 to 12 non-hydrogen atoms, or from 1 to 6 non-hydrogen atoms, or from 1 to 4 non-hydrogen atoms. Heteroalkyl groups may be straight or branched, and saturated or unsaturated. Unsaturated heteroalkyl groups have one or more double bonds and/or one or more triple bonds. Heteroalkyl groups may be unsubstituted or substituted. Exemplary heteroalkyl groups include, but are not limited to, alkoxyalkyl (e.g., methoxymethyl), and aminoalkyl (e.g., alkylaminoalkyl and dialkylaminoalkyl). Heteroalkyl groups may be optionally substituted with one or more substituents.

The term “carbonyl”, as used herein, for example in the context of C₁₋₆carbonyl substituents, generally refers to a carbon chain of given length (e.g., C₁₋₆), wherein each of the carbon atom of a given carbon chain can form the carbonyl bond, as long as it is chemically feasible in terms of the valence state of that carbon atom. Thus, in some instances, the “C₁₋₆ carbonyl” substituent refers to a carbon chain of between 1 and 6 carbon atoms, and either the terminal carbon contains the carbonyl functionality, or an inner carbon contains the carbonyl functionality, in which case the substituent could be described as a ketone. The term “carboxy”, as used herein, for example in the context of C₁₋₆ carboxy substituents, generally refers to a carbon chain of given length (e.g., C₁₋₆), wherein a terminal carbon contains the carboxy functionality, unless otherwise defined herein.

As to any of the groups described herein that contain one or more substituents, it is understood that such groups do not contain any substitution or substitution patterns which are sterically impractical and/or synthetically non-feasible. In addition, the compounds of this disclosure include all stereochemical isomers arising from the substitution of these compounds.

Unless otherwise defined herein, optional substituents for any alkyl, alkenyl and aryl group include substitution with one or more of the following substituents, among others:
halogen, including fluorine, chlorine, bromine or iodine;
pseudohalides, including —CN, —OCN (cyanate), —NCO (isocyanate), —SCN (thiocyanate) and —NCS (isothiocyanate);
—COOR, where R is a hydrogen or an alkyl group or an aryl group and more specifically where R is a methyl, ethyl, propyl, butyl, hexyl, or phenyl group, all of which groups are optionally substituted;
—COR, where R is a hydrogen or an alkyl group or an aryl group and more specifically where R is a methyl, ethyl, propyl, butyl, hexyl, or phenyl group, all of which groups are optionally substituted;
—CON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—OCON(R)₂, where each R, independently of each other R, is a hydrogen or an alkyl group or an aryl group and more specifically where R is a methyl, ethyl, propyl, butyl, or phenyl group all of which groups are optionally substituted; and where R and R can form a ring which can contain one or more double bonds and can contain one or more additional carbon atoms;
—N(R)₂, where each R, independently of each other R, is a hydrogen, or an alkyl group, or an acyl group or an aryl group and more specifically where R is a methyl, ethyl, propyl, butyl, phenyl or acetyl group, all of which are optionally substituted; and where R and R can form a ring that can contain one or more double bonds and can contain one or more additional carbon atoms;
—SR, where R is hydrogen or an alkyl group or an aryl group and more specifically where R is hydrogen, methyl, ethyl, propyl, butyl, hexyl, decyl, or a phenyl group, which are optionally substituted;
—SO₂R, or —SOR, where R is an alkyl group or an aryl group and more specifically where R is a methyl, ethyl, propyl, butyl, hexyl, decyl, or phenyl group, all of which are optionally substituted;
—OCOOR, where R is an alkyl group or an aryl group;
—SO₂N(R)₂, where each R, independently of each other R, is a hydrogen, or an alkyl group, or an aryl group all of which are optionally substituted and wherein R and R can form a ring that can contain one or more double bonds and can contain one or more additional carbon atoms; and
—OR, where R is H, an alkyl group, an aryl group, or an acyl group, all of which are optionally substituted. In a particular example R can be an acyl yielding —OCOR, where R is a hydrogen or an alkyl group or an aryl group and more specifically R is methyl, ethyl, propyl, butyl, hexyl, decyl, or phenyl groups, all of which groups are optionally substituted.

Specific substituted alkyl groups include haloalkyl groups, particularly trihalomethyl groups and specifically trifluoromethyl groups. Specific substituted aryl groups include mono-, di-, tri, tetra- and pentahalo-substituted phenyl groups; mono-, di-, tri-, tetra-, penta-, hexa-, and hepta-halo-substituted naphthalene groups; 3- or 4-halo-substituted phenyl groups, 3- or 4-alkyl-substituted phenyl groups, 3- or 4-alkoxy-substituted phenyl groups, 3- or 4-RCO-substituted phenyl, 5- or 6-halo-substituted naphthalene groups. More specifically, substituted aryl groups include acetylphenyl groups, particularly 4-acetylphenyl groups; fluorophenyl groups, particularly 3-fluorophenyl and 4-fluorophenyl groups; chlorophenyl groups, particularly 3-chlorophenyl and 4-chlorophenyl groups; methylphenyl groups, particularly 4-methylphenyl groups; and methoxyphenyl groups, particularly 4-methoxyphenyl groups.

As to any of the above groups that contain one or more substituents, it is understood that such groups do not contain any substitution or substitution patterns which are sterically impractical and/or synthetically non-feasible. In addition, as further described herein, the compounds of this disclosure can include all stereochemical isomers (and racemic mixtures) arising from the substitution of these compounds.

Three-dimensional (3D) printing, also known as additive manufacturing, is a process used to create 3D objects of virtually any shape from a digital design. This technique enables the rapid and efficient fabrication of customized parts. In a typical 3D printing process, an initial layer of material is deposited, followed by the sequential addition of subsequent material layers (or parts thereof), each building upon and connecting to the previous layer. This layer-by-layer process continues until the entire designed 3D object is fully formed.

Crystalline polymers possess excellent mechanical properties; however, their high degree of crystallinity often results in undesirable shrinkage during 3D printing process. Such can compromise dimensional accuracy, rendering these crystalline polymers unsuitable for constructing 3D objects in certain additive manufacturing processes.

The present disclosure provides monomers and curable compositions comprising such monomers for preparation of polymeric materials with controlled crystallinity, as well as orthodontic appliances made from such polymeric materials. The monomers disclosed herein may include thiol/ene monomers for forming sulfur-containing polymers, wherein the presence of sulfur reduces crystallinity. In some embodiments, the monomers may include structurally asymmetric components that promote the formation of both cis and trans conformations, thereby further reducing the degree of crystallinity in the resulting polymeric materials. Reduced crystallinity minimizes shrinkage during the printing process, thereby preserving the dimensional accuracy of the printed parts. These approaches enable improved control over the final dimensions and performance characteristics of orthodontic appliances, including but not limited to spacers and aligners.

### Thiol and Ene Monomers

In one aspect, the present disclosure provides diene, dithiol, or thiol-ene monomers for making semicrystalline sulfur-containing polymers.

In some embodiments, the monomer has the following structure (I):

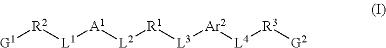

wherein:
Ar¹ and Ar² are independently an arylene or heteroarylene group;
L¹ and L² are independently an ether or ester linkage;
L³ and L⁴ are independently an ether or ester linkage;
R¹ is an alkylene, cycloalkylene, heteroalklyene or heteroatomic linker, wherein the alkylene or heteroalkylene is optionally interrupted by —OC(O)O—, —C(O)—, —C(O)O—, arylene or heteroarylene;
R² and R³ are independently an optional alkylene or heteroalkylene linker; and
G¹ and G² are independently a reactive functional group comprising an ethylenically unsaturated moiety or a thiol moiety.

In some embodiments, Ar¹ and Ar² are independently arylene. In some embodiments, Ar¹ and Ar² are independently phenylene or naphthalene. In some embodiments, Ar¹ and Ar² are phenylene.

In some embodiments, Ar¹ and Ar² are independently heteroarylene. In some embodiments, Ar¹ and Ar² are independently thienylene or furanylene.

In some embodiments, L¹ and L² are the same. In some embodiments, L¹ and L² are each an ester linkage. In some embodiments, L¹ and L² are different. In some embodiments, L¹ is an ether linkage, and L² is an ester linkage. In some embodiments, L¹ is an ester linkage, and L² is an ether linkage.

In some embodiments, L³ and L⁴ are the same. In some embodiments, L³ and L⁴ are each an ester linkage. In some embodiments, L³ and L⁴ are different. In some embodiments, L³ is an ether linkage, and L⁴ is an ester linkage. In some embodiments, L³ is an ester linkage, and L⁴ is an ether linkage.

In some embodiments, R¹ is C₁₋₁₂ alkylene. In some more specific embodiments, R¹ is ethylene, propylene, butylene, pentylene or hexylene.

In some embodiments, R¹ is C₂₋₁₂ alkylene interrupted by —OC(O)O—, —C(O)—, —C(O)O—, arylene or heteroarylene.

In some embodiments, R¹ is C₁₋₁₂ heteroalkylene.

In some embodiments, R¹ is C₂₋₁₂ heteroalkylene interrupted by —OC(O)O—, —C(O)—, —C(O)O—, arylene or heteroarylene.

In some embodiments, R² and R³ are independently C₁₋₆ alkylene. In some more specific embodiments, R² and R³ are independently methylene, ethylene or butylene.

In some embodiments, R² and R³ are independently C₁₋₆ heteroalkylene.

In some embodiments, G¹ and G² are each a reactive functional group comprising an ethylenically unsaturated moiety. Examples of ethylenically unsaturated moieties include, but are not limited to, ene, allyl ether, allyl ester, allyl carbonate, vinyl ether, acrylate, methacrylate, allyl silane, vinyl silane, and norbornene. In some embodiments, G¹ and G² are each a reactive functional group comprising a thiol moiety. In some embodiments, one of G¹ and G² is a reactive functional group comprising a thiol moiety, and the other of G¹ and G² is a reactive functional group comprising an ethylenically unsaturated moiety.

In some embodiments, Ar¹ and Ar² are each phenylene, and L¹, L², L³, and L⁴ are each an ester linkage. For example, the monomer has the following structure (IA):

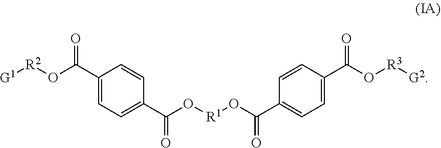

wherein:
R¹ is an alkylene, cycloalkylene, heteroalklyene or heteroatomic linker, wherein the alkylene or heteroalkylene is optionally interrupted by —OC(O)O—, —C(O)—, —C(O)O—, arylene or heteroarylene;
R² and R³ are independently an optional alkylene or heteroalkylene linker; and
G¹ and G² are independently a reactive functional group comprising an ethylenically unsaturated moiety or a thiol moiety.

In some embodiments, Ar¹ and Ar² are each phenylene, L¹ and L⁴ are each an ether linkage, and L² and L³ are each an ester linkage. For example, the monomer has the following structure (IB):

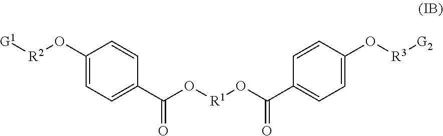

wherein:
R¹ is an alkylene or heteroalkylene linker, wherein the alkylene or heteroalkylene is optionally interrupted by —OC(O)O—, —C(O)—, —C(O)O—, arylene or heteroarylene;
R² and R³ are independently an optional alkylene or heteroalkylene linker; and
G¹ and G² are independently a reactive functional group comprising an ethylenically unsaturated moiety or a thiol moiety.

In some embodiments, Ar¹ and Ar² are each phenylene, L¹ and L⁴ are each an ester linkage, and L² and L³ are each an ether linkage. For example, the monomer has the following structure (IC):

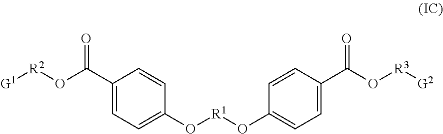

wherein:
R¹ is an alkylene, cycloalkylene, heteroalklyene or heteroatomic linker, wherein the alkylene or heteroalkylene is optionally interrupted by —OC(O)O—, —C(O)—, —C(O)O—, arylene or heteroarylene;
R² and R³ are independently an optional alkylene or heteroalkylene linker; and
G¹ and G² are independently a reactive functional group comprising an ethylenically unsaturated moiety or a thiol moiety.

In some embodiments, R¹ has one of the following structures:
—(CH₂)ₓ—; —(CH₂)_{y}—O—(CH₂)_{z}; —(CH₂)_{y}—S—(CH₂)_{z}—;

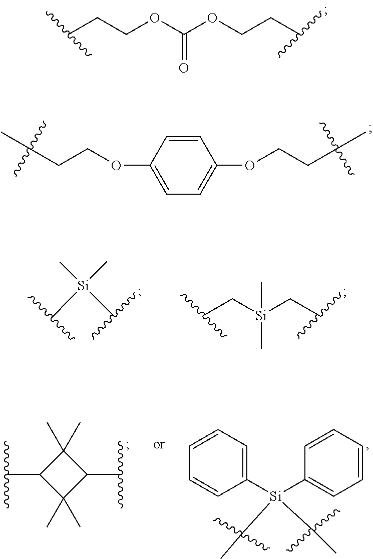

wherein x, y and z are independently an integer from 1 to 12.

In some embodiments, R² and R³ independently have one of the following structures:

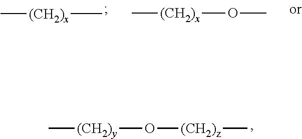

wherein x, y and z are independently an integer from 1 to 12.

In some embodiments, G¹ and G² independently have one of the following structures:

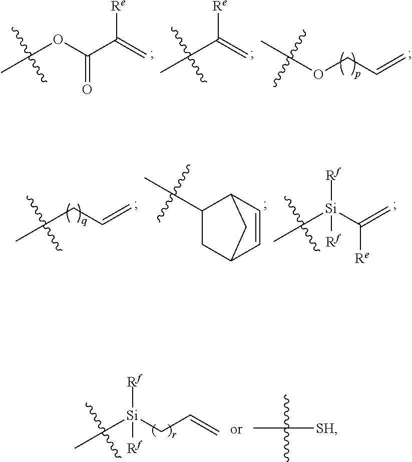

wherein:
R^{e}, at each occurrence, independently H, halogen or C₁-C₃ alkyl;
R^{f}, at each occurrence, independently H, halogen, C₁-C₃ alkyl, C₁-C₆ alkoxy and aryl; and
p, q and r are independently an integer from 1 to 6.

In some embodiments, G¹ and G² independently have one of the following structures:

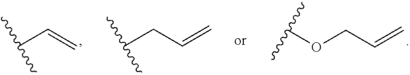

In some embodiments, G¹ and G² are each

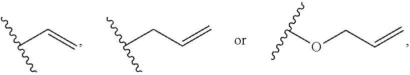

In some embodiments G¹ is

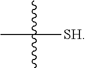 [SMILES: *S]

### and G² is

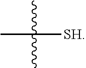 [SMILES: *S]

In some specific embodiments, the monomer is a compound of structure (I) selected from Table 1.

TABLE 1
Exemplary Compounds of Structure (I)

| | | Tm |
|---|---|---|
| # | Structure | (° C.) |
| I-1 | 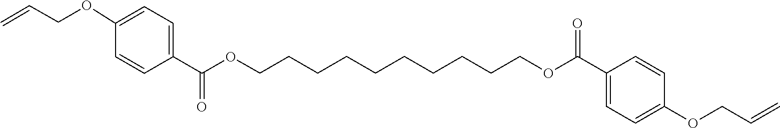 [SMILES: C=CCOc1ccc(C(=O)OCCCCCCCCCCOC(=O)c2ccc(OCC=C)cc2)cc1] | 39-43 |
| I-2 | 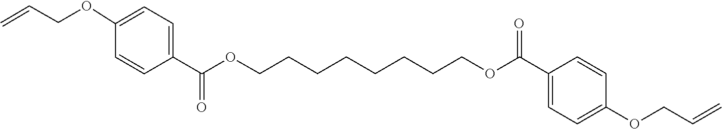 [SMILES: C=CCOc1ccc(C(=O)OCCCCCCCCOC(=O)c2ccc(OCC=C)cc2)cc1] | 46-49 |
| I-3 | 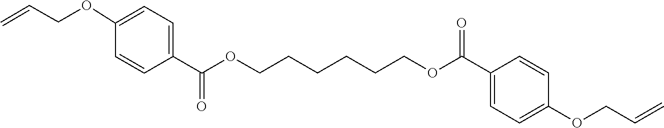 [SMILES: C=CCOc1ccc(C(=O)OCCCCCCOC(=O)c2ccc(OCC=C)cc2)cc1] | 70-72 |
| I-4 | 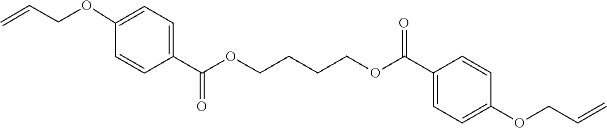 [SMILES: C=CCOc1ccc(C(=O)OCCCCOC(=O)c2ccc(OCC=C)cc2)cc1] | 64-69 |
| I-5 | 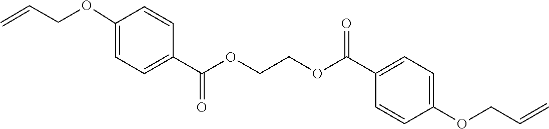 [SMILES: C=CCOc1ccc(C(=O)OCCOC(=O)c2ccc(OCC=C)cc2)cc1] | 81-83 |
| I-6 | 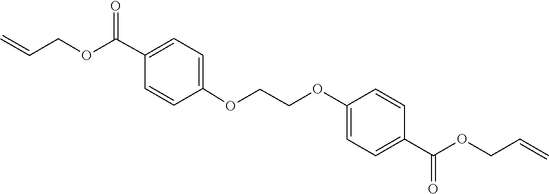 [SMILES: C=CCOC(=O)c1ccc(OCCOc2ccc(C(=O)OCC=C)cc2)cc1] | 80 |
| I-7 | 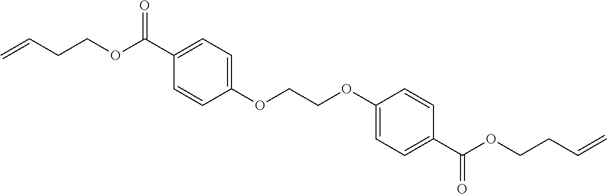 [SMILES: C=CCCOC(=O)c1ccc(OCCOc2ccc(C(=O)OCCC=C)cc2)cc1] | 112-114 |
| I-8 | 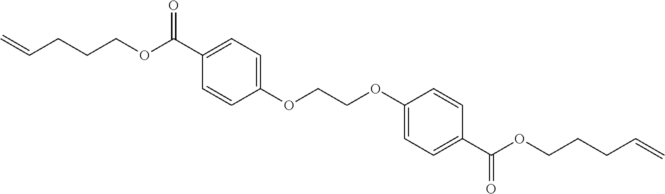 [SMILES: C=CCCCOC(=O)c1ccc(OCCOc2ccc(C(=O)OCCCC=C)cc2)cc1] | / |
| I-9 | 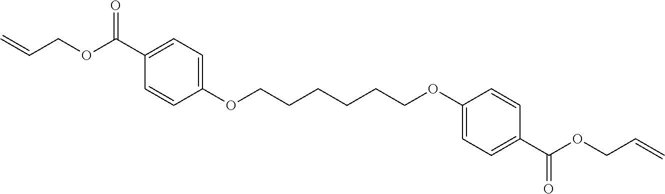 [SMILES: C=CCOC(=O)c1ccc(OCCCCCCOc2ccc(C(=O)OCC=C)cc2)cc1] | 63-65 |
| I-10 | 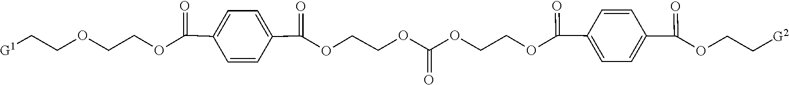 | / |
| I-11 | 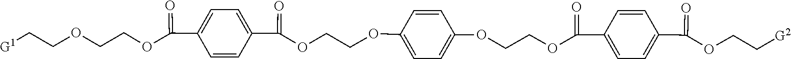 | / |
| I-12 | 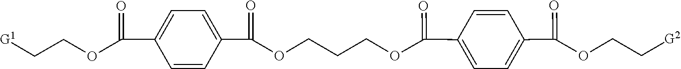 | / |

In some embodiments, G¹ and G² in the compounds of Table 1 are

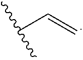 [SMILES: *C=C]

In some embodiments, G¹ and G² in the compounds of Table 1 are —SH. In some embodiments, in the compounds of Table 1, G¹ is

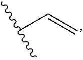 [SMILES: *C=C]

### and G² is —SH.

In some embodiments, the monomer has the following structure (II):

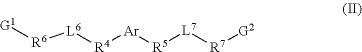

wherein:
Ar is an arylene or heteroarylene group;
R⁴ and R⁵ are independently an optional alkylene linker;
L⁶ and L⁷ are independently a carbonate, ether, or ester linkage;
R⁶ and R⁷ are independently an optional alkylene or heteroalkylene linker, wherein the alkylene or heteroalkylene is optionally interrupted by —OC(O)O—, —C(O)— or —C(O)O—; and
G¹ and G² are independently a reactive functional group comprising an ethylenically unsaturated moiety or a thiol moiety.

In some embodiments, Ar is arylene. In some embodiments, Ar is phenylene or naphthalene. In some embodiments, Ar is phenylene.

In some embodiments, Aris heteroarylene. In some embodiments, Aris independently thienylene or furanylene.

In some embodiments, R⁴ and R⁵ are each a direct bond.

In some embodiments, R⁴ and R⁵ are independently an optionally substituted linear or branched C₁₋₁₂ alkylene. In some embodiments, R⁴ and R⁵ are an optionally substituted methylene. In some embodiments, R⁴ and R⁵ are methylene or (dimethyl)methylene.

In some embodiments, R⁴ and R⁵ are each a direct bond, and L⁶ and L⁷ are each an ester linkage.

In some embodiments, R⁴ and R⁵ are direct bonds, and L⁶ and L⁷ are each an ether linkage.

In some embodiments, R⁴ and R⁵ are independently an optionally substituted linear or branched C₁₋₁₂ alkylene, for example, (dimethyl)methylene, and L⁶ and L⁷ are each a carbonate linkage.

In some embodiments, R⁶ and R⁷ are independently an optionally substituted linear or branched C₁₋₁₂ alkylene.

In some embodiments, R⁶ and R⁷ are independently an optionally substituted linear or branched C₂₋₁₂ alkylene interrupted by —OC(O)O—, —C(O)— or —C(O)O—.

In some embodiments, R⁶ and R⁷ are independently an optionally substituted linear or branched C₁₋₁₂ heteroalkylene.

In some embodiments, R⁶ and R⁷ are independently an optionally substituted linear or branched C₂₋₁₂ alkylene interrupted by —OC(O)O—, —C(O)— or —C(O)O—.

In some embodiments, G¹ and G² are each a reactive functional group comprising an ethylenically unsaturated moiety. Examples of ethylenically unsaturated moieties include, but are not limited to, ene, allyl ether, allyl ester, allyl carbonate, vinyl ether, acrylate, methacrylate, allyl silane, vinyl silane, and norbornene. In some embodiments, G¹ and G² are each a reactive functional group comprising a thiol moiety. In some embodiments, one of G¹ and G² is a reactive functional group comprising a thiol moiety, and the other of G¹ and G² is a reactive functional group comprising an ethylenically unsaturated moiety.

In some embodiments, Ar is phenylene, R⁴ and R⁵ are each a direct bond, and L⁶ and L⁷ are each an ester linkage. For example, the monomer has the following structure (IIA):

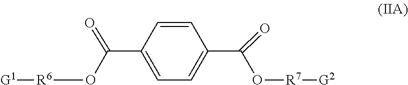

wherein:
R⁶ and R⁷ are independently an alkylene or heteroalkylene linker, wherein the alkylene or heteroalkylene is optionally interrupted by —OC(O)O—, —C(O)— or —C(O)O—; and
G¹ and G² are independently a reactive functional group comprising an ethylenically unsaturated moiety or a thiol moiety.

In some embodiments, Ar is phenylene, R⁴ and R⁵ are each a direct bond, and L⁶ and L⁷ are each an ether linkage. For example, the monomer has the following structure (IIB):

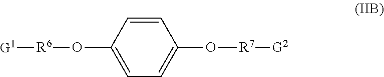

wherein:
R⁶ and R⁷ are independently an optional alkylene or heteroalkylene linker, wherein the alkylene or heteroalkylene is optionally interrupted by —OC(O)O—, —C(O)— or —C(O)O—; and
G¹ and G² are independently a reactive functional group comprising an ethylenically unsaturated moiety or a thiol moiety.

In some embodiments, Ar is phenylene, R⁴ and R⁵ are independently an optionally substituted linear or branched C₁₋₄ alkylene, and L⁶ and L⁷ are each a carbonate linkage. For example, the monomer has the following structure (IIC):

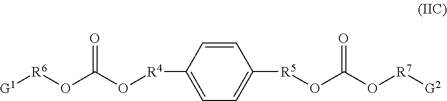

wherein:
R⁴ and R⁵ are independently an optionally substituted linear or branched alkylene;
R⁶ and R⁷ are independently an optional alkylene or heteroalkylene linker, wherein the alkylene or heteroalkylene is optionally interrupted by —OC(O)O—, —C(O)— or —C(O)O—; and
G¹ and G² are independently a reactive functional group comprising an ethylenically unsaturated moiety or a thiol moiety.

In some embodiments, R⁴ and R⁵ are each methyl, (dimethyl)methylene or (ethyl)methylene.

In some embodiments, R⁶ and R⁷ independently have one of the following structures:
(CH₂)ₓ—; —(CH₂)_{y}—O—(CH₂)_{z}—;

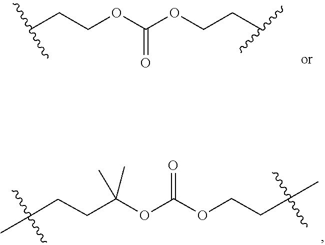

wherein x, y and z are independently an integer from 1 to 12.

In some embodiments, G¹ and G² independently comprise one of the following structures:

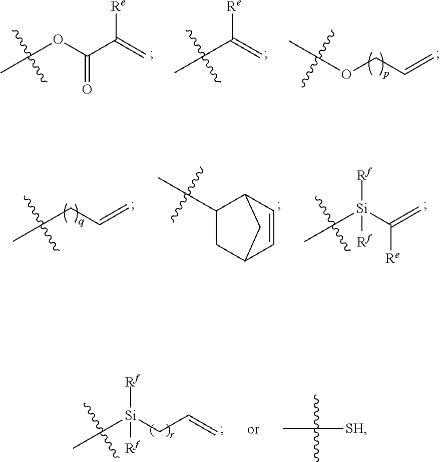

wherein:
R^{e}, at each occurrence, independently H, halogen or C₁-C₃ alkyl;
R^{f}, at each occurrence, independently H, halogen, C₁-C₃ alkyl, C₁-C₆ alkoxy and aryl; and
p, q and r are independently an integer from 1 to 6.

In some embodiments, G¹ and G² independently comprise one of the following structures:

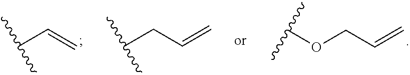

In some embodiments, G¹ and G² are each

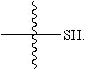 [SMILES: *S]

In some embodiments, G¹ is

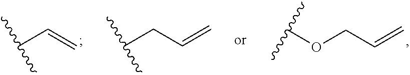

### and G² is

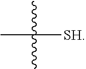 [SMILES: *S]

In some specific embodiments, the monomer is a compound of structure (II) selected from Table 2.

TABLE 2
Exemplary Compounds of Structure (II)

| # | Structure |
|---|---|
| II-1 | 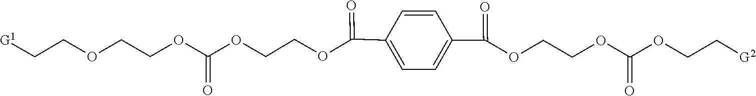 |
| II-2 | 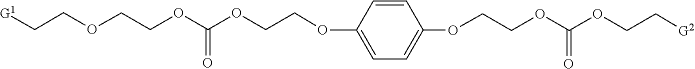 |
| II-3 | 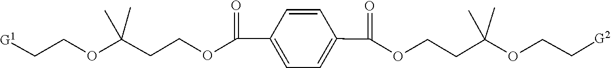 |
| II-4 | 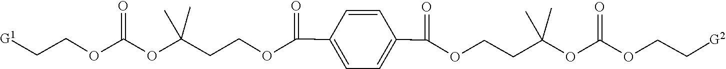 |
| II-5 | 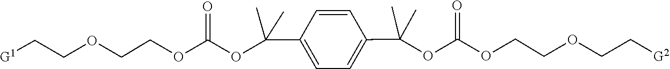 |

In some embodiments, G¹ and G² in the compounds of Table 2 are

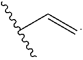 [SMILES: *C=C]

In some embodiments, G¹ and G² in the compounds of Table 2 are —SH. In some embodiments, in the compounds of Table 2, G¹ is

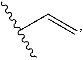 [SMILES: *C=C]

### and G² is —SH.

In some embodiments, the monomer has the following structure (III):

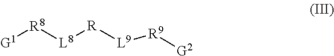

wherein:
R is an alkylene or heteroalkylene group;
L⁸ and L⁹ are independently an optional carbonate, ether, or ester linkage;
R⁸ and R⁹ are independently an optional alkylene or heteroalkylene linker; and
G¹ and G² are independently a reactive functional group comprising an ethylenically unsaturated moiety or a thiol moiety.

In some embodiments, R is an optionally substituted linear or branched C₁₋₁₂ alkylene.

In some embodiments, R⁸ and R⁹ are each a direct bond.

In some embodiments, R⁸ and R⁹ are independently C₁₋₁₂ alkylene.

In some embodiments, G¹ and G² are each a reactive functional group comprising an ethylenically unsaturated moiety. Examples of ethylenically unsaturated moieties include, but are not limited to, ene, allyl ether, allyl ester, allyl carbonate, vinyl ether, acrylate, methacrylate, allyl silane, vinyl silane, and norbornene. In some embodiments, G¹ and G² are each a reactive functional group comprising a thiol moiety. In some embodiments, one of G¹ and G² is a reactive functional moiety comprising a thiol group, and the other one of G¹ and G² is a reactive functional group comprising an ethylenically unsaturated moiety.

In some embodiments, L⁸ and L⁹ are each a carbonate linkage, and R⁸ and R⁹ are each a direct bond. For example, the monomer has the following structure (IIIA):

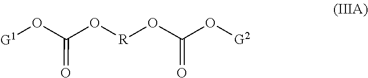

wherein:
R is an alkylene or heteroalkylene group; and
G¹ and G² are independently a reactive functional group comprising an ethylenically unsaturated moiety or a thiol moiety.

In some embodiments, L⁸ and L⁹ are each an ether linkage, and R⁸ and R⁹ are each a direct bond. For example, the monomer has the following structure (IIIB):

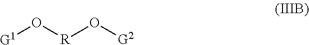

wherein:
R is an alkylene or heteroalkylene group; and
G¹ and G² are independently a reactive functional group comprising an ethylenically unsaturated moiety or a thiol moiety.

In some embodiments, R is an optionally substituted linear or branched C₁₋₁₂ alkylene.

In some embodiments, R has the following structure:

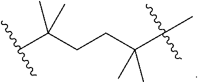 [SMILES: *C(C)(C)CCC(*)(C)C]

In some embodiments, G¹ and G² independently comprise one of the following structures:

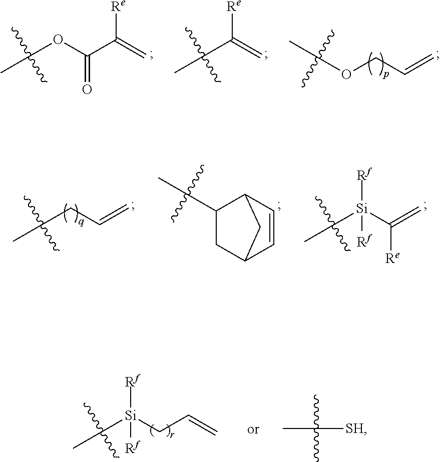

wherein:
R^{e}, at each occurrence, independently H, halogen or C₁-C₃ alkyl;
R^{f}, at each occurrence, independently H, halogen, C₁-C₃ alkyl, C₁-C₆ alkoxy and aryl; and
p, q and r are independently an integer from 1 to 6.

In some embodiments G¹ and G² independently have one of the following structures:

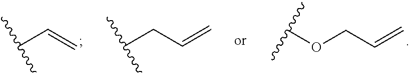

In some embodiments, G¹ and G² are —SH.

In some embodiments, G¹ is

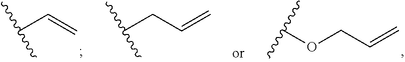

### and G² is —SH.

In some specific embodiments, the monomer is a compound of structure (III) selected from Table 3.

TABLE 3
Exemplary Compounds of Structure (III)

| # | Structure |
|---|---|
| III-1 | 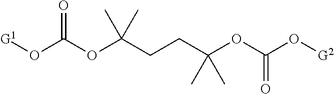 |
| III-2 | 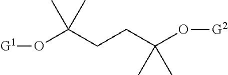 |
| III-3 | 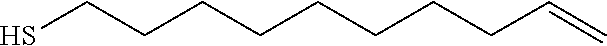 |

In some embodiments, G¹ and G² in the compounds of Table 3 are

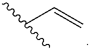 [SMILES: *C=C]

In some embodiments, G¹ and G² in the compounds of Table 3 are —SH. In some embodiments, in the compounds of Table 3, G¹ is

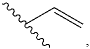 [SMILES: *C=C]

### and G² is —SH.

In some embodiments, a monomer of structure (IA) can be prepared by reacting a terephthalic acid or ester with excess diol according to Scheme 1. For example, in some embodiments, to form a monomer of structure (IA), terephthalic acid or ester is first reacted with a molar excess of diol to produce a carboxylic acid-terminated intermediate which, in turn, is reacted with a compound G¹-M¹ and/or a compound G²-M², where G¹ and G² are independently a thiol or an ethylenically unsaturated group; and M¹ and M² are each a reactive group that can react with carboxylic acid groups in the intermediate. In some embodiments, G¹-M¹ and G²-M² are independently 2-mercaptoethanol, allyl alcohol, 3-buten-1-ol, or 4-penten-1-ol.

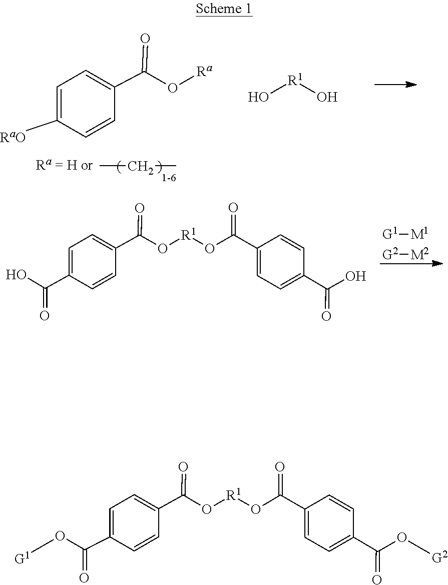

In some embodiments, a monomer of structure (IB) can be prepared by reacting alkyl 4-hydroxy benzoate with excess diol according to Scheme 2. For example, in some embodiments, to form a monomer of structure (IB), alkyl 4-hydroxybenzoate is first reacted with a molar excess of diol to produce a hydroxy-terminated intermediate which, in turn, is reacted with a compound G¹-M³ and/or a compound G²-M⁴, where G¹ and G² are independently a thiol or an ethylenically unsaturated group; and M³ and M⁴ are each a reactive group that can react with hydroxy group in the intermediate. In some embodiments, G¹-M³ or G²-M⁴ or may be an alkene, such as 3-buten-1-ol, to provide a vinyl ether-terminated diene.

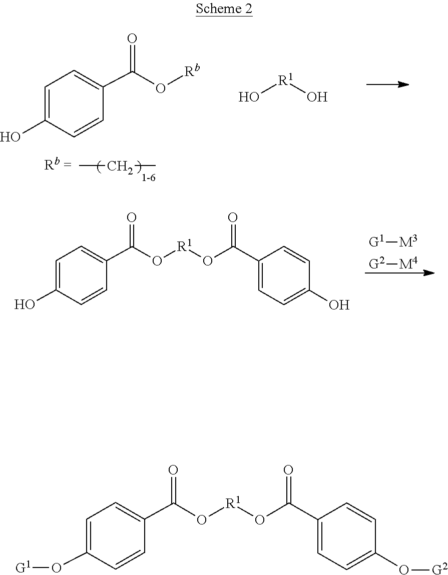

### Curable Resin Compositions

In one aspect, the present disclosure provides curable compositions (also referred to as “curable resins”) that can comprise a plurality of polymerizable components. A curable composition herein may be a photopolymerizable composition, a thermo-polymerizable composition, or a combination thereof.

In some embodiments, a curable composition disclosed herein may include at least one diene monomer of structure (I), (II) or (III) and at least one dithiol monomer which can be a dithiol monomer of structure (I), (II) or (III), an alkylene dithiol, a cycloalkylene dithiol, a heteroalkylene dithiol, an arylene dithiol, or a heteroarylene dithiol. Examples of dithiols include, but are not limited to, 1,2-ethanedithiol (EDT), 1,3-propanedithiol, 1,4-butanedithiol, 1,5-pentanedithiol (PDT), 1,6-hexanedithiol (HDT), 1,10-decanedithiol (DDT), 2,2′-thiodiethanethiol (TDET), 2,2′-(ethylenedioxy)diethanethiol (EDDT), 1,4-bis(3-mercaptobutylyloxy)butane, poly(ethylene glycol) dithiol, and tetra(ethylene glycol) dithiol.

In some embodiments, a curable composition disclosed herein may include at least one dithiol monomer of structure (I), (II) or (III) and at least one diene monomer which can be a diene monomer of structure (I), (II) or (III), an alkylene diene, a cycloalkylene diene, an heteroalkylene diene, an arylene diene, or heteroarylene diene. Examples of dienes include, but are not limited to, diallyl terephthalate (DAT), butanediol diacrylate, tricyclo[5.2.1.02,6]decanedimethanol diacrylate, poly(ethylene glycol) diacrylate, diallyl phthalate, diallyl maleate, trimethylolpropane diallyl ether, ethylene glycol dicyclopentenyl ether acrylate, diallyl carbonate, diallylurea, and 1,6-hexanediol diacrylate.

The ratio of the diene monomer to dithiol monomer in the curable composition can be varied within a range such that the molar ratio of diene monomer to dithiol monomer is from about 1.0:0.8 to about 1.0:1.5. In some embodiments, the ratio of diene monomer to dithiol monomer is about 1:1.

In some embodiments, a curable composition disclosure herein may include at least one thiol-ene monomer of structure (I), (II) or (III).

In some embodiments, the curable composition disclosed herein may include an asymmetric monomer containing an asymmetrically substituted ring. The asymmetric structure results in the formation of both cis and trans conformations, which help to reduce the degree of crystallinity in the resulting polymers. By controlling the ratio of cis and trans conformations, the degree of crystallinity can be tuned. Examples of asymmetric monomers include, but are not limited to, methyl 4-hydroxycyclohexanecarboxylate and ethyl 4-hydroxycyclohexanecarboxylate.

### Additional Components

In some embodiments, the curable composition disclosed herein further comprises an initiator. In some embodiments, the initiator is a photoinitiator. In some embodiments, photoinitiators may be useful for various purposes, including for curing polymers, including those that can be activated with light and initiate polymerization of the polymerizable components of the formulation. In some embodiments, the photoinitiator is a radical photoinitiator and/or a photoacid initiator. In some embodiments, the initiator comprises a photobase generator.

In some embodiments, the photoinitiator is a free radical photoinitiator. In certain embodiments, the free radical photoinitiator comprises an alpha hydroxy ketone moiety (e.g., 2-hydroxy-2-methylpropiophenone or 1-hydroxycyclohexyl phenyl ketone), an alpha-amino ketone (e.g., 2-benzyl-2-(dimethylamino)-4′-morpholinobutyrophenone or 2-methyl-1-[4-(methylthio)phenyl]-2-morpholinopropan-1-one), 4-methyl benzophenone, an azo compound (e.g., 4,4′-Azobis(4-cyanovaleric acid), 1,1′-Azobis(cyclohexanecarbonitrile, Azobisisobutyronitrile, 2,2′-Azobis(2-methylpropionitrile), or 2,2′-Azobis(2-methylpropionitrile)), an inorganic peroxide, an organic peroxide, or any combination thereof. In certain embodiments, the free radical photoinitiator is selected from a benzophenone, a mixture of benzophenone and a tertiary amine containing a carbonyl group which is directly bonded to at least one aromatic ring, and an Irgacure (e.g., Irgacure 907 (2-methyl-1-[4-(methylthio)-phenyl]-2-morpholino-propanone-1) or Irgacure 651 (2,2-dimethoxy-1,2-diphenylethan-1-one). In certain embodiments, the free radical photoinitiator comprises an acetophenone photoinitiator (e.g., 4′-hydroxyacetophenone, 4′-phenoxyacetophenone, 4′-ethoxyaceto-phenone), a benzoin, a benzoin derivative, a benzil, a benzil derivative, a benzophenone (e.g., 4-benzoylbiphenyl, 3,4-(dimethylamino)benzophenone, 2-methylbenzophenone), a cationic photoinitiator (e.g., diphenyliodonium nitrate, (4-iodophenyl)diphenylsulfonium triflate, triphenylsulfonium triflate), an anthraquinone, a quinone (e.g., camphorquinone), a phosphine oxide (e.g., 2,4,6-trimethylbenzoyl diphenyl phosphine oxide (TPO), bis(2,4,6-trimethylbenzoyl)phenyl phosphine oxide (BAPO), ethyl(2,4,6-trimethylbenzoyl)phenyl phosphinate (TPO-L), and bis(2,6-dimethoxybenzoyl)-(2,4,4-trimethylpentyl) phosphine oxide)), a phosphinate, 9,10-phenanthrenequinone, a thioxanthone, any combination thereof, or any derivative thereof. In some embodiments, the composition comprises a photoinitiator comprising SpeedCure TPO-L. In some embodiments, the composition comprises a photoinitiator comprising TPO.

In some embodiments, the photoinitiator is a photoacid initiator such as, for example, aryldiazonium, diaryliodonium, and triarylsulfonium salts.

In some embodiments, the photoinitiator is a photobase generator that generates a base upon exposure to radiation. In some embodiments, the photobase generator includes a photolatent primary, secondary or tertiary amine compound that generates amine upon irradiation. Examples of photolatent primary amines and secondary amines include, but are not limited to, orthonitrobenzylurethane, dimethoxybenzylurethane, benzoins carbamates, O-acyloximes, O-carbamoyl oximes; N-hydroxyimide carbamates; formanilide derivatives; aromatic sulfonamides; cobalt amine complexes and the like. Examples of photolatent tertiary amines include, but are not limited to, α-aminoketone derivatives, α-ammonium ketone derivatives, benzylamine derivatives, benzylammonium salt derivatives, α-aminoalkene derivatives, α-ammonium alkene derivatives. Benzyl ammonium salt derivatives, benzyl substituted amine derivatives, α-amino ketone.

In certain embodiments, the photobase generator comprises 2-(2-nitrophenyl) propyloxycarbonyl-1,1,3,3-tetramethylguanidine (NPPOC-TMG), 2-(2-nitrophenyl)propyl oxycarbonyl-hexylamine (NPPOC-HA), 1-benzyloctahydropyrrolo[1,2-a]pyrimidine, 1-(1-phenylethyl)octahydropyrrolo[1,2-a]pyrimidine, 1-(1-phenylpropyl)octahydropyrrolo[1,2-a]pyrimidine, 1-(1-(o-tolypethyl)octahydropyrrolo[1,2-a]pyrimidine, or 1-(1-(p-tolyl)ethyl)octahydropyrrolo[1,2-a]pyrimidine, or combinations thereof.

In some embodiments, the photoinitiator can have an absorbance between 200 and 300 nm, between 300 and 400 nm, between 400 and 500 nm, between 500 and 600 nm, between 600 and 700 nm, between 700 and 800 nm, between 800 and 900 nm, between 150 and 200 nm, between 200 and 250 nm, between 250 and 300 nm, between 300 and 350 nm, between 350 and 400 nm, between 400 and 450 nm, between 450 and 500 nm, between 500 and 550 nm, between 550 and 600 nm, between 600 and 650 nm, between 650 and 700 nm, or between 700 and 750 nm. In some embodiments, the photoinitiator has an absorbance between 300 to 500 nm.

In some embodiments, the initiator further comprises a thermal initiator. In some embodiments, the thermal initiator comprises an azo compound, an inorganic peroxide, an organic peroxide, or any combination thereof. In some embodiments, the thermal initiator is selected from the group consisting of tert-amyl peroxybenzoate, 4,4-azobis(4-cyanovaleric acid), 1,1′-azobis (cyclohexanecarbonitrile), 2,2′-azobisisobutyronitrile (AIBN), benzoyl peroxide, 2,2-bis(tert-butylperoxy)butane, 1,1-bis(tert-butylperoxy)cyclohexane, 2,5-bis(tert-butylperoxy)2,5-dimethylhexane, 2,5-bis(tert-butylperoxy)-2,5-dimethyl-3-hexyne, bis(1-(tert-butylperoxy)-3,3,5-trimethylcyclohexane, tert-butyl hydroxyperoxide, tert-butyl peracetate, tert-butyl peroxide, tert-butyl peroxybenzoate, tert-butylperoxy isopropyl carbonate, cumene hydroperoxide, cyclohexanone peroxide, dicumyl peroxide, lauroyl peroxide, 2,4-pentanedione peroxide, peracetic acid, potassium persulfate, a derivative thereof, and a combination thereof. In preferred embodiments, the thermal initiator comprises azobisisobutyronitrile, 2,2′-azodi(2-methylbutyronitrile), or combinations thereof. In some embodiments, the thermal initiator is a thermal acid generator or a thermal base generator. Many sulfonium salts can be used as thermal acid generators.

In some embodiments, the curable composition comprises 0.01-10 wt %, 0.02-5 wt %, 0.05-4 wt %, 0.1-3 wt %, 0.1-2 wt %, or 0.1-1 wt %, based on the total weight of the composition, of the initiator. In preferred embodiments, the curable composition comprises 0.1-2 wt %, based on the total weight of the composition, of the initiator. In some embodiments, the curable composition comprises 0.05 to 1 wt %, 0.05 to 2 wt %, 0.05 to 3 wt %, 0.05 to 4 wt %, 0.05 to 5 wt %, 0.1 to 1 wt %, 0.1 to 2 wt %, 0.1 to 3 wt %, 0.1 to 4 wt %, 0.1 to 5 wt %, 0.1 to 6 wt %, 0.1 to 7 wt %, 0.1 to 8 wt %, 0.1 to 9 wt %, or 0.1 to 10 wt %, based on the total weight of the composition, of the photoinitiator. In preferred embodiments, the curable composition comprises 0.1-2 wt % of the photoinitiator. In some embodiments, the curable composition comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the thermal initiator. In preferred embodiments, the curable composition comprises from 0 to 0.5 wt %, based on the total weight of the composition, of the thermal initiator.

In some embodiments, the curable composition disclosed herein can comprise one or more polymerizable components in addition to diene, dithiol, or thiol-ene monomers of structures (I)-(III) provided herein. Such one or more polymerizable components can include one or more telechelic oligomers, one or more telechelic polymers, or a combination thereof. In such instances, a telechelic oligomer can have a number average molecular weight of greater than 500 Da (0.5 kDa) but less than 5 kDa. A telechelic polymer can have a number-average molecular weight of greater than 5 kDa but less than 50 kDa. A telechelic polymer can have a number-average molecular weight of greater than 10 kDa but less than 50 kDa. A telechelic polymer can have a number-average molecular weight of greater than 5 kDa but less than 300 kDa. The telechelic oligomer(s) and/or polymer(s) can comprise photoreactive moieties at their termini. In some cases, the photoreactive moiety can be an acrylate, methacrylate, vinyl acrylate, vinyl methacrylate, allyl ether, silene, allyl silane, alkyne, alkene, vinyl ether, maleimide, fumarate, maleate, itaconate, or styrenyl moiety. In some cases, the photoreactive moiety can be an acrylate or a methacrylate. A telechelic polymer herein can include polyurethanes, polyesters, polyethers, block copolymers or any other commercial polymers with reactive (e.g., photo-reactive or thermo-reactive) end groups. Thus, in various instances, a telechelic polymer suitable for the present disclosure is capable of undergoing photopolymerization with one or more other telechelic polymers, telechelic block copolymers, telechelic oligomers, or polymerizable sulfur-containing components provided herein via its terminal monomers. In various cases, the terminal monomers comprise a photo-reactive moiety enabling further photo-polymerization reactions. Such photo-polymerization reaction of a telechelic polymer with other polymers, oligomers and/or monomers can occur during photo-curing, e.g., in instances where these components are part of a curable composition. In some instances, a telechelic polymer can have one or more glass transition temperatures, wherein at least one glass transition temperature is at 30° C. or lower; preferably 0° C. or lower, even more preferably −20° C. or lower.

In some embodiments, the curable composition disclosed herein can comprise a reactive diluent, a crosslinking modifier, a solvent, a glass transition temperature modifier, a polymerization catalyst, a polymerization inhibitor, a light blocker, a plasticizer, a surface energy modifier, a pigment, a dye, a filler, a biologically significant chemical, or a combination thereof.

In some embodiments, the curable composition of the present disclosure can comprise a reactive diluent homogeneously or heterogeneously dispersed or patterned therethrough. The degree of heterogeneous partitioning (e.g., emulsification) or homogeneity can be controlled with a method or device disclosed herein, for example, through agitation prior to printing. In some cases, the degree of heterogeneity in a curable composition can be controlled through addition of solvents or reactive diluents. In various cases, a reactive diluent can comprise an acrylate or methacrylate moiety for incorporation into an oligomeric or polymeric backbone, coupled to a linear or cyclic (e.g., mono-, bi-, or tricyclic) side-chain moiety. Generally, any aliphatic, cycloaliphatic or aromatic molecule with a mono-functional polymerizable reactive functional group can be used (also includes liquid crystalline monomers). In some instances, the polymerizable reactive functional groups are acrylate or methacrylate groups. In some instances, a reactive diluent is a syringol, guaiacol, or vanillin derivative, for example, homosalic methacrylate (HSMA), syringyl methacrylate (SMA), isobornyl methacrylate (IBOMA), or isobornyl acrylate (IBOA). In some cases, the reactive diluent used herein can have a low vapor pressure, low viscosity, or a combination thereof. In some embodiments, however, low amounts (e.g., 5% w/w or less) of a reactive diluent may be used. In some embodiments, no reactive diluent is used.

In some embodiments, the curable composition of the present disclosure can comprise a crosslinking modifier (also referred to herein as a “crosslinker”). A “crosslinking modifier” as used herein refers to a substance that bonds one oligomer or polymer chain to another oligomer or polymer chain, thereby forming a crosslink. A crosslinking modifier may become part of another substance, such as a crosslink in a polymer material obtained by a polymerization process. In some embodiments, a crosslinking modifier is a curable unit that, when mixed with a curable composition, is incorporated as a crosslink into the polymeric material that results from polymerization of the formulation. In certain embodiments, the curable composition comprises 0-60 wt %, based on the total weight of the composition, of the crosslinking modifier. The crosslinking modifier may have a number average molecular weight equal to or less than 50 kDa, equal to or less than 20 kDa, equal to or less than 10 kDa, equal to or less than 6 kDa, equal to or less than 3 kDa, equal to or less than 2.5 kDa, equal to or less than 2 kDa, equal to or less than 1.5 kDa, equal to or less than 1.25 kDa, equal to or less than 1 kDa, equal to or less than 800 Da, equal to or less than 600 Da, or equal to or less than 400 Da. In some embodiments, the crosslinking modifier can have a high glass transition temperature (Tg), which leads to a high heat deflection temperature. In some embodiments, the crosslinking modifier has a glass transition temperature greater than −10° C., greater than −5° C., greater than 0° C., greater than 5° C., greater than 10° C., greater than 15° C., greater than 20° C., or greater than 25° C. In some specific embodiments, the curable composition comprises 0-25 wt %, based on the total weight of the composition, of the crosslinking modifier, the crosslinking modifier having a molecular weight equal to or less than 1.5 kDa. In some embodiments, the crosslinking modifier comprises a (meth)acrylate-terminated polyester, a vinyl ester-terminated polyester, a tricyclodecanediol vinyl ester, a glycerol, or a derivative thereof, or a combination thereof. Examples of crosslinking modifiers include, but are not limited to, tricyclodecanediol di(meth)acrylate, pentaerythritol tetrakis(3-mercaptopropionate) (PETMP), trimethyl-1,3,5-benzenetricarboxylate, 1,2,4-trivinylcyclohexane (and isomers), and triallyl isocyanurate.

In some embodiments, the curable composition disclosed herein can comprise a solvent. In some embodiments, the solvent comprises a nonpolar solvent. In certain embodiments, the nonpolar solvent comprises pentane, cyclopentane, hexane, cyclohexane, benzene, toluene, 1,4-dioxane, chloroform, diethyl ether, dichloromethane, a derivative thereof, or a combination thereof. In some embodiments, the solvent comprises a polar aprotic solvent. In certain embodiments, the polar aprotic solvent comprises tetrahydrofuran, ethyl acetate, acetone, dimethylformamide, acetonitrile, DMSO, propylene carbonate, a derivative thereof, or a combination thereof. In some embodiments, the solvent comprises a polar protic solvent. In certain embodiments, the polar protic solvent comprises formic acid, n-butanol, isopropyl alcohol, n-propanol, t-butanol, ethanol, methanol, acetic acid, water, a derivative thereof, or a combination thereof. In some embodiments, the curable composition comprises less than 90 wt %, less than 80 wt %, less than 70 wt %, less than 60 wt %, less than 50 wt %, less than 40 wt %, less than 30 wt %, less than 20 et %, less than 15 wt %, less than 10 wt %, less than 5 wt %, less than 3 wt %, less than 2 wt %, or less than 1 wt %, based on the total weight of the composition, of the solvent. In some cases, the solvent is configured to evaporate or separate from the curable resins following curing.

In some embodiments, the curable composition disclosed herein can comprise a glass transition temperature modifier that can alter the glass transition temperature of the resulting polymeric material. In such instances, a glass transition temperature modifier (also referred to herein as a Tg modifier or a glass transition modifier) can be present in a curable composition from about 0 to 50 wt %, based on the total weight of the composition. The Tg modifier can have a high glass transition temperature, which leads to a high heat deflection temperature, which can be necessary to use a material at elevated temperatures. In some embodiments, the curable composition comprises 0 to 80 wt %, 0 to 75 wt %, 0 to 70 wt %, 0 to 65 wt %, 0 to 60 wt %, 0 to 55 wt %, 0 to 50 wt %, 1 to 50 wt %, 2 to 50 wt %, 3 to 50 wt %, 4 to 50 wt %, 5 to 50 wt %, 10 to 50 wt %, 15 to 50 wt %, 20 to 50 wt %, 25 to 50 wt %, 30 to 50 wt %, 35 to 50 wt %, 0 to 40 wt %, 1 to 40 wt %, 2 to 40 wt %, 3 to 40 wt %, 4 to 40 wt %, 5 to 40 wt %, 10 to 40 wt %, 15 to 40 wt %, or 20 to 40 wt %, based on the total weight of the composition, of a Tg modifier. In certain embodiments, the curable composition comprises 0-50 wt % of a glass transition modifier. In some instances, the number average molecular weight of the Tg modifier is from 0.4 to 5 kDa. In some embodiments, the number average molecular weight of the Tg modifier is from 0.1 to 5 kDa, from 0.2 to 5 kDa, from 0.3 to 5 kDa, from 0.4 to 5 kDa, from 0.5 to 5 kDa, from 0.6 to 5 kDa, from 0.7 to 5 kDa, from 0.8 to 5 kDa, from 0.9 to 5 kDa, from 1.0 to 5 kDa, from 0.1 to 4 kDa, from 0.2 to 4 kDa, from 0.3 to 4 kDa, from 0.4 to 4 kDa, from 0.5 to 4 kDa, from 0.6 to 4 kDa, from 0.7 to 4 kDa, from 0.8 to 4 kDa, from 0.9 to 4 kDa, from 1 to 4 kDa, from 0.1 to 3 kDa, from 0.2 to 3 kDa, from 0.3 to 3 kDa, from 0.4 to 3 kDa, from 0.5 to 3 kDa, from 0.6 to 3 kDa, from 0.7 to 3 kDa, from 0.8 to 3 kDa, from 0.9 to 3 kDa, or from 1 to 3 kDa. A polymerizable compound of the present disclosure (which can act by itself as a Tg modifier) and a separate Tg modifier compound can be miscible and compatible in the methods described herein. When used in the subject compositions, the Tg modifier may provide for high Tg and strength values, sometimes at the expense of elongation at break.

In some embodiments, the curable composition disclosed herein can comprise a polymerization catalyst. In some embodiments, the polymerization catalyst comprises a tin catalyst, a platinum catalyst, a rhodium catalyst, a titanium catalyst, a silicon catalyst, a palladium catalyst, a metal triflate catalyst, a boron catalyst, a bismuth catalyst, or any combination thereof. Non-limiting examples of a tin catalyst include di-n-butylbutoxychlorotin, di-n-butyldiacetoxytin, di-n-butyldilauryltin, dimethyldineodecanoatetin, dioctyldilauryltin, tetramethyltin, and dioctylbis(2-ethylhexylmaleate) tin. Non-limiting examples of a platinum catalyst include platinum-divinyltetramethyl-disiloxane complex, platinum-cyclovinylmethyl-siloxane complex, platinum-octanal complex, and platinum carbonyl cyclovinylmethylsiloxane complex. A non-limiting example of a rhodium catalyst includes tris(dibutylsulfide) rhodium trichloride. Non-limiting examples of a titanium catalyst include titanium isopropoxide, titanium 2-ethyl-hexoxide, titanium chloride triisopropoxide, titanium ethoxide, and titanium diisopropoxide bis(ethylacetoacetate). Non-limiting examples of a silicon catalyst include tetramethylammonium siloxanolate and tetramethylsilylmethyl-trifluoromethane sulfonate. A non-limiting example of a palladium catalyst includes tetrakis(triphenylphosphine) palladium (0). Non-limiting examples of a metal triflate catalyst include scandium trifluoromethane sulfonate, lanthanum trifluoromethane sulfonate, and ytterbium trifluoromethane sulfonate. A non-limiting example of a boron catalyst includes tris(pentafluorophenyl) boron. Non-limiting examples of a bismuth catalyst include bismuth-zinc neodecanoate, bismuth 2-ethylhexanoate, a metal carboxylate of bismuth and zinc, and a metal carboxylate of bismuth and zirconium.

In some embodiments, the curable composition disclosed herein can comprise a polymerization inhibitor in order to stabilize the composition and prevent premature polymerization. In some embodiments, the polymerization inhibitor is a photopolymerization inhibitor (e.g., oxygen). In some embodiments, the polymerization inhibitor is a phenolic compound (e.g., butylated hydroxytoluene (BHT)). In some embodiments, the polymerization inhibitor is vitamin E. In some embodiments, the polymerization inhibitor is a stable radical (e.g., 2,2,4,4-tetramethylpiperidinyl-1-oxy radical, 2,2-diphenyl-1-picrylhydrazyl radical, galvinoxyl radical, or triphenylmethyl radical). In some embodiments, more than one polymerization inhibitor is present in the curable composition. In some embodiments, the polymerization inhibitor is an antioxidant, a hindered amine light stabilizer (HAL), a hindered phenol, or a deactivated radical (e.g., a peroxy compound). In some embodiments, the polymerization inhibitor is selected from the group consisting of 4-tert-butylpyrocatechol, tert-butylhydroquinone, 1,4-benzoquinone, 6-tert-butyl-2,4-xylenol, 2-tertbutyl-1,4-benzoquinone, 2,6-di-tert-butyl-p-cresol, 2,6-ditert-butylphenol, 1,1-diphenyl-2-picrylhydrazyl free radical, hydroquinone, 4-methoxyphenol, phenothiazine, derivative thereof, and any combination thereof. In some embodiments, the curable composition comprises from 0 to 1000 ppm, from 0 to 900 ppm, from 0 to 800 ppm, from 0 to 700 ppm, from 0 to 600 ppm, from 0 to 500 ppm, from 0 to 400 ppm, from 0 to 300 ppm, from 0 to 200 ppm, or from 0 to 100 ppm, based on the total weight of the composition, of the polymerization inhibitor.

In some embodiments, the curable composition disclosed herein can comprise a light blocker in order to dissipate UV radiation. In some embodiments, the light blocker absorbs a specific UV energy value and/or range. In some embodiments, the light blocker is a UV light absorber, a pigment, a color concentrate, or an IR light absorber. In some embodiments, the light blocker comprises a benzotriazole (e.g., 2-(2′-hydroxy-phenyl benzotriazole), 2,2-dihydroxy-4-methoxy benzophenone, 9,10-diethoxyanthracene, a hydroxyphenyl triazine, an oxanilide, a benzophenone, or a combination thereof. In some embodiments, the curable composition comprises from 0 to 10 wt %, from 0 to 9 wt %, from 0 to 8 wt %, from 0 to 7 wt %, from 0 to 6 wt %, from 0 to 5 wt %, from 0 to 4 wt %, from 0 to 3 wt %, from 0 to 2 wt %, from 0 to 1 wt %, or from 0 to 0.5 wt %, based on the total weight of the composition, of the light blocker. In more specific embodiments, the curable composition comprises from 0 to 0.5 wt % of the light blocker.

In some embodiments, the curable composition disclosed herein can comprise a filler. In some embodiments, the filler comprises calcium carbonate (i.e., chalk), kaolin, metakolinite, a kaolinite derivative, magnesium hydroxide (i.e., talc), calcium silicate (i.e., wollastonite), a glass filler (e.g., glass beads, short glass fibers, or long glass fibers), a nanofiller (e.g., nanoplates, nanofibers, or nanoparticles), a silica filler (e.g., a mica, silica gel, fumed silica, or precipitated silica), carbon black, dolomite, barium sulfate, Al(OH)₃, Mg(OH)₂, diatomaceous earth, magnetite, halloysite, zinc oxide, titanium dioxide, cellulose, lignin, a carbon filler (e.g., chopped carbon fiber or carbon fiber), a derivative thereof, or a combination thereof. The filler can be a minor constituent of a curable composition, for example, accounting for less than 5 wt %, or can account for a majority of the weight of the curable composition. In some embodiments, the filler is present as at least 0.05 wt %, at least 0.5 wt %, at least 1 wt %, at least 2 wt %, at least 3 wt %, at least 5 wt %, at least 8 wt %, at least 10 wt %, at least 12 wt %, at least 15 wt %, at least 20 wt %, at least 25 wt %, at least 30 wt %, at least 40 wt %, at least 50 wt %, at least 60 wt %, at least 70 wt %, at least 75 wt %, or at least 80 wt % of the curable composition. In some embodiments, the filler is present as at most 80 wt %, at most 75 wt %, at most 70 wt %, at most 60 wt %, at most 50 wt %, at most 40 wt %, at most 30 wt %, at most 25 wt %, at most 20 wt %, at most 15 wt %, at most 10 wt %, at most 8 wt %, at most 5 wt %, at most 3 wt %, at most 2 wt %, at most 1 wt %, or at most 0.5 wt % of the curable composition. In some embodiments, the filler is present between 0.05 and 60 wt %, between 1 and 5 wt %, between 1 and 10 wt %, between 1 and 20 wt %, between 2 and 5 wt %, between 2 and 10 wt %, between 2 and 20 wt %, between 3 and 6 wt %, between 3 and 10 wt %, between 3 and 20 wt %, between 5 and 10 wt %, between 5 and 25 wt %, between 8 and 20 wt %, between 10 and 60 wt %, between 12 and 25 wt %, between 15 and 30 wt %, between 15 and 40 wt %, between 20 and 35 wt %, between 25 and 50 wt %, between 30 and 50 wt %, between 35 and 65 wt %, between 40 and 65 wt %, between 40 and 80 wt %, between 50 and 75 wt %, or between 60 and 80 wt % of the curable composition. In some embodiments, the filler is present between 10 and 60 wt % of the curable composition. In some embodiments, the filler is present between 20 and 60 wt % of the curable composition. In some embodiments, the filler is present between 20 and 40 wt % of the curable composition. In some embodiments, the filler is present between 30 and 50 wt % of the curable composition.

In some embodiments, the curable composition disclosed herein can comprise a pigment, a dye, or a combination thereof. A pigment is typically a suspended solid that may be insoluble in the resin. A dye is typically dissolved in the curable composition. In some embodiments, the pigment comprises an inorganic pigment. In some embodiments, the inorganic pigment comprises an iron oxide, barium sulfide, zinc oxide, antimony trioxide, a yellow iron oxide, a red iron oxide, ferric ammonium ferrocyanide, chrome yellow, carbon black, Pigment Violet 15, or aluminum flake. In some embodiments, the pigment comprises an organic pigment. In some embodiments, the organic pigment comprises an azo pigment, an anthraquinone pigment, a copper phthalocyanine (CPC) pigment (e.g., phthalo blue or phthalo green) or a combination thereof. In some embodiments, the dye comprises an azo dye (e.g., a diarylide or Sudan stain), an anthraquinone (e.g., Oil Blue A or Disperse Red 11), or a combination thereof. In some embodiments, the curable composition comprises from about 0.001 to about 3 wt %, based on the total weight of the composition, of the pigment. In some embodiments, the curable composition comprises from about 0.005 to about 2 wt %, based on the total weight of the composition, of the pigment. In some cases, the curable composition comprises from about 0.005 to about 0.5 wt %, based on the total weight of the composition, of the pigment. In some embodiments, the curable composition comprises from about 0.01 to about 0.3 wt/o, based on the total weight of the composition, of the pigment. In some embodiments, the curable composition comprises from about 0.005 to about 0.1 wt %, based on the total weight of the composition, of the pigment.

In some embodiments, the curable composition disclosed herein can comprise a surface energy modifier. In some embodiments, the surface energy modifier can aid the process of releasing a polymer from a mold. In some embodiments, the surface energy modifier can act as an antifoaming agent. In some embodiments, the surface energy modifier comprises a defoaming agent, a deaeration agent, a hydrophobization agent, a leveling agent, a wetting agent, or an agent to adjust the flow properties of the curable composition. In some embodiments, the surface energy modifier comprises an alkoxylated surfactant, a silicone surfactant, a sulfosuccinate, a fluorinated polyacrylate, a fluoropolymer, a silicone, a star-shaped polymer, an organomodified silicone, or any combination thereof. In some embodiments, the curable composition comprises from between about 0.01 to about 3 wt % of the surface energy modifier. In some embodiments, the curable composition comprises from about 0.05 to about 1.5 wt %, from about 0.1 to about 1.5 wt/o, from about 0.3 to about 1.5 wt %, from about 0.1 to about 1 wt %, from about 0.1 to about 0.5 wt %, from about 0.2 to about 1 wt %, from about 0.3 to about 0.7 wt %, or from about 0.4 to about 1 wt %, based on the total weight of the composition, of the surface energy modifier.

In some embodiments, the curable composition disclosed herein can comprise a plasticizer. A plasticizer can be a nonvolatile material that can reduce interactions between polymer chains, which can decrease glass transition temperature, melt viscosity, and elastic modulus. In some embodiments, the plasticizer comprises a dicarboxylic ester plasticizer, a tricarboxylic ester plasticizer, a trimellitate, an adipate, a sebacate, a maleate, or a bio-based plasticizer. In some embodiments, the plasticizer comprises a dicarboxylic ester or a tricarboxylic ester comprising a dibasic ester, a phthalate, bis(2-ethylhexyl) phthalate (DEHP), bis(2-propylheptyl) phthalate (DPHP), diisononyl phthalate (DINP), di-n-butyl phthalate (DBP), butyl benzyl phthalate (BBZP), diisodecyl phthalate (DIDP), dioctyl phthalate (DOP), diisooctyl phthalate (DIOP), diethyl phthalate (DEP), diisobutyl phthalate (DIBP), di-n-hexyl phthalate, a derivative thereof, or a combination thereof. In some embodiments, the plasticizer comprises a trimellitate comprising trimethyl trimellitate (TMTM), tri-(2-ethylhexyl) trimellitate (TEHTM), tri-(n-octyl, n-decyl) trimellitate (ATM), tri(heptyl, nonyl) trimellitate (LTM), n-octyl trimellitate (OTM), trioctyl trimellitate, a derivative thereof, or a combination thereof. In some embodiments, the plasticizer comprises an adipate comprising bis(2-ethylhexyl) adipate (DEHA), dimethyl adipate (DMAD), monomethyl adipate (MMAD), dioctyl adipate (DOA), Bis[2-(2-butoxyethoxy) ethyl] adipate, dibutyl adipate, diisobutyl adipate, diisodecyl adipate, a derivative thereof, or a combination thereof. In some embodiments, the plasticizer comprises a sebacate comprising dibutyl sebacate (DBS), Bis(2-ethylhexyl) sebacate, diethyl sebacate, dimethyl sebacate, a derivative thereof, or a combination thereof. In some embodiments, the plasticizer comprises a maleate comprising Bis(2-ethyl-hexyl) maleate, dibutyl maleate, diisobutyl maleate, a derivative thereof, or a combination thereof. In some embodiments, the plasticizer comprises a bio-based plasticizer comprising an acetylated monoglyceride, an alkylcitrate, a methyl ricinoleate, or a green plasticizer. In some embodiments, the alkyl citrate is selected from the group consisting of triethyl citrate, acetyl triethyl citrate, tributyl citrate, acetyl tributyl citrate, trioctyl citrate, acetyl trioctyl citrate, trihexyl citrate, acetyl trihexyl citrate, butyryl trihexyl citrate, trimethyl citrate, a derivative thereof, or a combination thereof. In some embodiments, the green plasticizer is selected from the group consisting of epoxidized soybean oil, epoxidized vegetable oil, epoxidized esters of soybean oil, a derivative thereof, or a combination thereof. In some embodiments, the plasticizer comprises an azelate, a benzoate (e.g., sucrose benzoate), a terephthalate (e.g., dioctyl terephthalate), 1, 2-cyclohexane dicarboxylic acid diisononyl ester, alkyl sulphonic acid phenyl ester, a sulfonamide (e.g., N-ethyl toluene sulfonamide, N-(2-hydroxy propyl) benzene sulfonamide, N-(n-butyl) benzene sulfonamaide), an organophosphate (e.g., tricresyl phosphate or tributyl phosphate), a glycol (e.g., triethylene glycol dihexanoate or tetraethylene glycol diheptanoate), a polyether, polybutene, a derivative thereof, or a combination thereof.

In some embodiments, the curable composition disclosed herein can comprise a biologically significant chemical. In some embodiments, the biologically significant chemical comprises a hormone, an enzyme, an active pharmaceutical ingredient, an antibody, a protein, a drug, or any combination thereof. In some embodiments, the biologically significant chemical comprises a pharmaceutical composition, a chemical, a gene, a polypeptide, an enzyme, a biomarker, a dye, a compliance indicator, an antibiotic, an analgesic, a medical grade drug, a chemical agent, a bioactive agent, an antibacterial, an antibiotic, an anti-inflammatory agent, an immune-suppressive agent, an immune-stimulatory agent, a dentinal desensitizer, an odor masking agent, an immune reagent, an anesthetic, a nutritional agent, an antioxidant, a lipopolysaccharide complexing agent or a peroxide.

In some embodiments, the added component (e.g., a crosslinking modifier, a glass transition temperature modifier, a toughness modifier, a polymerization catalyst, a polymerization inhibitor, a light blocker, a plasticizer, a solvent, a surface energy modifier, a pigment, a dye, a filler, or a biologically significant chemical) is functionalized so that it can be incorporated into the polymeric material so that it cannot readily be extracted from the final cured material. In certain embodiments, the polymerization catalyst, polymerization inhibitor, light blocker, plasticizer, surface energy modifier, pigment, dye, and/or filler, are functionalized to facilitate their incorporation into the cured polymeric material.

### Curable Composition Properties

Curable (e.g., photo-curable) compositions disclosed herein can be characterized by having one or more properties. In some embodiments, a curable composition of the present disclosure can have a viscosity from about 30 cP to about 50,000 cP at a printing temperature. In some embodiments, the curable composition has a viscosity less than or equal to 30,000 cP, less than or equal to 25,000 cP, less than or equal to 20,000 cP, less than or equal to 19,000 cP, less than or equal to 18,000 cP, less than or equal to 17,000 cP, less than or equal to 16,000 cP, less than or equal to 15,000 cP, less than or equal to 14,000 cP, less than or equal to 13,000 cP, less than or equal to 12,000 cP, less than or equal to 11,000 cP, less than or equal to 10,000 cP, less than or equal to 9,000 cP, less than or equal to 8,000 cP, less than or equal to 7,000 cP, less than or equal to 6,000 cP, or less than or equal to 5,000 cP at 25° C. In some embodiments, the curable composition has a viscosity less than 15,000 cP at 25° C. In some embodiments, the curable composition has a viscosity less than or equal to 100,000 cP, less than or equal to 90,000 cP, less than or equal to 80,000 cP, less than or equal to 70,000 cP, less than or equal to 60,000 cP, less than or equal to 50,000 cP, less than or equal to 40,000 cP, less than or equal to 35,000 cP, less than or equal to 30,000 cP, less than or equal to 25,000 cP, less than or equal to 20,000 cP, less than or equal to 15,000 cP, less than or equal to 10,000 cP, less than or equal to 5,000 cP, less than or equal to 4,000 cP, less than or equal to 3,000 cP, less than or equal to 2,000 cP, less than or equal to 1,000 cP, less than or equal to 750 cP, less than or equal to 500 cP, less than or equal to 250 cP, less than or equal to 100 cP, less than or equal to 90 cP, less than or equal to 80 cP, less than or equal to 70 cP, less than or equal to 60 cP, less than or equal to 50 cP, less than or equal to 40 cP, less than or equal to 30 cP, less than or equal to 20 cP, or less than or equal to 10 cP at a printing temperature. In some embodiments, the curable composition has a viscosity from 50,000 cP to 30 cP, from 40,000 cP to 30 cP, from 30,000 cP to 30 cP, from 20,000 cP to 30 cP, from 10,000 cP to 30 cP, or from 5,000 cP to 30 cP at a printing temperature. In some embodiments, the printing temperature is from 0° C. to 25° C., from 25° C. to 40° C., from 40° C. to 100° C., or from 20° C. to 150° C. In some embodiments, the curable composition has a viscosity from 30 cP to 50,000 cP at a printing temperature, wherein the printing temperature is from 20° C. to 150° C. In yet other embodiments, the curable composition has a viscosity less than 20,000 cP at a print temperature. In some embodiments, the printing temperature is at least about 20° C., 25° C., 30° C., 40° C., 50° C., 60° C., 80° C., or 100° C. In some embodiments, the print temperature is from 25° C. to 150° C., from 25° C. to 120° C., from 25° C. to 115° C., or from 30° C. to 100° C. In preferred embodiments, the print temperature is from 25° C. to 120° C.

In some embodiments, the curable composition disclosed herein has a melting temperature greater than room temperature. In some embodiments, the curable composition has a melting temperature greater than 20° C., greater than 25° C., greater than 30° C., greater than 35° C., greater than 40° C., greater than 45° C., greater than 50° C., greater than 55° C., greater than 60° C., greater than 65° C., greater than 70° C., greater than 75° C., or greater than 80° C. In some embodiments, the curable composition has a melting temperature from 20° C. to 250° C., from 30° C. to 180° C., from 40° C. to 160° C., or from 50° C. to 140° C. In some embodiments, the curable composition has a melting temperature greater than 60° C. In other embodiments, the curable composition has a melting temperature from 80° C. to 110° C. In some instances, a curable composition can have a melting temperature of about 80° C. before polymerization, and after polymerization, the resulting polymeric material can have a melting temperature of about 100° C.

In certain instances, it may be advantageous that a curable composition is in a liquid phase at an elevated temperature. As an example, a conventional curable composition can comprise polymerizable components that may be viscous at a process temperature, and thus can be difficult to use in the fabrication of objects (e.g., using 3D printing). As a solution for that technical problem, the present disclosure provides curable compositions comprising diene, dithiol, or thiol-ene monomers of structure (I), (II) or (III) described herein that can melt at an elevated temperature, e.g., at a temperature of fabrication (e.g., during 3D printing), and can have a decreased viscosity at the elevated temperature, which can make such curable composition more applicable and usable for uses such as 3D printing. Hence, in some embodiments, provided herein are curable compositions that are a liquid at an elevated temperature. In some embodiments, the elevated temperature is at or above the melting temperature (Tm) of the curable composition. In certain embodiments, the elevated temperature is a temperature in the range from about 40° C. to about 100° C., from about 60° C. to about 100° C., from about 80° C. to about 100° C., or from about 40° C. to about 120° C. In some embodiments, the elevated temperature is a temperature above about 40° C., above about 60° C., above about 80° C., or above about 100° C. In some embodiments, a curable composition herein is a liquid at an elevated temperature with a viscosity less than about 50 Pa s, less than about 20 Pa s, less than about 10 Pa s, less than about 5 Pa s, or less than about 1 Pa s. In some embodiments, a curable composition herein is a liquid at an elevated temperature of above about 40° C. with a viscosity less than about 20 Pa s. In yet other embodiments, a curable composition herein is a liquid at an elevated temperature of above about 40° C. with a viscosity less than about 1 Pa s.

In some embodiments, two or more monomers disclosed herein may be mixed to produce a eutectic mixture, which has a melting point lower than that of the individual monomers. Such an effect can be utilized to control factors such as viscosity and print temperature. For instance, a diene monomer with a melting point (Tm) of 110° C. and a dithiol monomer with a Tm of 90° C. may, when mixed, form a eutectic mixture with a Tm less than 90° C. Alternatively, the eutectic mixture may have a Tm between 90° C. and 110° C.

In some embodiments, at least a portion of a curable composition herein has a melting temperature below about 100° C., below about 90° C., below about 80° C., below about 70° C., or below about 60° C. In some embodiments, at least a portion of a curable composition herein melts at an elevated temperature between about 100° C. and about 20° C., between about 90° C. and about 20° C., between about 80° C. and about 20° C., between about 70° C. and about 20° C., between about 60° C. and about 20° C., between about 60° C. and about 10° C., or between about 60° C. and about 0° C.

The curable composition can, in some embodiments, be characterized by a low crystalline content when the curable composition is at an elevated temperature (e.g., during the 3D printing process). The low crystalline content can be due, e.g., to the elevated temperature being above the melting temperature of the crystalline phases. In some embodiments, the curable composition has less than 60% crystalline content, less than 50% crystalline content, less than 50% crystalline content, less than 40% crystalline content, less than 20% crystalline content, less than 10% crystalline content, or less than 5% crystalline content at the print temperature, as measured by X-ray diffraction. The print temperature can be a temperature from 20-120° C. In some embodiments, at least 90% of the diene, dithiol, or thiol-ene monomers of structures (I)-(III) herein is in a liquid phase at 90° C. In some embodiments, the curable composition is a liquid with no crystallinity at the printing temperature and before curing, but may become crystalline during or after curing, and/or when cooling from the cure temperature. When the curable composition has no crystallinity, the curable composition can be less viscous. In some embodiments, it is preferred to have the viscosity as low as possible. In other embodiments, it is advantageous to have some crystallinities present at the printing temperature. For example, a small amount of crystallinity can facilitate the crystallization process, either during printing or upon cooling down (e.g., they can act as crystallization seeds), to improve the strength of the partially cured composition.

The curable composition of the present disclosure can comprise less than about 20 wt % or less than about 10 wt % hydrogen bonding units. In some embodiments, a curable composition herein comprises less than about 15 wt %, less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, or less than about 1 wt % hydrogen bonding units, wherein wt % is the weight percent of species, including monomeric units in polymerized, oligomerized, and monomeric form, capable of forming at least one hydrogen bond.

### Polymeric Materials

The present disclosure provides polymeric materials generated by curing the curable composition described herein (also referred to herein as “printed polymeric materials” and “cured polymeric materials”). The cured polymeric materials comprise semicrystalline sulfur-containing polymers and include a crystalline domain (also referred to herein as a “crystalline phase”) and an amorphous domain (also referred to herein as an “amorphous phase”).

In some embodiments, the polymeric material has a melting temperature (Tm) above 20° C., above 30° C., above 40° C., above 50° C., above 60° C., or above 70° C., as measured by DSC. In some embodiments, the use temperature is different from temperatures near standard room temperatures, and the polymeric material has a melting temperature greater than or equal to 10° C., greater than or equal to 30° C., greater than or equal to 60° C., greater or equal to 80° C., greater than or equal to 100° C., or greater than or equal to 150° C. above the use temperature. In preferred embodiments, the polymeric material has a melting temperature greater than 60° C. In some embodiments, the polymeric material has a melting temperature between 60° C. and 180° C., between 60° C. and 120° C., or between 70° C. and 100° C.

In some embodiments, the polymeric material has a glass transition temperature (Tg) less than 80° C., less than 70° C., less than 60° C., less than 50° C., less than 40° C., less than 30° C., less than 20° C., less than 10° C., less than 0° C., less than −10° C., less than −15° C., less than −20° C., less than −40° C., as measured by DSC. In some embodiments, the polymeric material may have more than one glass transition temperature. For example, in some embodiments, the polymeric material has a first glass transition temperature less than 40° C. and a second glass transition temperature greater than 60° C. In preferred embodiments, the polymeric material has an onset temperature at or below the use temperature.

In some embodiments, the polymeric material is a semicrystalline material having a glass transition temperature, a melting temperature, and a crystallization temperature. In some embodiments, the polymeric material has a glass transition temperature below 40° C., below 0° C., below −15° C., or below −40° C., and a melting temperature greater than 40° C., greater than 80° C., greater than 100° C., greater than 180° C., and greater than 200° C.

In some embodiments, the polymeric material comprises at least one crystalline domain and an amorphous domain. The combination of these two domains can create a polymeric material that has a high modulus phase and a low modulus phase. By having these two phases, the polymeric material can have high modulus and high elongation, as well as high stress remaining following stress relaxation.

In some embodiments, the polymeric material may be formed from a eutectic mixture. The resultant polymeric material may have one or more melting points that are similar to, higher than, or lower than that of the resin. In some embodiments, the monomers have functional groups that are purposely chosen to react preferentially, leading to the formation of polymers of different repeating structures. For example, a thiol-ene combination, along with a telechelic oligomer with methacrylate functional groups, may form a resin with one Tm, but upon polymerization, the thiol-ene reaction preferentially forms one polymer, while the methacrylate polymerization forms a different polymer, and copolymerization of thiol with methacrylate can form a third polymer. By controlling the reactive groups and starting monomers, polymeric materials with different polymer structures, crystalline Tms, phase domains, and domain sizes can all be created and controlled.

### Phase Separation in Polymeric Materials

In some embodiments, the curable composition herein can be cured by exposing such composition to electromagnetic radiation of an appropriate wavelength. Such curing or polymerization can induce phase separation in the resulting polymeric material. Such polymerization-induced phase separation can occur along one or more lateral and vertical direction(s). Polymerization-induced phase separation can generate one or more polymeric phases in the resulting polymeric material. A curable composition undergoing polymerization and polymerization-induced phase separation can comprise one or more polymerizable compounds or monomers of the present disclosure. Thus, in some cases, at least one polymeric phase of the one or more polymeric phases generated during curing and present in the resulting polymeric material can comprise, in a polymerized form, at least one of the one or more polymerizable compounds or monomers of the present disclosure. In an example, a curable composition comprising a polymerizable compound and a thiol-ene monomer is cured by exposure to electromagnetic radiation of an appropriate wavelength.

A polymeric phase of a polymeric material of the present disclosure can have a certain size or volume. In some embodiments, a polymeric phase is 3-dimensional, and can have at least one dimension less than 1000 μm, less than 500 μm, less than 250 μm, less than 200 μm, less than 150 μm, less than 100 μm, less than 90 μm, less than 80 μm, less than 70 μm, less than 60 μm, less than 50 μm, less than 40 μm, less than 30 μm, less than 20 μm, less than 10 μm, less than 5 μm, less than 1 μm, less than 500 nm, or less than 100 nm. In certain embodiments, the polymeric phase can have at least two dimension less than 1000 μm, less than 500 μm, less than 250 μm, less than 200 μm, less than 150 μm, less than 100 μm, less than 90 μm, less than 80 μm, less than 70 μm, less than 60 μm, less than 50 μm, less than 40 μm, less than 30 μm, less than 20 μm, less than 10 μm, less than 5 μm, less than 1 μm, less than 500 nm, or less than 100 nm. In certain embodiments, the polymeric phase can have three dimensions less than 1000 μm, less than 500 μm, less than 250 μm, less than 200 μm, less than 150 μm, less than 100 μm, less than 90 μm, less than 80 μm, less than 70 μm, less than 60 μm, less than 50 μm, less than 40 μm, less than 30 μm, less than 20 μm, less than 10 μm, less than 5 μm, less than 1 μm, less than 500 nm, or less than 100 nm. In some embodiments, a polymeric material comprises an average polymeric phase size of less than 500 nm or less than 100 nm in at least one spatial dimension.

Control of the crystalline domain size or volume percent can be achieved by adding additional components to the curable composition. Such additional components can act as defects that prevent or hinder crystallization. Crosslinking introduces both a defect and restricts the mobility of the polymeric network which can prevent it from moving into a position that crystallizes. The addition of one or more additional monomers, oligomers, polymers, plasticizers, solvents, and other resin components can also limit the extent of crystallinity. In some embodiments, monomers with chiral centers are used to hinder crystallization. Asymmetric molecules can also be used to hinder crystallinity. Asymmetric molecules may still be able to crystallize; however due to their asymmetric structure, they often crystallize slowly. This is because they require a preferred orientation in order to crystallize.

In various aspects, the present disclosure provides a polymeric material that can comprise one or more polymeric phases, wherein at least one polymeric phase of the one or more polymeric phases is a crystalline phase. In various aspects, the present disclosure provides a polymeric material that can comprise one or more polymeric phases, wherein at least one polymeric phase of the one or more polymeric phases is an amorphous phase. In some instances, provided herein is a polymeric material that can comprise two or more polymeric phases, wherein at least one polymeric phase of the one or more polymeric phases is a crystalline phase, and at least one polymeric phase of the one or more polymeric phases is an amorphous phase.

Hence, in some instances, provided herein is a polymeric material comprising: (i) at least one crystalline phase comprising at least one polymer crystal having a melting temperature above 20° C.; and (ii) at least one amorphous phase comprising at least one amorphous polymer having a glass transition temperature greater than 40° C. In some embodiments, such amorphous phase has a glass transition temperature greater than 50° C., 60° C., 70° C., 80° C., 90° C., 100° C. or greater than 110° C. In some embodiments, the at least one polymer crystal has a melting temperature above 30° C., 40° C., 50° C., 60° C., or above 70° C.

### Amorphous Polymeric Phases

The present disclosure provides polymeric materials comprising one or more amorphous phases, e.g., generated by polymerization-induced phase separation. Such polymeric materials, or regions of such material that contain polymeric phases, can provide fast response times to external stimuli, which can confer favorable properties to the polymeric material comprising the crystalline phase and/or the amorphous phase, e.g., for using the polymeric material in a medical device (e.g., an orthodontic appliance). In some cases, a polymeric material comprising one or more amorphous polymeric phases can, for example, provide flexibility to the cured polymeric material, which can increase its durability (e.g., the material can be stretched or bent while retaining its structure, while a similar material without amorphous phases can crack). In certain embodiments, amorphous phases can be characterized by randomly oriented polymer chains (e.g., not stacked in parallel or in crystalline structures). In some embodiments, such amorphous phase of a polymeric material can have a glass transition temperature of greater than about 10° C., 20° C., 30° C., 40° C., 50° C., 60° C., 70° C., 80° C., 90° C., 100° C., or greater than about 110° C. In some embodiments, an amorphous phase can have a glass transition temperature from about 40° C. to about 60° C., from about 50° C. to about 70° C., from about 60° C. to about 80° C., or from about 80° C. to about 110° C. In some embodiments, the amorphous phase has a glass transition temperature less than 10° C., 0° C., −10° C., −30° C., or −50° C. In some preferred aspects, one or more amorphous phases will have a glass transition temperature less than 0° C. In some embodiments, two or more amorphous phases have glass transition temperatures above 60° C. and below 10° C.

In some embodiments, an amorphous phase herein (also referred to herein as an amorphous domain) can comprise at least about 5%, 10%, 20%, 30%, 40%, 50%, 60%, 70%, 80% or at least about 90% amorphous polymeric material in an amorphous state. The percentage of amorphous polymeric material in an amorphous phase generally refers to the total volume percent.

In some embodiments, an amorphous polymeric phase can comprise one or more polymer types that may have formed, during curing, from diene, dithiol, or thiol-ene monomers of structure (I), (II) or (II), and any other polymerizable components that may have been present in the curable composition used to produce the polymeric material that contains the amorphous polymeric phase.

In some instances, polymerizable components of a curable composition that are typically capable of forming a crystalline material may form an amorphous phase instead when subjected to conditions that prevent crystallization. Hence, in some cases, materials that conventionally regarded as crystalline can, under specific circumstances, behave as amorphous materials. As a non-limiting example, while polycaprolactone is generally a crystalline polymer, its crystallization can be suppressed when it is mixed with other polymerizable monomers and telechelic polymers, leading to formation of an amorphous phase.

### Crystalline Polymeric Phases

As further described herein, a polymeric material of the present disclosure can comprise one or more crystalline phases, e.g., generated by polymerization-induced phase separation during curing. As described herein, a crystalline phase is a polymeric phase of a cured polymeric material that comprises at least one polymer crystal. As disclosed herein, a crystalline phase may consist of a single polymeric crystal, or may comprise a plurality of polymeric crystals.

In some embodiments, a crystalline polymeric phase can have a melting temperature equal to or greater than about 20° C., 30° C., 40° C., 50° C., 60° C., 70° C., 80° C., 90° C., 100° C., 120° C., or equal to or greater than about 150° C. In some cases, at least two crystalline phases of a plurality of crystalline phases can have a different melting temperature due to, e.g., differences in crystalline phase sizes, impurities, degree of cross-linking, chain lengths, thermal history, rates at which polymerization occurred, degree of phase separation, or any combination thereof. In some embodiments, at least two crystalline phases of a polymeric material can each have a polymer crystal melting temperature within about 5° C. of each other. In some instances, such melting temperature difference can be less than about 5° C. In other instances, such melting temperature difference can be greater than about 5° C. In some embodiments, each of the polymer crystal melting temperatures of a polymeric material can be from about 40° C. to about 150° C. In some embodiments, at least about 80% of the crystalline domains of a polymeric material can comprise a polymer crystal having a melting temperature between about 40° C. and about 150° C.

In some embodiments, at least 80% of the crystalline phases have a crystal melting point at a temperature between 0° C. and 150° C. In some embodiments, at least 80% of the crystalline phases have a crystal melting point at a temperature between 40° C. and 60° C., between 40° C. and 80° C., between 40° C. and 120° C., between 60° C. and 80° C., between 60° C. and 120° C., between 80° C. and 120° C., or greater than 120° C. In some embodiments, at least 90% of the crystalline phases have a crystal melting point at a temperature between 0° C. and 150° C. In some embodiments, at least 90% of the crystalline phases have a crystal melting point at a temperature between 40° C. and 60° C., between 40° C. and 80° C., between 40° C. and 100° C., between 60° C. and 80° C., between 60° C. and 120° C., between 80° C. and 120° C., or greater than 120° C. In some embodiments, at least 95% of the crystalline phases have a crystal melting point at a temperature between 0° C. and 150° C. In some embodiments, at least 95% of the crystalline phases have a crystal melting point at a temperature between 40° C. and 60° C., between 40° C. and 80° C., between 40° C. and 120° C., between 60° C. and 80° C., between 60° C. and 120° C., between 80° C. and 120° C., or greater than 120° C.

In certain embodiments, the temperature at which a crystalline phase of a cured polymeric material melts can be controlled, e.g., by using different amounts and types of polymerizable components in the curable composition.

In some embodiments, the curing of a resin composition can occur at an elevated temperature (e.g., at about 90° C.), and as the cured polymeric material cools to room temperature (e.g., 25° C.), the cooling can trigger the formation and/or growth of polymeric crystals in the polymeric material. In some instances, a polymeric material can be a solid at room temperature and can be crystalline-free, but can form crystalline phase over time. In such cases, a crystalline phase can form within 1 hour, within 2 hours, within 4 hours, within 8 hours, within 12 hours, within 18 hours, within 1 day, within 2 days, within 3 days, within 4 days, within 5 days, within 6 days, or within 7 days after cooling. In some embodiments, a crystalline phase can form while the cured polymeric material is in a cooled environment, e.g., an environment having a temperature from about 40° C. to about 30° C., from about 30° C. to about 20° C., from about 20° C. to about 10° C., from about 10° C. to about 0° C., from about 0° C. to about −10° C., from about −10° C. to about −20° C., from about −20° C. to about −30° C., or below about −30° C. In some instances, a polymeric material can be heated to an elevated temperature in order to induce crystallization or formation of crystalline phases. As a non-limiting example, a polymeric material that is near its glass transition temperature can comprise polymer chains that may not be mobile enough to organize into crystals, and thus further heating the material can increase chain mobility and induce formation of crystals.

In some embodiments, the generation, formation, and/or growth of a polymeric phase is spontaneous. In some embodiments, the generation, formation, and/or growth of a polymer crystal is facilitated by a trigger. In some embodiments, the trigger comprises the addition of a seeding particle (also referred to herein as a “seed”), which can induce crystallization. Such seeds can include, for example, finely ground solid material that has at least some properties similar to the forming crystals. In some embodiments, the trigger comprises a reduction of temperature. In certain embodiments, the reduction of temperature can include cooling the cured material to a temperature from 40° C. to 30° C., from 30° C. to 20° C., from 20° C. to 10° C., from 10° C. to 0° C., from 0° C. to −10° C., from −10° C. to −20° C., from −20° C. to −30° C., or below −30° C. In some embodiments, the trigger can comprise an increase in temperature. In certain embodiments, the increase of temperature can include heating the polymeric cured material to a temperature from 20° C. to 40° C., from 40° C. to 60° C., from 60° C. to 80° C., from 80° C. to 100° C., or above 100° C. In some embodiments, the trigger comprises a force placed on the cured polymeric material. In certain embodiments, the force includes squeezing, compacting, pulling, twisting, or providing any other physical force to the material. In some embodiments, the trigger comprises an electrical charge and/or electrical field applied to the material. In some embodiments, formation of one or more crystalline phases may be induced by more than one trigger (i.e., more than one type of trigger can facilitate the generation, formation, and/or growth of crystals). In some embodiments, the polymeric material comprises a plurality of crystalline phases, and at least two of the crystalline phases may be induced by different triggers.

In some embodiments, a polymeric material herein comprises a crystalline phase that has discontinuous phase transitions (e.g., first-order phase transitions). In some cases, a polymeric material has discontinuous phase transitions, due at least in part to the presence of one or more crystalline domains. As a non-limiting example, a cured polymeric material comprising one or more crystalline domains can, when heated to an elevated temperature, have one or more portions that melt at such elevated temperature, as well as one or more portions that remain solid.

In some embodiments, a polymeric material comprises crystalline phases that are continuous and/or discontinuous phases. A continuous phase can be a phase that can be traced or is connected from one side of a polymeric material to another side of the material; for instance, a closed-cell foam has material comprising the foam that can be traced across the sample, whereas the closed cells (bubbles) represent a discontinuous phase of air pockets. In some embodiments, the at least one crystalline phase forms a continuous phase while the at least one amorphous phase is discontinuous across the material. In another embodiment, the at least one crystalline phase is discontinuous and the at least one amorphous phase is continuous across the material. In another embodiment, both the at least one crystalline and the at least one amorphous phases are continuous across the material. In some embodiments, a polymeric material comprises a plurality of crystalline phases, wherein one or more crystalline phases of the plurality of crystalline phases have a high melting point (e.g., at least about 50° C., 70° C., or 90° C.) and are in a discontinuous phase, while another one or more crystalline phases of the plurality of crystalline phases have a low melting point (e.g., at less than about 50° C., 70° C., or 90° C.) and are in a continuous phase. In some embodiments, two continuous amorphous phases are present. In other embodiments, one continuous and one discontinuous amorphous phase is present

In some embodiments, a polymeric material comprises an average crystalline phase size of less than about 100 μm, less than about 50 μm, less than about 20 μm, less than about 10 μm, less than about 5 μm, less than about 1 μm, less than about 500 nm, less than about 400 nm, less than about 300 nm, or less than about 200 nm in at least one spatial dimension.

In some embodiments, a polymer crystal of a crystalline phase can comprise greater than about 40 wt %, greater than about 50 wt %, greater than about 60 wt %, greater than about 70 wt %, greater than about 80 wt %, or greater than about 90 wt % of linear polymers and/or linear oligomers.

In some embodiments, the polymeric material has a crystalline content (i.e., the volume percentage of polymer crystals) from 20% to 60% by volume. In some embodiments, the crystalline content is between 30% and 50%, or between 50% and 80%. The crystalline content can be measured by X-ray diffraction. In some embodiments, a polymeric material disclosed herein can comprise a weight ratio of crystalline phases to amorphous phases from about 1:99 to about 99:1.

In some embodiments, a cured polymer such as a crosslinked polymer, can be characterized by a tensile stress-strain curve that displays a yield point after which the test specimen continues to elongate, but there is no (detectable) or only a very low increase in stress. Such yield point behavior can occur “near” the glass transition temperature, where the material is between the glassy and rubbery regimes and may be characterized as having viscoelastic behavior. In some embodiments, viscoelastic behavior is observed in the temperature range from about 20° C. to about 40° C. The yield stress is determined at the yield point. In some embodiments, the modulus is determined from the initial slope of the stress-strain curve or as the secant modulus at 1% strain (e.g., when there is no linear portion of the stress-strain curve). The elongation at yield is determined from the strain at the yield point. When the yield point occurs at a maximum in the stress, the ultimate tensile strength is less than the yield strength. For a tensile test specimen, the strain is defined by ln (l/l₀), which may be approximated by (l−l₀)/l₀ at small strains (e.g., less than approximately 10%) and the elongation is l/l₀, where l is the gauge length after some deformation has occurred and l₀ is the initial gauge length. The mechanical properties can depend on the temperature at which they are measured. The test temperature may be below the expected use temperature for an orthodontic appliance such as 35° C. to 40° C. In some embodiments, the test temperature is 23±2° C.

As provided further herein, the polymeric material comprising a crystalline phase (can also be referred to herein as a crystalline domain) and an amorphous phase (can also be referred to herein as an amorphous domain) can have improved characteristics, such as the ability to act quickly (e.g., vibrate quickly and react upon application of strain, from the elastic characteristics of the amorphous domain) and also provide strong modulus (e.g., are stiff and provide strength, from the crystalline domain). The polymer crystals disclosed herein can comprise closely stacked and/or packed polymer chains. In some embodiments, the polymer crystals comprise long oligomer or long polymer chains that are stacked in an organized fashion, overlapping in parallel. The polymer crystals can in some cases be pulled out of a crystalline phase, resulting in an elongation as the polymer chains of the polymer crystal are pulled (e.g., application of a force can pull the long polymer chain of the polymer crystal, thus introducing disorder to the stacked chains, pulling at least a portion out of its crystalline state without breaking the polymer chain). This is in contrast with fillers that are traditionally used in the formation of resins for materials with high flexural modulus, which can simply slip through the amorphous phase as forces are applied to the polymeric material or when the fillers are covalently bonded to the polymers causing a reduction in the elongation to break for the material. The use of polymer crystals in the resulting polymeric material can thus provide a less brittle product that can retain more of the original physical properties following use (i.e., are more durable), and retains elastic characteristics through the combination of amorphous and crystalline phases.

In some embodiments, a polymeric material herein comprises a ratio of crystalline polymeric phases to amorphous polymeric phases (wt/wt) of greater than about 1:10, greater than about 1:9, greater than about 1:8, greater than about 1:7, greater than about 1:6, greater than about 1:5, greater than about 1:4, greater than about 1:3, greater than about 1:2, greater than about 1:1, greater than about 2:1, greater than about 3:1, greater than about 4:1, greater than about 5:1, greater than about 6:1, greater than about 7:1, greater than about 8:1, greater than about 9:1, greater than about 10:1, greater than about 20:1, greater than about 30:1, greater than about 40:1, greater than about 50:1, or greater than about 99:1. In some embodiments, the polymeric material comprises a ratio of the crystalline polymeric phases to the amorphous polymeric phases (wt/wt) of at least 1:10, at least 1:9, at least 1:8, at least 1:7, at least 1:6, at least 1:5, at least 1:4, at least 1:3, at least 1:2, at least 1:1, at least 2:1, at least 3:1, at least 4:1, at least 5:1, at least 6:1, at least 7:1, at least 8:1, at least 9:1, at least 10:1, at least 20:1, at least 30:1, at least 40:1, at least 50:1, or at least 99:1. In certain embodiments, the polymeric material comprises a ratio of crystalline polymeric phases to amorphous polymeric phases (wt/wt) of between 1:9 and 99:1, between 1:9 and 9:1, between 1:4 and 4:1, between 1:4 and 1:1, between 3:5 and 1:1, between 1:1 and 5:3, or between 1:1 and 4:1.

In some embodiments, a polymeric material disclosed herein comprises a ratio of crystalline polymeric phases to amorphous polymeric phases (vol/vol) of greater than about 1:10, greater than about 1:9, greater than about 1:8, greater than about 1:7, greater than about 1:6, greater than about 1:5, greater than about 1:4, greater than about 1:3, greater than about 1:2, greater than about 1:1, greater than about 2:1, greater than about 3:1, greater than about 4:1, greater than about 5:1, greater than about 6:1, greater than about 7:1, greater than about 8:1, greater than about 9:1, greater than about 10:1, greater than about 20:1, greater than about 30:1, greater than about 40:1, greater than about 50:1, or greater than about 99:1. In some embodiments, the polymeric material comprises a ratio of crystalline polymeric phases to amorphous polymeric phases (vol/vol) of at least 1:10, at least 1:9, at least 1:8, at least 1:7, at least 1:6, at least 1:5, at least 1:4, at least 1:3, at least 1:2, at least 1:1, at least 2:1, at least 3:1, at least 4:1, at least 5:1, at least 6:1, at least 7:1, at least 8:1, at least 9:1, at least 10:1, at least 20:1, at least 30:1, at least 40:1, at least 50:1, or at least 99:1. In certain embodiments, the polymeric material comprises a ratio of crystalline polymeric phases to amorphous polymeric phases (vol/vol) of between 1:9 and 99:1, between 1:9 and 9:1, between 1:4 and 4:1, between 1:4 and 1:1, between 3:5 and 1:1, between 1:1 and 5:3, or between 1:1 and 4:1.

### Properties of Polymeric Materials

Sulfur-containing polymeric materials formed from the polymerization of curable compositions disclosed herein can provide advantageous characteristics compared to conventional polymeric materials. In some instances, and as described herein, a polymeric material can contain some percentage of crystallinity, which can impart an increased toughness and high modulus to the polymeric material, while in some circumstances being a 3D printable material. Furthermore, a polymeric material herein can further comprise one or more amorphous phases that can provide increased durability, prevention of crack formation, as well as prevention of crack propagation. In some instances, a polymeric material can also have low amounts of water uptake, and can be solvent resistant. In some cases, a polymeric material can be characterized by one or more of the properties selected from the group consisting of elongation at break, storage modulus, tensile modulus, flexural stress remaining, glass transition temperature, water uptake, hardness, color, transparency, hydrophobicity, lubricity, surface texture, percent crystallinity, phase composition ratio, phase domain size, and phase domain size and morphology. Further, as described herein, a polymeric material provided herein can be used for a multitude of applications, including 3D printing, to form a device having favorable properties of both elasticity and stiffness. Specifically, a polymeric material of this disclosure can provide excellent flexural modulus, elastic modulus, elongation at break, or a combination thereof.

In various embodiments, a polymeric material disclosed herein can comprise or consist of a high toughness, e.g., through a tough polymer matrix, and the difference (or delta) between the elastic modulus measured at different strain rates (e.g., at 1.7 mm/min and 510 mm/min) can be low, e.g., lower than 80%, 70%, 60%, 50%, 40%, or lower than 30%, which can be an indication for a polymeric phase separation within the material.

In some embodiments, a polymeric material disclosed herein can have one or more of the following characteristics: (A) a storage modulus greater than or equal to 200 MPa; (B) a flexural stress and/or flexural modulus of greater than or equal to 1.5 MPa remaining after 24 hours in a wet environment at 37° C.; (C) an elongation at break greater than or equal to 5% before and after 24 hours in a wet environment at 37° C.; (D) a water uptake of less than 25 wt % when measured after 24 hours in a wet environment at 37° C.; (E) transmission of at least 30% of visible light through the polymeric material after 24 hours in a wet environment at 37° C.; and (F) comprises a plurality of polymeric phases, wherein at least one polymeric phase of the one or more polymeric phases has a Tg of at least 60° C., 80° C., 90° C., 100° C., or at least 110° C. In some instances, a polymeric material herein has at least two, three, four, five, or all characteristics of (A), (B), (C), (D), (E) and (F).

In some instances, the polymeric material disclosed herein can be characterized by a storage modulus of 0.1 MPa to 4000 MPa, a storage modulus of 300 MPa to 3000 MPa, or a storage modulus of 750 MPa to 3000 MPa after 24 hours in a wet environment at 37° C. In some instances, the polymeric material is characterized by a flexural stress and/or flexural modulus of greater than or equal to 5 MPa, greater than or equal to 10 MPa, greater than or equal to 20 MPa, greater than or equal to 30 MPa, greater than or equal to 40 MPa, greater than or equal to 50 MPa, greater than or equal to 60 MPa, greater than or equal to 80 MPa, or greater than or equal to 100 MPa remaining after 24 hours in a wet environment at 37° C.

In some instances, the polymeric material disclosed herein can have a flexural stress and/or flexural modulus of 400 MPa or more, 300 MPa or more, 200 MPa or more, 180 MPa or more, 160 MPa or more, 120 MPa or more, 100 MPa or more, 80 MPa or more, 70 MPa or more, 60 MPa or more, after 24 hours in a wet environment at 37° C.

In some instances, the polymeric material disclosed herein can be characterized by an elongation at break greater than 10%, an elongation at break greater than 20%, an elongation at break greater than 30%, an elongation at break of 5% to 250%, an elongation at break of 20% to 250%, or an elongation at break value between 40% and 250% before and after 24 hours in a wet environment at 37° C.

A polymeric material disclosed herein can be characterized by a water uptake of less than 20 wt %, less than 15 wt %, less than 10 wt %, less than 5 wt %, less than 4 wt %, less than 3 wt %, less than 2 wt %, less than 1 wt %, less than 0.5 wt %, less than 0.25 wt %, or less than 0.1 wt % when measured after 24 hours in a wet environment at 37° C. In some cases, a polymeric material can have greater than 50%, 60%, or 70% conversion of double bonds to single bonds compared to the curable composition, as measured by FTIR.

In some embodiments, a polymeric material disclosed herein can have an ultimate tensile strength from 10 MPa to 100 MPa, from 15 MPa to 80 MPa, from 20 MPa to 60 MPa, from 10 MPa to 50 MPa, from 10 MPa to 45 MPa, from 25 MPa to 40 MPa, from 30 MPa to 45 MPa, or from 30 MPa to 40 MPa after 24 hours in a wet environment at 37° C.

In some embodiments, a polymeric material disclosed herein can have a low amount of hydrogen bonding which can facilitate a decreased uptake of water in comparison with conventional polymeric materials having greater amounts of hydrogen bonding. Thus, in some instances, a polymeric material herein can comprise less than about 10 wt %, less than about 9 wt %, less than about 8 wt %, less than about 7 wt %, less than about 6 wt %, less than about 5 wt %, less than about 4 wt %, less than about 3 wt %, less than about 2 wt %, less than about 1 wt %, or less than about 0.5 wt % water when fully saturated at use temperature (e.g., about 20° C., 25° C., 30° C., or 35° C.). In some instances, the use temperature can include the temperature of a human mouth (e.g., approximately 35-40° C.). The use temperature can be a temperature selected from −100-250° C., 0-90° C., 0-80° C., 0-70° C., 0-60° C., 0-50° C., 0-40° C., 0-30° C., 0-20° C., 0-10° C., 20-90° C., 20-80° C., 20-70° C., 20-60° C., 20-50° C., 20-40° C., 20-30° C., or below 0° C.

In some embodiments, a polymeric material disclosed herein can comprise at least one crystalline phase and at least one amorphous phase, wherein the at least one crystalline phase contains rigid segments of a semicrystalline sulfur-containing polymer of the present disclosure, and the at least one amorphous phase contains flexible segments of a semicrystalline sulfur-containing polymer of the present disclosure. In some instances, a combination of these two types of phases or domains can create a polymeric material that has a high modulus phase (e.g., the crystalline polymeric phase can provide a high modulus) and a low modulus phase (e.g., provided by the presence of the amorphous polymeric phase). By having these two phases, the polymeric material can have a high modulus and a high elongation, as well as high flexural stress remaining following stress relaxation.

In various instances, the one or more amorphous phases of the polymeric material can have a glass transition temperature of at least about 30° C., 40° C., 50° C., 60° C., 70° C., 80° C., 90° C., 100° C., or at least about 110° C. In such cases, at least one amorphous phase of the one or more amorphous phases having a glass transition temperature of at least about 50° C. comprises, integrated in its polymeric structure, flexible segments of a semicrystalline sulfur-containing polymer of the present disclosure. In other instances, the one or more amorphous phases of the polymeric materials can have a glass transition temperature of no more than −50° C., −30° C., −10° C., 0° C., 20° C., or no more than 40° C.

In some embodiments, a polymeric material disclosed herein can comprise crystalline and/or amorphous phases having a smaller size (e.g., less than about 5 μm). Smaller polymeric phases in a polymeric material can facilitate light passage and provide a polymeric material that appears clear. In contrast, larger polymeric phases (e.g., those larger than about 1 μm) can scatter light, for example, when the refractive index of the polymer crystal is different from the refractive index of the amorphous phase adjacent to the polymer crystal (e.g., the amorphous material). In some cases, at least 40%, 50%, 60%, or 70% of visible light passes through the polymeric material after 24 hours in a wet environment at 37° C. (when a sample thickness of 500 microns is tested).

Thus, in some cases, it may be advantageous to have a polymeric material that comprises small polymeric phases such as crystalline or amorphous phases, e.g., as measured by the longest length of the phases. In some embodiments, such polymeric material comprises an average polymeric phase size that is less than 5 μm. In some cases, the maximum polymeric phase size of the polymeric materials can be about 5 μm. In some embodiments, at least about 50%, at least about 60%, at least about 70%, at least about 80%, at least about 90%, at least about 95%, or at least about 99% of the polymeric phases of the polymeric material have a size of less than about 5 μm. In yet other embodiments, a polymeric material comprises an average polymeric phase size that is less than about 1 μm. In some embodiments, the maximum polymer polymeric phase size of the cured polymeric materials is 1 μm. In some embodiments, at least about 50%, at least about 60%, at least about 70%, at least about 80%, at least about 90%, at least about 95%, or at least about 99% of the polymeric phases of the polymeric material have a size less than about 1 μm. In yet other embodiments, the polymeric material comprises an average polymeric phase size that is less than about 500 nm. In yet other embodiments, the polymeric material comprises an average polymeric phase size that is less than about 200 nm. In some embodiments, the maximum polymeric phase size of the cured polymeric materials is about 500 nm. In some embodiments, at least about 50%, at least about 60%, at least about 70%, at least about 80%, at least about 90%, at least about 95%, or at least about 99% of the polymeric phases of the polymeric material have a size less than 200 nm.

In some embodiments, the size of at least one or more of the polymeric phases (e.g., crystalline phases and amorphous phases) of a polymeric material can be controlled. Non-limiting examples of ways in which the size of the polymeric phases can be controlled includes: rapidly cooling the cured polymeric material, annealing the cured polymeric material at an elevated temperature (i.e., above room temperature), annealing the cured polymeric material at a temperature below room temperature, controlling the rate of polymerization, controlling the intensity of light during the curing step using light, controlling and/or adjusting polymerization temperature, exposing the cured polymeric material to sonic vibrations, and/or controlling the presence and amounts of impurities, and in particular for crystalline phases, adding crystallization-inducing chemicals or particles (e.g., crystallization seeds).

In some embodiments, the refractive index of the one or more crystalline phases and/or one or more amorphous phases of a polymeric material herein can be controlled. A reduction in difference of refractive index between different phases (e.g., reduction in the difference of refractive index between the crystalline phase and the amorphous phase) can increase clarity of the cured polymeric material, providing a clear or nearly clear material. Light scatter can be decreased by minimizing polymer crystal size, as well as by reducing the difference of refractive index across an interface between an amorphous polymeric phase and a crystalline phase. In some embodiments, the difference of refractive index between a given polymeric phase and a neighboring phase (e.g., crystalline and a neighboring amorphous phase) can be less than about 0.1, less than about 0.01, or less than about 0.001.

Further provided herein are polymeric films comprising a polymeric material of the present disclosure. In some cases, such polymeric film can have a thickness of at least about 50 μm, 100 μm, 250 μm, 500 μm, 1 mm, 2 mm and not more than 3 mm.

### Polymeric Materials in Medical Devices

The present disclosure provides devices that comprise a polymeric material of the present disclosure. As described herein, such polymeric material can comprise, incorporated in its polymeric structure, one or more polymerizable components of this disclosure. In various cases, the device can be a medical device. The medical device can be an orthodontic appliance. The orthodontic appliance can be a dental aligner, a dental expander or a dental spacer.

### Methods of Use

The present disclosure provides methods of using compositions comprising polymerizable compounds herein, as well as methods for using the compositions in devices such as orthodontic devices.

### Methods of Forming Polymeric Materials

The present disclosure provides methods for making the polymeric materials described herein, wherein said polymeric materials are formed by polymerizing (e.g., photocuring) curable compositions comprising one or more of diene, dithiol, or thiol-ene monomers of structure (I), (II), or (III). In some embodiments, the method for forming a polymeric material comprises: (i) providing a curable composition disclosed herein; and (ii) curing the curable composition, forming the polymeric material disclosed herein.

In some embodiments, providing the curable composition comprises mixing the components of the curable composition comprising one or more of diene, dithiol, or thiol-ene monomers of structure (I), (II), or (III).

In some embodiments, curing the curable composition comprises exposing the curable composition to a light source that initiates and/or facilitates photopolymerization. In some embodiments, a photoinitiator can be used as part of the curable composition to accelerate and/or initiate photopolymerization. In some embodiments, the curable composition is exposed to radiation (e.g., UV or visible light) of sufficient power and of a wavelength capable of initiating polymerization. The wavelengths and/or power of radiation useful to initiate polymerization may depend on the photoinitiator used. “Light” as used herein includes any wavelength and power capable of initiating polymerization. Some wavelengths of light include ultraviolet (UV) or visible. UV light sources include UVA (wavelength about 400 nanometers (nm) to about 320 nm), UVB (about 320 nm to about 290 nm) or UVC (about 290 nm to about 100 nm). Any suitable source may be used, including laser sources. The source may be broadband or narrowband, or a combination thereof. The light source may provide continuous or pulsed light during the process. Both the length of time the system is exposed to UV light and the intensity of the UV light can be varied to determine the ideal reaction conditions. In certain embodiments, a curable composition is cured using an additive manufacturing device to produce the polymeric material. In some embodiments, the curable composition herein may be heated to a predefined elevated process temperature ranging from about 50° C. to about 120° C., such as from about 90° C. to about 120° C., before becoming irradiated with light of a suitable wavelength to be absorbed by the photoinitiator, thereby causing activation of the photoinitiator to induce polymerization of the polymerizable resin to obtain a cured polymeric material, which can optionally be crosslinked.

In some embodiments, the methods disclosed herein for forming a polymeric material are part of a high temperature lithography-based photopolymerization process, wherein a curable composition (e.g., a photopolymerizable composition) that can comprise at least one photoinitiator is heated to an elevated process temperature. The heating may lower the viscosity of the curable composition before and/or during curing. Non-limiting examples of high-temperature lithography processes include those processes described in WO 2015/075094, WO 2016/078838 and WO 2018/032022. In some implementations, the high-temperature lithography may involve applying heat to material to temperatures from about 50° C. to about 120° C., such as from about 90° C. to about 120° C., from about 100° C. to about 120° C., from about 105° C. to about 115° C., from about 108° C. to about 110° C., etc. The material may be heated to temperatures greater than about 120° C. It is noted other temperature ranges may be used without departing from the scope and substance of the inventive concepts described herein. Thus, a method for forming a polymeric material according to the present disclosure can offer the possibility of quickly and facilely producing devices, such as orthodontic appliances, by additive manufacturing such as 3D printing using curable composition as disclosed herein.

In some embodiments, the methods disclosed herein further comprise heating the polymeric material to an elevated temperature. In certain embodiments, the elevated temperature is from 40° C. to 150° C. In some embodiments, heating the polymeric material to the elevated temperature occurs after curing the curable composition. In certain embodiments, a thermal cure occurs by heating the polymeric material comprising a thermal initiator to an elevated temperature following the photo-curing step. In certain embodiments, the curable composition is cured using an additive manufacturing device to produce the polymeric material. In some embodiments, the additive manufacturing device is a 3-D printer. In some embodiments, the method further comprises the step of cleaning the polymeric material. In certain embodiments, the cleaning of the polymeric material includes washing and/or rinsing the polymeric material with a solvent, which can remove monomers and undesired impurities from the polymeric material.

As described herein, a polymeric material produced by the methods provided herein can be characterized by one or more of: (i) a storage modulus greater than or equal to 200 MPa; (ii) a flexural stress of greater than or equal to 1.5 MPa remaining after 24 hours in a wet environment at 37° C.; (iii) an elongation at break greater than or equal to 5% before and after 24 hours in a wet environment at 37° C.; (iv) a water uptake of less than 25 wt % when measured after 24 hours in a wet environment at 37° C.; and (v) transmission of at least 30% of visible light through the polymeric material after 24 hours in a wet environment at 37° C. In various cases, such polymeric material can be characterized by at least 2, 3, 4, or all of these properties.

### Fabrication and Use of Orthodontic Appliances

The present disclosure provides devices comprising the polymeric materials generated from the curable compositions as described further herein. In some embodiments, the polymeric material is used to create orthodontic appliances intended to be placed in the intraoral cavity of a human. Such orthodontic appliances can be, for example, aligners that help to move teeth to new positions. In some embodiments, the orthodontic appliances can be retainers that help to keep teeth from moving to a new position. In some embodiments, the orthodontic appliances can be expanders used to expand the palate, move the location of the jaw, or prevent snoring of a human.

In some embodiments, the present disclosure provides methods for producing the devices described herein, said devices comprising a polymeric material generated from the curable compositions described herein. In some embodiments, the method comprises a step of shaping a curable composition into a desirable shape prior to a step of curing the curable composition, thereby generating the polymeric material having said desirable shape. In some embodiments, the method comprises a step of shaping a curable composition into a desirable shape during a step of curing the curable composition, thereby generating the polymeric material having said desirable shape. In some embodiments, the method comprises a step of curing the curable composition, thereby forming the polymeric material, then shaping the polymeric material into a desirable shape. In some embodiments, the desirable shape is an orthodontic appliance. In some embodiments, the desirable shape is a device and/or object as disclosed herein. In some embodiments, the shaping step comprises extrusion, production of a sheet, production of a film, melt spinning, coating, injection molding, compression and transfer molding, blow molding, rotational blow molding, thermoforming, casting, or a combination thereof.

In certain embodiments, the present disclosure provides an orthodontic appliance comprising a polymeric material as further described herein. The orthodontic appliance may be an aligner, expander or retainer. In some embodiments, the orthodontic appliance comprises a plurality of tooth receiving cavities configured to reposition teeth from a first configuration toward a second configuration. In some embodiments, the orthodontic appliance is one of a plurality of orthodontic appliances configured to reposition the teeth from an initial configuration toward a target configuration, optionally according to a treatment plan. As used herein a “plurality of teeth” encompasses two or more teeth.

In many embodiments, one or more posterior teeth comprise one or more of a molar, a premolar, or a canine, and one or more anterior teeth comprise one or more of a central incisor, a lateral incisor, a cuspid, a first bicuspid or a second bicuspid.

The curable compositions and cured polymeric materials according to the present disclosure exhibit favorable thermomechanical properties for use as orthodontic appliances, for example, for moving one or more teeth.

The embodiments disclosed herein can be used to couple groups of one or more teeth to each other. The groups of one or more teeth may comprise a first group of one or more anterior teeth and a second group of one or more posterior teeth. The first group of teeth can be coupled to the second group of teeth with the polymeric shell appliances as disclosed herein.

The embodiments disclosed herein are well suited for moving one or more teeth of the first group of one or more teeth or moving one or more of the second group of one or more teeth, and combinations thereof.

The embodiments disclosed herein are well suited for combination with one or known commercially available tooth moving components such as attachments and polymeric shell appliances. In many embodiments, the appliance and one or more attachments are configured to move one or more teeth along a tooth movement vector comprising six degrees of freedom, in which three degrees of freedom are rotational and three degrees of freedom are translation.

The present disclosure provides orthodontic systems and related methods for designing and providing improved or more effective tooth moving systems for eliciting a desired tooth movement and/or repositioning teeth into a desired arrangement.

Although reference is made to an appliance comprising a polymeric shell appliance, the embodiments disclosed herein are well suited for use with many appliances that receive teeth, for example appliances without one or more of polymers or shells. The appliance can be fabricated with one or more of many materials such as metal, glass, reinforced fibers, carbon fiber, composites, reinforced composites, aluminum, biological materials, and combinations thereof for example. In some cases, the reinforced composites can comprise a polymer matrix reinforced with ceramic or metallic particles, for example. The appliance can be shaped in many ways, such as with thermoforming or direct fabrication as described herein, for example. Alternatively or in combination, the appliance can be fabricated with machining such as an appliance fabricated from a block of material with computer numeric control machining. Preferably, the appliance is fabricated using a polymerizable resin according to the present disclosure.

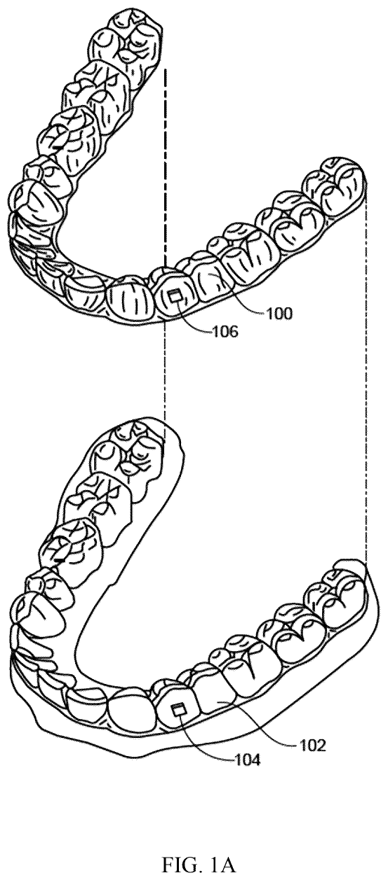

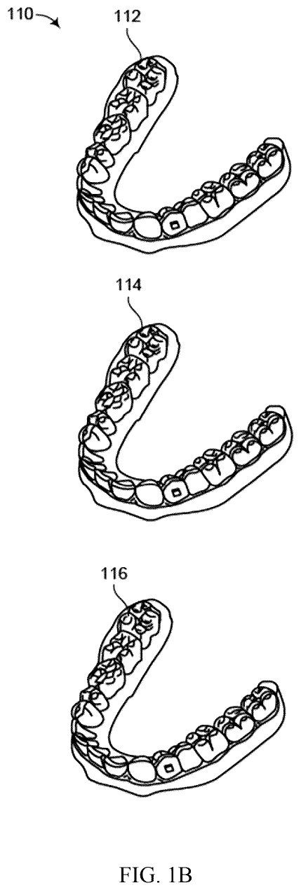

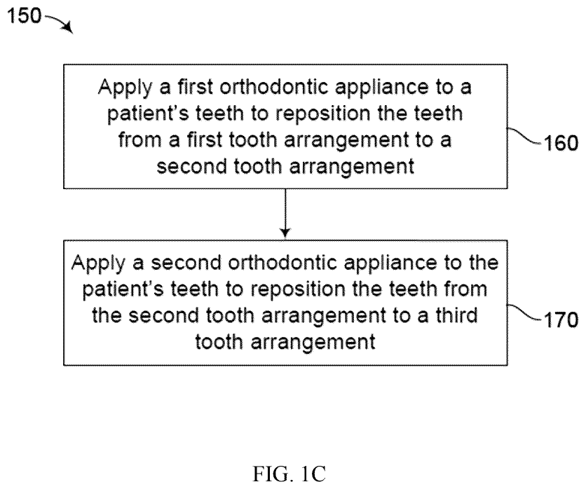

Turning now to the drawings, in which like numbers designate like elements in the various figures, FIG. 1A illustrates an exemplary tooth repositioning appliance or aligner 100 that can be worn by a patient in order to achieve an incremental repositioning of individual teeth 102 in the jaw, and comprises the cured polymeric material disclosed herein. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. In some embodiments, a physical appliance is directly fabricated, e.g., using rapid prototyping fabrication techniques, from a digital model of an appliance. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth) and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some, most, or even all of the teeth will be repositioned at some point during treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements 104 on teeth 102 with corresponding receptacles or apertures 106 in the appliance 100 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 1B illustrates a tooth repositioning system 110 including a plurality of appliances 112, 114, 116. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 110 can include a first appliance 112 corresponding to an initial tooth arrangement, one or more intermediate appliances 114 corresponding to one or more intermediate arrangements, and a final appliance 116 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

FIG. 1C illustrates a method 150 of orthodontic treatment using a plurality of appliances, in accordance with embodiments. The method 150 can be practiced using any of the appliances or appliance sets described herein. In step 160, a first orthodontic appliance is applied to a patient's teeth in order to reposition the teeth from a first tooth arrangement to a second tooth arrangement. In step 170, a second orthodontic appliance is applied to the patient's teeth in order to reposition the teeth from the second tooth arrangement to a third tooth arrangement. The method 150 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

The various embodiments of the orthodontic appliances presented herein can be fabricated in a wide variety of ways. In some embodiments, the orthodontic appliances herein (or portions thereof) can be produced using direct fabrication, such as additive manufacturing techniques (also referred to herein as “3D printing”) or subtractive manufacturing techniques (e.g., milling). In some embodiments, direct fabrication involves forming an object (e.g., an orthodontic appliance or a portion thereof) without using a physical template (e.g., mold, mask, etc.) to define the object geometry. Additive manufacturing techniques can be categorized as follows: (1) vat photopolymerization (e.g., stereolithography), in which an object is constructed layer by layer from a vat of liquid photopolymer resin; (2) material jetting, in which material is jetted onto a build platform using either a continuous or drop on demand (DOD) approach; (3) binder jetting, in which alternating layers of a build material (e.g., a powder-based material) and a binding material (e.g., a liquid binder) are deposited by a print head; (4) fused deposition modeling (FDM), in which material is drawn though a nozzle, heated, and deposited layer by layer; (5) powder bed fusion, including but not limited to direct metal laser sintering (DMLS), electron beam melting (EBM), selective heat sintering (SHS), selective laser melting (SLM), and selective laser sintering (SLS); (6) sheet lamination, including but not limited to laminated object manufacturing (LOM) and ultrasonic additive manufacturing (UAM); and (7) directed energy deposition, including but not limited to laser engineering net shaping, directed light fabrication, direct metal deposition, and 3D laser cladding. For example, stereolithography can be used to directly fabricate one or more of the appliances herein. In some embodiments, stereolithography involves selective polymerization of a photosensitive resin (e.g., a photopolymer) according to a desired cross-sectional shape using light (e.g., ultraviolet light). The object geometry can be built up in a layer-by-layer fashion by sequentially polymerizing a plurality of object cross-sections. As another example, the appliances herein can be directly fabricated using selective laser sintering. In some embodiments, selective laser sintering involves using a laser beam to selectively melt and fuse a layer of powdered material according to a desired cross-sectional shape in order to build up the object geometry. As yet another example, the appliances herein can be directly fabricated by fused deposition modeling. In some embodiments, fused deposition modeling involves melting and selectively depositing a thin filament of thermoplastic polymer in a layer-by-layer manner in order to form an object. In yet another example, material jetting can be used to directly fabricate the appliances herein. In some embodiments, material jetting involves jetting or extruding one or more materials onto a build surface in order to form successive layers of the object geometry.

Alternatively or in combination, some embodiments of the appliances herein (or portions thereof) can be produced using indirect fabrication techniques, such as by thermoforming over a positive or negative mold. Indirect fabrication of an orthodontic appliance can involve producing a positive or negative mold of the patient's dentition in a target arrangement (e.g., by rapid prototyping, milling, etc.) and thermoforming one or more sheets of material over the mold in order to generate an appliance shell.

In some embodiments, the direct fabrication methods provided herein build up the object geometry in a layer-by-layer fashion, with successive layers being formed in discrete build steps. Alternatively, or in combination, direct fabrication methods that allow for continuous build-up of an object geometry can be used, referred to herein as “continuous direct fabrication.” Various types of continuous direct fabrication methods can be used. As an example, in some embodiments, the appliances herein are fabricated using “continuous liquid interphase printing,” in which an object is continuously built up from a reservoir of curable composition by forming a gradient of partially cured resin between the building surface of the object and a polymerization-inhibited “dead zone.” In some embodiments, a semi-permeable membrane is used to control transport of a photopolymerization inhibitor (e.g., oxygen) into the dead zone in order to form the polymerization gradient. Continuous liquid interphase printing can achieve fabrication speeds about 25 times to about 100 times faster than other direct fabrication methods, and speeds about 1000 times faster can be achieved with the incorporation of cooling systems. Continuous liquid interphase printing is described in U.S. Patent Publication Nos. 2015/0097315, 2015/0097316, and 2015/0102532, the disclosures of each of which are incorporated herein by reference in their entirety.

As another example, a continuous direct fabrication method can achieve continuous build-up of an object geometry by continuous movement of the build platform (e.g., along the vertical or Z-direction) during the irradiation phase, such that the hardening depth of the irradiated photopolymer is controlled by the movement speed. Accordingly, continuous polymerization of material on the build surface can be achieved. Such methods are described in U.S. Pat. No. 7,892,474, the disclosure of which is incorporated herein by reference in its entirety.

In another example, a continuous direct fabrication method can involve extruding a composite material composed of a polymerizable liquid material surrounding a solid strand. The composite material can be extruded along a continuous three-dimensional path in order to form the object. Such methods are described in U.S. Patent Publication No. 2014/0061974, the disclosure of which is incorporated herein by reference in its entirety.

In yet another example, a continuous direct fabrication method utilizes a “heliolithography” approach in which the liquid photopolymer is cured with focused radiation while the build platform is continuously rotated and raised. Accordingly, the object geometry can be continuously built up along a spiral build path. Such methods are described in U.S. Patent Publication No. 2014/0265034, the disclosure of which is incorporated herein by reference in its entirety.

Machine parameters can include curing parameters. For digital light processing (DLP)-based curing systems, curing parameters can include power, curing time, and/or grayscale of the full image. For laser-based curing systems, curing parameters can include power, speed, beam size, beam shape and/or power distribution of the beam. For printing systems, curing parameters can include material drop size, viscosity, and/or curing power. These machine parameters can be monitored and adjusted on a regular basis (e.g., some parameters at every 1-x layers and some parameters after each build) as part of the process control on the fabrication machine. Process control can be achieved by including a sensor on the machine that measures power and other beam parameters every layer or every few seconds and automatically adjusts them with a feedback loop. For DLP machines, gray scale can be measured and calibrated before, during, and/or at the end of each build, and/or at predetermined time intervals (e.g., every n^{th} build, once per hour, once per day, once per week, etc.), depending on the stability of the system. In addition, material properties and/or photo-characteristics can be provided to the fabrication machine, and a machine process control module can use these parameters to adjust machine parameters (e.g., power, time, gray scale, etc.) to compensate for variability in material properties. By implementing process controls for the fabrication machine, variability in appliance accuracy and residual stress can be reduced.

Optionally, the direct fabrication methods described herein allow for fabrication of an appliance including multiple materials, referred to herein as “multi-material direct fabrication.” In some embodiments, a multi-material direct fabrication method involves concurrently forming an object from multiple materials in a single manufacturing step. For instance, a multi-tip extrusion apparatus can be used to selectively dispense multiple types of materials from distinct material supply sources in order to fabricate an object from a plurality of different materials. Such methods are described in U.S. Pat. No. 6,749,414, the disclosure of which is incorporated herein by reference in its entirety. Alternatively, or in combination, a multi-material direct fabrication method can involve forming an object from multiple materials in a plurality of sequential manufacturing steps. For instance, a first portion of the object can be formed from a first material in accordance with any of the direct fabrication methods herein, then a second portion of the object can be formed from a second material in accordance with methods herein, and so on, until the entirety of the object has been formed.

Direct fabrication can provide various advantages compared to other manufacturing approaches. For instance, in contrast to indirect fabrication, direct fabrication permits production of an orthodontic appliance without utilizing any molds or templates for shaping the appliance, thus reducing the number of manufacturing steps involved and improving the resolution and accuracy of the final appliance geometry. Additionally, direct fabrication permits precise control over the three-dimensional geometry of the appliance, such as the appliance thickness. Complex structures and/or auxiliary components can be formed integrally as a single piece with the appliance shell in a single manufacturing step, rather than being added to the shell in a separate manufacturing step. In some embodiments, direct fabrication is used to produce appliance geometries that would be difficult to create using alternative manufacturing techniques, such as appliances with very small or fine features, complex geometric shapes, undercuts, interproximal structures, shells with variable thicknesses, and/or internal structures (e.g., for improving strength with reduced weight and material usage). For example, in some embodiments, the direct fabrication approaches herein permit fabrication of an orthodontic appliance with feature sizes of less than or equal to about 5 μm, or within a range from about 5 μm to about 50 μm, or within a range from about 20 μm to about 50 μm.

In some embodiments, the direct fabrication techniques described herein can be used to produce appliances with substantially isotropic material properties, e.g., substantially the same or similar strengths along all directions. In some embodiments, the direct fabrication approaches herein permit production of an orthodontic appliance with a strength that varies by no more than about 25%, about 20%, about 15%, about 10%, about 5%, about 1%, or about 0.5% along all directions. In some embodiments, the direct fabrication techniques described herein can be used to produce appliances with substantially anisotropic material properties (e.g., substantially different strengths along all directions). In some embodiments, the direct fabrication techniques described herein produce appliances with a strength that varies by more than about 0.5%, more than about 1%, more than about 5%, more than about 10%, more than about 15%, more than about 20%, or more than about 25% along all directions. Additionally, the direct fabrication approaches herein can be used to produce orthodontic appliances at a faster speed compared to other manufacturing techniques. In some embodiments, the direct fabrication approaches herein allow for production of an orthodontic appliance in a time interval less than or equal to about 1 hour, about 30 minutes, about 25 minutes, about 20 minutes, about 15 minutes, about 10 minutes, about 5 minutes, about 4 minutes, about 3 minutes, about 2 minutes, about 1 minutes, or about 30 seconds. Such manufacturing speeds allow for rapid “chair-side” production of customized appliances, e.g., during a routine appointment or checkup.

In some embodiments, the direct fabrication methods described herein implement process controls for various machine parameters of a direct fabrication system or device in order to ensure that the resultant appliances are fabricated with a high degree of precision. Such precision can be beneficial for ensuring accurate delivery of a desired force system to the teeth in order to effectively elicit tooth movements. Process controls can be implemented to account for process variability arising from multiple sources, such as the material properties, machine parameters, environmental variables, and/or post-processing parameters.

Material properties may vary depending on the properties of raw materials, purity of raw materials, and/or process variables during mixing of the raw materials. In many embodiments, resins or other materials for direct fabrication should be manufactured with tight process control to ensure little variability in photo-characteristics, material properties (e.g., viscosity, surface tension), physical properties (e.g., modulus, strength, elongation) and/or thermal properties (e.g., glass transition temperature, heat deflection temperature). Process control for a material manufacturing process can be achieved with screening of raw materials for physical properties and/or control of temperature, humidity, and/or other process parameters during the mixing process. By implementing process controls for the material manufacturing procedure, reduced variability of process parameters and more uniform material properties for each batch of material can be achieved. Residual variability in material properties can be compensated with process control on the machine, as discussed further herein.

In many embodiments, environmental variables (e.g., temperature, humidity, sunlight, or exposure to other energy/curing sources) are maintained in a narrow range to reduce variability in appliance thickness and/or other properties. Optionally, machine parameters can be adjusted to compensate for environmental variables.

In many embodiments, post-processing of appliances includes cleaning, post-curing, and/or support removal processes. Relevant post-processing parameters can include purity of cleaning agent, cleaning pressure and/or temperature, cleaning time, post-curing energy and/or time, and/or consistency of support removal process. These parameters can be measured and adjusted as part of a process control scheme. In addition, appliance physical properties can be varied by modifying the post-processing parameters. Adjusting post-processing machine parameters can provide another way to compensate for variability in material properties and/or machine properties.

The configuration of the orthodontic appliances herein can be determined according to a treatment plan for a patient, e.g., a treatment plan involving successive administration of a plurality of appliances for incrementally repositioning teeth. Computer-based treatment planning and/or appliance manufacturing methods can be used in order to facilitate the design and fabrication of appliances. For instance, one or more of the appliance components described herein can be digitally designed and fabricated with the aid of computer-controlled manufacturing devices (e.g., computer numerical control (CNC) milling, computer-controlled rapid prototyping such as 3D printing, etc.). The computer-based methods presented herein can improve the accuracy, flexibility, and convenience of appliance fabrication.

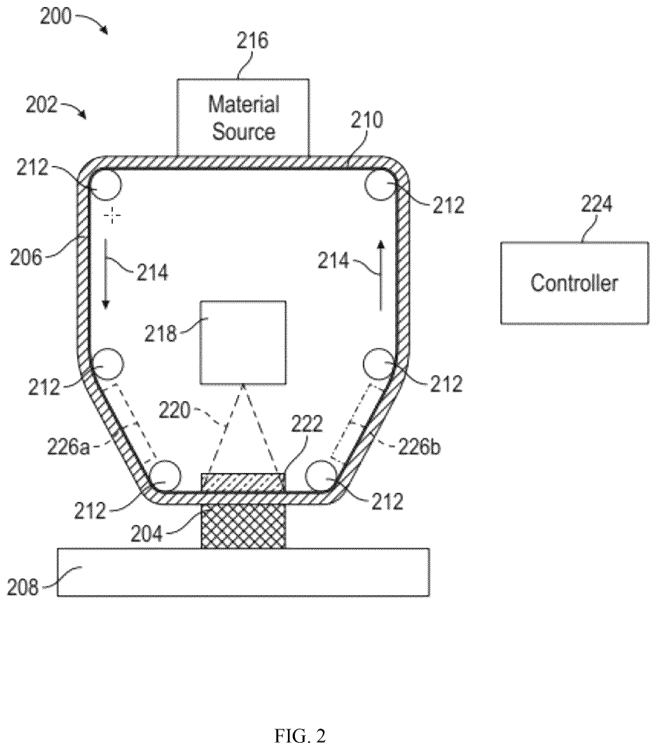

FIG. 2 illustrates a representative example of a system 200 for additive manufacturing configured in accordance with embodiments of the present disclosure. The system 200 can be used to fabricate any embodiment of the objects described herein. For example, the system 200 can be used to produce an object using an additive manufacturing process (e.g., 3D printing).

The system 200 includes a printer assembly 202 configured to fabricate an additively manufactured object 204 (“object 204”) using any of the additive manufacturing processes described herein. The printer assembly 202 is configured to deposit a curable material 206 (e.g., a polymeric resin, polymerizable composition, or other solidifiable precursor material) on a build platform 208 (e.g., a tray, plate, film, sheet, or other planar substrate) to form the object 204. In the illustrated embodiment, the printer assembly 202 includes a carrier film 210 configured to deliver the curable material 206 to the build platform 208. The carrier film 210 can be a flexible loop of material having an outer surface and an inner surface. The outer surface of the carrier film 210 can adhere to and carry a thin layer of the curable material 206. The inner surface of the carrier film 210 can contact one or more rollers 212 that rotate to move the carrier film 210 in a continuous loop trajectory, e.g., along the direction indicated by arrow 214. The printer assembly 202 can also include a material source 216 (shown schematically) configured to apply the curable material 206 to the carrier film 210. In the illustrated embodiment, the material source 216 is located at the upper portion of the printer assembly 202. In other embodiments, however, the material source 216 can be at a different location in the printer assembly 202. The material source 216 can include nozzles, ports, reservoirs, etc., that deposit the curable material 206 onto the outer surface of the carrier film 210. The material source 216 can also include one or more blades (e.g., doctor blades, recoater blades) that smooth the deposited curable material 206 into a relatively thin, uniform layer. For example, the curable material 206 can be formed into a layer having a thickness within a range from 200 microns to 300 microns, or any other desired thickness.

The curable material 206 can be conveyed by the carrier film 210 toward the build platform 208. In the illustrated embodiment, the build platform 208 is located below the printer assembly 202. In other embodiments, however, the build platform 208 can be positioned at a different location in the printer assembly 202. The distance between the carrier film 210 and build platform 208 can be adjustable so that the curable material 206 at can be brought into direct contact with the surface of the build platform 208 (when printing the initial layer of the object 204) or with the surface of the object 204 (when printing subsequent layers of the object 204). For example, the build platform 208 can include or be coupled to a motor (not shown) that raises and/or lowers the build platform 208 to the desired height during the manufacturing process.

The printer assembly 202 includes an energy source 218 (e.g., a projector or light engine) that outputs energy 220 (e.g., light, such as UV light) having a wavelength configured to partially or fully cure the curable material 206. The carrier film 210 can be partially or completely transparent to the wavelength of the energy 220 to allow the energy 220 to pass through the carrier film 210 and onto the portion of the curable material 206 above the build platform 208. Optionally, a transparent plate 222 can be disposed between the energy source 218 and the carrier film 210 to guide the carrier film 210 into a specific position (e.g., height) relative to the build platform 208. During operation, the energy 220 can be patterned or scanned in a suitable pattern onto the curable material 206, thus forming a layer of cured material onto the build platform 208 and/or on a previously formed portion of the object 204. The geometry of the cured material can correspond to the desired cross-sectional geometry for the object 204. The parameters for operating the energy source 218 (e.g., energy intensity, energy dosage, exposure time, exposure pattern, exposure wavelength, energy density, power density) can be set based on instructions from a controller 224, as described in further detail below.

Once the object cross-section has been formed, the build platform 208 can be lowered by a predetermined amount to separate the cured material from the carrier film 210. The remaining curable material 206 can be carried by the carrier film 210 away from the build platform 208 and back toward the material source 216. The material source 216 can deposit additional curable material 206 onto the carrier film 210 and/or smooth the curable material 206 to re-form a uniform layer of curable material 206 on the carrier film 210. The curable material 206 can then be recirculated back to the build platform 208 to fabricate an additional layer of the object 204. This process can be repeated to iteratively build up individual object layers on the build platform 208 until the object 204 is complete. The object 204 and build platform 208 can then be removed from the system 200 for post-processing.

In some embodiments, the system 200 is used in a high temperature lithography process utilizing a highly viscous curable material 206 (e.g., a highly viscous resin). Accordingly, the printer assembly 202 can include one or more heat sources (heating plates, infrared lamps, etc.) for heating the curable material 206 to lower the viscosity to a range suitable for additive manufacturing. For example, the printer assembly 202 can include a first heat source 226a positioned against the segment of the carrier film 210 before the build platform 208, and a second heat source 226b positioned against the segment of the carrier film 210 after the build platform 208. Alternatively, or in combination, the printer assembly 202 can include heat sources at other locations.

The system 200 also includes a controller 224 (shown schematically) that is operably coupled to the printer assembly 202 and build platform 208 to control the operation thereof. The controller 224 can be or include a computing device including one or more processors and memory storing instructions for performing the additive manufacturing operations described herein. For example, the controller 224 can receive a digital data set (e.g., a three-dimensional model) representing the object 204 to be fabricated, determine a plurality of object cross-sections to build up the object 204 from the curable material 206, and can transmit instructions to the energy source 218 to output energy 220 to form the object cross-sections. As described above and in greater detail below, the controller 224 can control the energy application parameters of the energy source 218, such as the energy intensity, energy dosage, exposure time, exposure pattern, energy wavelength, and/or energy type of the energy 220 applied to the curable material 206. Optionally, the controller 224 can also determine and control other operational parameters, such as the positioning of the build platform 208 (e.g., height) relative to the carrier film 210, the movement speed and direction of the carrier film 210, the amount of curable material 206 deposited by the material source 216, the thickness of the material layer on the carrier film 210, and/or the amount of heating applied to the curable material 206.

Although FIG. 2 illustrates a representative example of a system 200 for additive manufacturing, this is not intended to be limiting, and the methods described herein can be implemented using other types of additive manufacturing systems, such as material jetting systems, binder jetting systems, material extrusion systems, powder bed fusion systems, sheet lamination systems, or directed energy deposition systems.

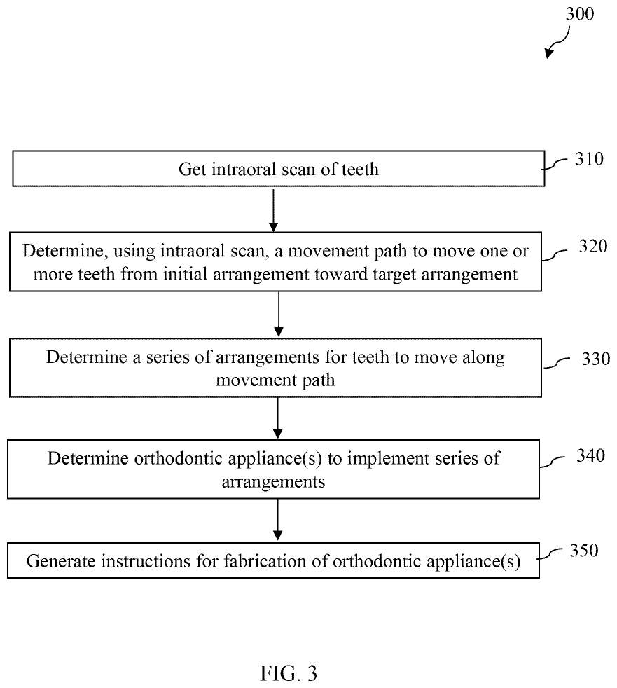

FIG. 3 illustrates a method 300 for designing an orthodontic appliance to be produced by direct fabrication, in accordance with embodiments. The method 300 can be applied to any embodiment of the orthodontic appliances described herein. Some or all of the steps of the method 300 can be performed by any suitable data processing system or device, e.g., one or more processors configured with suitable instructions.

In step 310, an intraoral scan is performed.

In step 320, using the intraoral scan, a movement path to move one or more teeth from an initial arrangement to a target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, including measured or extrapolated hidden surfaces and root structures, as well as surrounding bone and soft tissue.

The target arrangement of the teeth (e.g., a desired and intended end result of orthodontic treatment) can be received from a clinician in the form of a prescription, can be calculated from basic orthodontic principles, and/or can be extrapolated computationally from a clinical prescription. With a specification of the desired final positions of the teeth and a digital representation of the teeth themselves, the final position and surface geometry of each tooth can be specified to form a complete model of the tooth arrangement at the desired end of treatment.

Having both an initial position and a target position for each tooth, a movement path can be defined for the motion of each tooth. In some embodiments, the movement paths are configured to move the teeth in the quickest fashion with the least amount of round-tripping to bring the teeth from their initial positions to their desired target positions.

In step 330, a series of arrangements for teeth to move along the movement path is determined. The movement path can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In step 340, a determination of orthodontic appliance(s) configured to implement the series of arrangements is determined. Determination of the appliance design, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA(Abaqus) software products from Dassault Systhmes of Waltham, MA.

Optionally, one or more appliance designs can be selected for testing or force modeling. As noted above, a desired tooth movement, as well as a series of arrangements required or desired for the tooth movement, can be identified. Using the simulation environment, a candidate appliance design can be analyzed or modeled for determination of an actual moving arrangement resulting from use of the candidate appliance. One or more modifications can optionally be made to a candidate appliance, and arrangements can be further analyzed as described, e.g., in order to iteratively determine an appliance design that produces the desired moving arrangements.

In step 350, instructions for fabrication of the orthodontic appliance incorporating the appliance design are generated. The instructions can be configured to control a fabrication system or device in order to produce the orthodontic appliance with the specified design. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by thermoforming.

Method 300 may comprise additional steps: 1) The upper arch and palate of the patient are scanned intraorally to generate three dimensional data of the palate and upper arch; 2) The three dimensional shape profile of the appliance is determined to provide a gap and teeth engagement structures as described herein.

Although the above steps show a method 300 of designing an orthodontic appliance in accordance with some embodiments, a person of ordinary skill in the art will recognize some variations based on the teaching described herein. Some of the steps may comprise sub-steps. Some of the steps may be repeated as often as desired. One or more steps of the method 300 may be performed with any suitable fabrication system or device, such as the embodiments described herein. Some of the steps may be optional, and the order of the steps can be varied as desired.

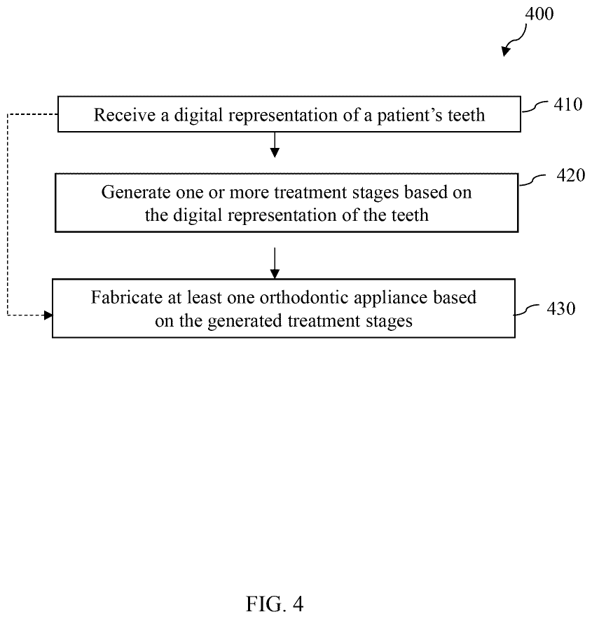

FIG. 4 illustrates a method 400 for digitally planning an orthodontic treatment and/or design or fabrication of an appliance, in accordance with embodiments. The method 400 can be applied to any of the treatment procedures described herein and can be performed by any suitable data processing system.

In step 410, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In step 420, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step 430, at least one orthodontic appliance is fabricated based on the generated treatment stages. For example, a set of appliances can be fabricated, each shaped according a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired.

In some instances, staging of various arrangements or treatment stages may not be necessary for design and/or fabrication of an appliance. As illustrated by the dashed line in FIG. 4, design and/or fabrication of an orthodontic appliance, and perhaps a particular orthodontic treatment, may include use of a representation of the patient's teeth (e.g., receive a digital representation of the patient's teeth), followed by design and/or fabrication of an orthodontic appliance based on a representation of the patient's teeth in the arrangement represented by the received representation.

### On-Track Treatment

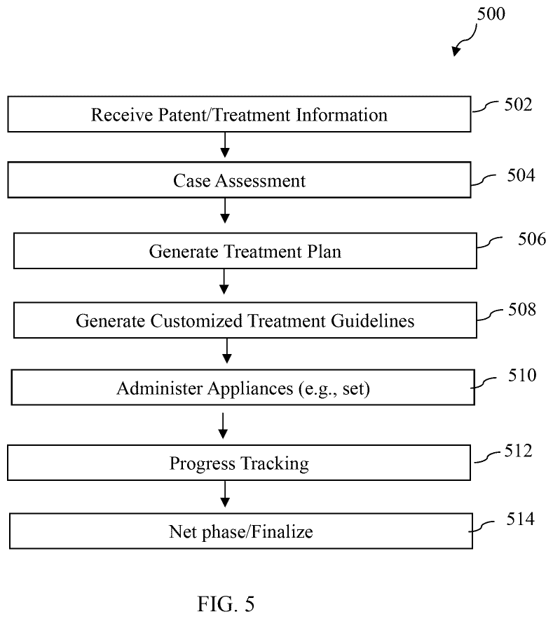

Referring to FIG. 5, a process 500 according to the present invention is illustrated. Individual aspects of the process are discussed in further detail below. The process includes receiving information regarding the orthodontic condition of the patient and/or treatment information (502), generating an assessment of the case (504), and generating a treatment plan for repositioning a patient's teeth (506). Briefly, a patient/treatment information will include obtaining data comprising an initial arrangement of the patient's teeth, which typically includes obtaining an impression or scan of the patient's teeth prior to the onset of treatment and can further include identification of one or more treatment goals selected by the practitioner and/or patient. A case assessment can be generated (504) so as to assess the complexity or difficulty of moving the particular patient's teeth in general or specifically corresponding to identified treatment goals and may further include practitioner experience and/or comfort level in administering the desired orthodontic treatment. In some cases, however, the assessment can include simply identifying particular treatment options (e.g., appointment planning, progress tracking, etc.) that are of interest to the patient and/or practitioner. The information and/or corresponding treatment plan will include identifying a final or target arrangement of the patient's teeth that is desired, as well as a plurality of planned successive or intermediary tooth arrangements for moving the teeth along a treatment path from the initial arrangement toward the selected final or target arrangement.

The process further includes generating customized treatment guidelines (508). The treatment plan typically includes multiple phases of treatment, with a customized set of treatment guidelines generated that correspond to a phase of the treatment plan. The guidelines will include detailed information on timing and/or content (e.g., specific tasks) to be completed during a given phase of treatment and will be of sufficient detail to guide a practitioner, including a less experienced practitioner or practitioner relatively new to the particular orthodontic treatment process, through the phase of treatment. Since the guidelines are designed to specifically correspond to the treatment plan and provide guidelines on activities specifically identified in the treatment information and/or generated treatment plan, the guidelines are said to be customized. The customized treatment guidelines are then provided to the practitioner so as to help instruct the practitioner as how to deliver a given phase of treatment. As set forth above, appliances can be generated based on the planned arrangements and will be provided to the practitioner and ultimately administered to the patient (510). The appliances are typically provided and/or administered in sets or batches of appliances, such as 2, 3, 4, 5, 6, 7, 8, 9, or more appliances, but are not limited to any particular administrative scheme. Appliances can be provided to the practitioner concurrently with a given set of guidelines, or appliances and guidelines can be provided separately.

After the treatment according to the plan begins and following administration of appliances to the patient, treatment progress tracking, e.g., by teeth matching, is done to assess a current and actual arrangement of the patient's teeth compared to a planned arrangement (512). If the patient's teeth are determined to be “on-track” and progressing according to the treatment plan, then treatment progresses as planned and treatment progresses to the next stage of treatment (514). If the patient's teeth have substantially reached the initially planned final arrangement, then treatment progresses to the final stages of treatment (514). Where the patient's teeth are determined to be tracking according to the treatment plan, but have not yet reached the final arrangement, the next set of appliances can be administered to the patient.

The threshold difference values of a planned position of teeth to actual positions selected as indicating that a patient's teeth have progressed on-track are provided below in Table 4. If a patient's teeth have progressed at or within the threshold values, the progress is considered to be on-track. If a patient's teeth have progressed beyond the threshold values, the progress is considered to be off-track.

TABLE 4

| Type Movement | Difference Actual/Planned | |
|---|---|---|
| Rotations | | |
| Upper Central Incisors | 9 | degrees |
| Upper Lateral Incisors | 11 | degrees |
| Lower Incisors | 11 | degrees |
| Upper Cuspids | 11 | degrees |
| Lower Cuspids | 9.25 | degrees |
| Upper Bicuspids | 7.25 | degrees |
| Lower First Bicuspid | 7.25 | degrees |
| Lower Second Bicuspid | 7.25 | degrees |
| Molars | 6 | degrees |
| Extrusion | | |
| Anterior | 0.75 | mm |
| Posterior | 0.75 | mm |
| Intrusion | | |
| Anterior | 0.75 | mm |
| Posterior | 0.75 | mm |
| Angulation | | |
| Anterior | 5.5 | degrees |
| Posterior | 3.7 | degrees |
| Inclination | | |
| Anterior | 5.5 | degrees |
| Posterior | 3.7 | degrees |
| Translation | | |
| BL Anterior | 0.7 | mm |
| BL Posterior Cuspids | 0.9 | mm |
| MD Anterior | 0.45 | mm |
| MD Cuspids | 0.45 | mm |
| MD Posterior | 0.5 | mm |

The patient's teeth are determined to be on track by comparison of the teeth in their current positions with teeth in their expected or planned positions, and by confirming the teeth are within the parameter variance disclosed in Table 4. If the patient's teeth are determined to be on track, then treatment can progress according to the existing or original treatment plan. For example, a patient determined to be progressing on track can be administered one or more subsequent appliances according to the treatment plan, such as the next set of appliances. Treatment can progress to the final stages and/or can reach a point in the treatment plan where bite matching is repeated for a determination of whether a patient's teeth are progressing as planned or if the teeth are off track.

In some embodiments, as further disclosed herein, this disclosure provides methods of treating a patient using a 3D printed orthodontic appliance. In certain embodiments, the method of repositioning a patient's teeth (or, in some embodiments, a singular tooth) comprises:
generating a treatment plan for the patient, the plan comprising tooth arrangements for moving teeth along a treatment path from an initial arrangement toward a final arrangement;
producing a 3D printed orthodontic appliance comprising less than or equal to 20 wt % hydrogen bonding units or less than or equal to 10 wt % hydrogen bonding units; and
moving on-track, with the orthodontic appliance, at least one of the patient's teeth toward an intermediate arrangement or a final tooth arrangement. In preferred embodiments, the method further comprises achieving on-track the movement of the patient's teeth to the intermediate arrangement or final tooth arrangement. In some embodiments, producing the 3D printed orthodontic appliance uses the polymerizable resin compositions disclosed further herein. On-track performance can be determined, e.g., from Table 4, above.

In some embodiments, the method further comprises tracking the progression of the patient's teeth along the treatment path after administration of the orthodontic appliance. In certain embodiments, the tracking comprises comparing a current arrangement of the patient's teeth to a planned arrangement of the teeth. As a non-limiting example, following the initial administration of the orthodontic appliance, a period of time passes (e.g., two weeks), a comparison of the now-current arrangement of the patient's teeth (i.e., at two weeks of treatment) can be compared with the teeth arrangement of the treatment plan. In some embodiments, the progression can also be tracked by comparing the current arrangement of the patient's teeth with the initial configuration of the patient's teeth. The period of time can be, for example, greater than 3 days, greater than 4 days, greater than 5 days, greater than 6 days, greater than 7 days, greater than 8 days, greater than 9 days, greater than 10 days, greater than 11 days, greater than 12 days, greater than 13 days, greater than 2 weeks, greater than 3 weeks, greater than 4 weeks, or greater than 2 months. In some embodiments, the period of time can be from at least 3 days to at most 4 weeks, from at least 3 days to at most 3 weeks, from at least 3 days to at most 2 weeks, from at least 4 days to at most 4 weeks, from at least 4 days to at most 3 weeks, or from at least 4 days to at most 2 weeks. In certain embodiments, the period of time can restart following the administration of a new orthodontic appliance.

In some embodiments, greater than 50%, greater than 55%, greater than 60%, greater than 65%, greater than 70%, greater than 75%, greater than 80%, greater than 85%, greater than 90%, greater than 91%, greater than 92%, greater than 93%, greater than 94%, greater than 95%, greater than 96%, greater than 97%, greater than 98%, or greater than 99% of the patient's teeth are on track with the treatment plan after a period of time of using an orthodontic appliance as disclosed further herein. In some embodiments, the period of time is 3 days, 4 days, 5 days, 6 days, 7 days, 8 days, 9 days, 10 days, 11 days, 12 days, 13 days, 2 weeks, 3 weeks, 4 weeks, or greater than 4 weeks.

### Properties After Use

In some embodiments of the method disclosed above, the 3D printed orthodontic appliance has a retained repositioning force (i.e., the repositioning force after the orthodontic appliance has been applied to or worn by the patient over a period of time), and the retained repositioning force to at least one of the patient's teeth after the period of time is at least 10%, at least 20%, at least 30%, at least 40%, at least 50%, at least 55%, at least 60%, at least 65%, at least 70%, at least 75%, at least 80%, at least 85%, at least 90%, at least 95%, at least 96%, at least 97%, at least 98%, or at least 99% of the repositioning force initially provided to the at least one of the patient's teeth (i.e., with initial application of the orthodontic appliance). In some embodiments, the period of time is 3 days, 4 days, 5 days, 6 days, 7 days, 8 days, 9 days, 10 days, 11 days, 12 days, 13 days, 2 weeks, 3 weeks, 4 weeks, or greater than 4 weeks.

In preferred embodiments, the orthodontic appliances disclosed herein can provide on-track movement of at least one of the patient's teeth. On-track movement has been described further herein, e.g., at Table 4. In some embodiments, the orthodontic appliances disclosed herein can be used to achieve on-track movement of at least one of the patient's teeth to an intermediate tooth arrangement. In some embodiments, the orthodontic appliances disclosed herein can be used to achieve on-track movement of at least one of the patient's teeth to a final tooth arrangement.

In some embodiments, prior to moving on-track, with the orthodontic appliance, at least one of the patient's teeth toward the intermediate arrangement or the final tooth arrangement, the orthodontic appliance comprises a first flexural stress; and after achieving on-track the movement of the at least one of the patient's teeth to the intermediate arrangement or the final tooth arrangement, the orthodontic appliance comprises a second flexural stress.

As provided herein, the methods disclosed can use the orthodontic appliances further disclosed herein. Said orthodontic appliances can be directly fabricated using, e.g., the resins disclosed herein. In certain embodiments, the direct fabrication comprises cross-linking the resin.

The appliances formed from the resins disclosed herein provide improved durability, strength, and flexibility, which in turn improve the rate of on-track progression in treatment plans. In some embodiments, greater than 60%, greater than 70%, greater than 80%, greater than 90%, or greater than 95% of patients treated with the orthodontic appliances disclosed herein (e.g., an aligner) are classified as on-track in a given treatment stage. In certain embodiments, greater than 60%, greater than 70%, greater than 80%, greater than 90%, or greater than 95% of patients treated with the orthodontic appliances disclosed herein (e.g., an aligner) have greater than 50%, greater than 55%, greater than 60%, greater than 65%, greater than 70%, greater than 75%, greater than 80%, greater than 85%, greater than 90%, or greater than 95% of their tooth movements classified as on-track.

As disclosed further herein, the cured polymeric material contains favorable characteristics that, at least in part, stem from the presence of polymeric crystals. These cured polymeric materials can have increased resilience to damage, can be tough, and can have decreased water uptake when compared to similar polymeric materials. The cured polymeric materials can be used for devices within the field of orthodontics, as well as outside the field of orthodontics. For example, the cured polymeric materials disclosed herein can be used to make devices for use in aerospace applications, automobile manufacturing, the manufacture of prototypes, and/or devices for use in durable parts production.

### Experimental Methods

All chemicals were purchased from commercial sources and were used without further purification, unless otherwise stated.

In some embodiments, the stress relaxation of a material or device can be measured by monitoring the time-dependent stress resulting from a steady strain. The extent of stress relaxation can also depend on the temperature, relative humidity and other applicable conditions (e.g., presence of water). In some embodiments, the test conditions for stress relaxation are a temperature of 37±2° C. at 100% relative humidity or a temperature of 37±2° C. in water.

The dynamic viscosity of a fluid indicates its resistance to shearing flows. The SI unit for dynamic viscosity is the Poiseuille (Pa·s). Dynamic viscosity is commonly given in units of centipoise, where 1 centipoise (cP) is equivalent to 1 mPa·s. Kinematic viscosity is the ratio of the dynamic viscosity to the density of the fluid; the SI unit is m2/s. Devices for measuring viscosity include viscometers and rheometers. For example, an MCR 301 rheometer from Anton Paar may be used for rheological measurement in rotation mode (PP-25, 50 s−1, 50-115° C., 3° C./min).

Determining the water content when fully saturated at use temperature can comprise exposing the polymeric material to 100% humidity at the use temperature (e.g., 40° C.) for a period of 24 hours, then determining water content by methods known in the art, such as by weight.

In some embodiments, the presence of a crystalline phase and an amorphous phase provides favorable material properties to the polymeric materials. Property values of the cured polymeric materials can be determined, for example, by using the following methods:
flexural modulus, remaining flexural stress, and stress relaxation properties can be assessed using an RSA-G2 instrument from TA Instruments, with a 3-point bending, according to ASTM D790; for example, stress relaxation can be measured under static conditions at a loading rate of 32 mm/min and a strain of 5% at 30° C. and submerged in water, and reported as the remaining load after 24 hours, as either the percent (%) of initial load, and/or in MPa;
storage modulus can be measured at 37° C. and is reported in MPa;
glass transition temperature (Tg), melting temperature (Tm), and crystallization temperature of the cured polymeric material can be assessed using dynamic mechanical analysis (DMA). Tg is provided herein as the tan δ peak;
tensile modulus, tensile strength, elongation at yield and elongation at break can be assessed according to ISO 527-2 5B; and tensile strength at yield, elongation at break, tensile strength, and Young's modulus can be assessed according to ASTM D1708;
molecular weight can be measured by size exclusion chromatography or gel permeation chromatography.

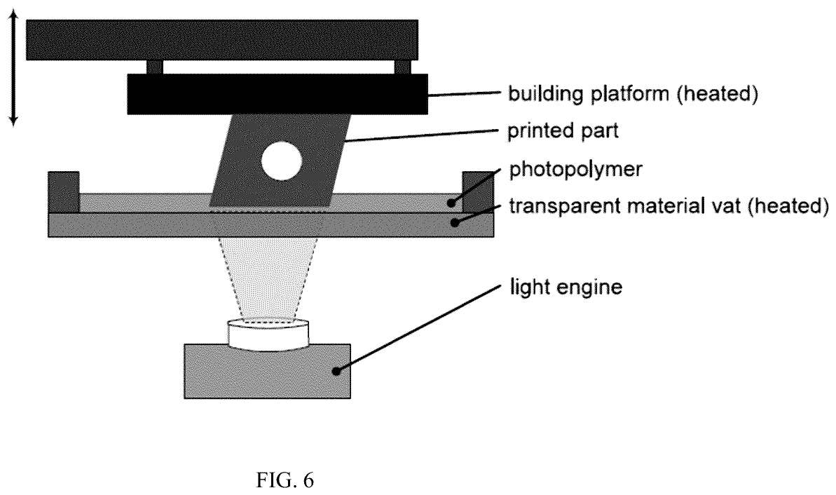

Additive manufacturing or 3D printing processes for generating a device herein (e.g., an orthodontic appliance) can be conducted using a Hot Lithography apparatus prototype from Cubicure (Vienna, Austria), which can substantially be configured as schematically shown in FIG. 6. In such cases, a curable composition (e.g., resin) according to the present disclosure can be filled into the transparent material vat of the apparatus shown in FIG. 6, which vat can be heated to 90-110° C. The building platform can be heated to 90-110° C., too, and lowered to establish holohedral contact with the upper surface of the curable composition. By irradiating the composition with 375 nm UV radiation using a diode laser from Soliton, which can have an output power of 70 mW, which can be controlled to trace a predefined prototype design, and alternately raising the building platform, the composition can be cured layer by layer by a photopolymerization process according to the disclosure, resulting in a polymeric material according to the present disclosure.

### EXAMPLES

The following examples are given for the purpose of illustrating various embodiments of the invention and are not meant to limit the present disclosure in any fashion. The present examples, along with the methods described herein are presently representative of some embodiments, are exemplary, and are not intended as limitations on the scope of the invention. Changes therein and other uses which are encompassed within the spirit of the invention as defined by the scope of the claims will occur to those skilled in the art.

### Example 1

Examples of diene or dithiol monomers of structures (IB) according to the present disclosure are synthesized according to Scheme 3:

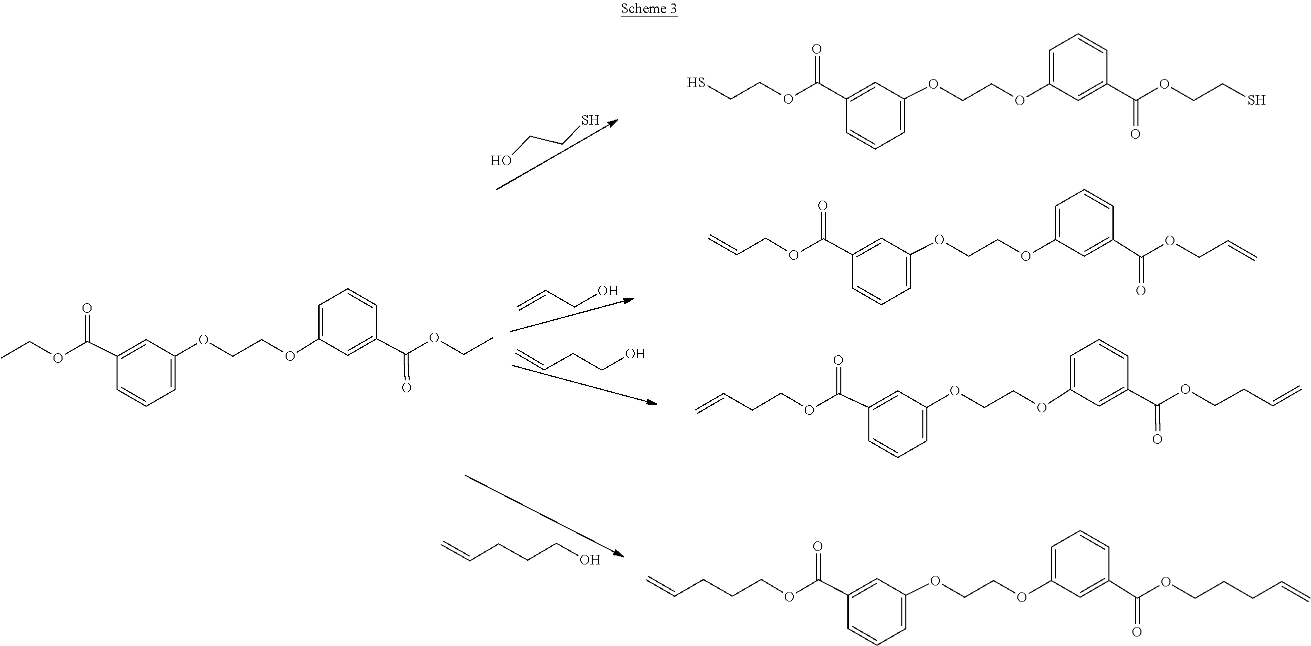

### Example 2

The effects of asymmetrical monomer structures on the crystallinity of resulting polymeric materials were studied by evaluating physical properties of homopolymers formed from the corresponding monomers, including flexural modulus, glass transition temperature (Tg), crystalline temperature (Tc), and melting temperature (Tm). The results are summarized in Table 5, and compared with a control diene monomer, diallyl terephthalate.

TABLE 5

| | Flexural | Working | | | |
|---|---|---|---|---|---|
| | Modulus | Range | Tg | Tc | Tm |
| Monomer | (MPa @ h) | (%) | (° C.)* | (° C.)* | (° C.)* |
| 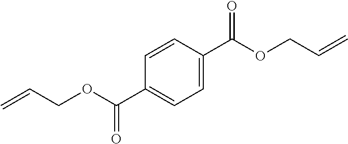 [SMILES: C=CCOC(=O)c1ccc(C(=O)OCC=C)cc1] | 67.07 @ 0 h 41.83 @ 0 h | 2.6 | −29 | 20.9 | 63.2 |
| Diallyl Terephthalate (Control) | | | | | |
| 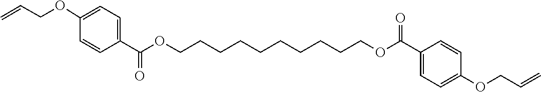 [SMILES: C=CCOc1ccc(C(=O)OCCCCCCCCCCOC(=O)c2ccc(OCC=C)cc2)cc1] | 210.67 @ 0 h 168.13 @ 7 h | 3.7 | −17 | 21 35 | 88.8 |
| 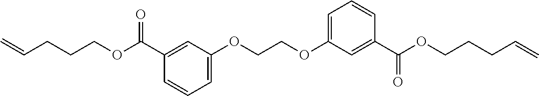 [SMILES: C=CCCCOC(=O)c1cccc(OCCOc2cccc(C(=O)OCCCC=C)c2)c1] | 130.37 @ 0 h 95.09 @ 7 h | 3.51 | −8.7 | 18.5 | 83.9 |
| 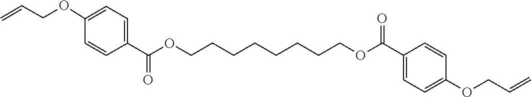 [SMILES: C=CCOc1ccc(C(=O)OCCCCCCCCOC(=O)c2ccc(OCC=C)cc2)cc1] | 115.00 @ 0 h 76.51 @ 7 h | 2.88 | −18.8 | 10.3 | 64 |
| 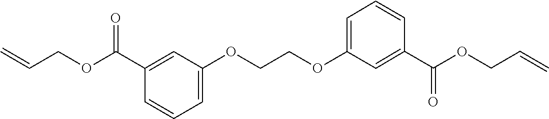 [SMILES: C=CCOC(=O)c1cccc(OCCOc2cccc(C(=O)OCC=C)c2)c1] | 80.66 @ 0 h 53.13 @ 7 h | 3.23 | −6.4 | −4.2 10.6 | 71.2 |
| 1.46 wt % added crosslinker | | | | | |
| 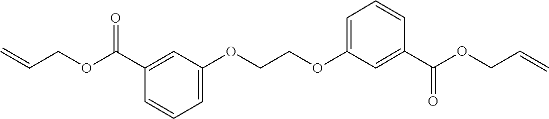 [SMILES: C=CCOC(=O)c1cccc(OCCOc2cccc(C(=O)OCC=C)c2)c1] | 38.43 @ 0 h 18.16 @ 7 h | 2.03 | −6.3 | −1.3 | 58.2 |
| 2.95 wt % added crosslinker | | | | | |
| 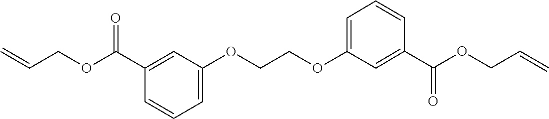 [SMILES: C=CCOC(=O)c1cccc(OCCOc2cccc(C(=O)OCC=C)c2)c1] | / | / | −5.4 | 38.5 10.0 | 92.2 76.9 |
| 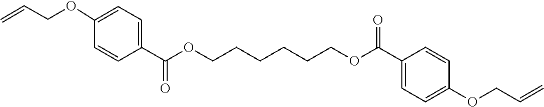 [SMILES: C=CCOc1ccc(C(=O)OCCCCCCOC(=O)c2ccc(OCC=C)cc2)cc1] | 61.56 @ 0 h 39.84 @ 7 h | 2.76 | −14.4 | 5.8 | 51.7 |
| 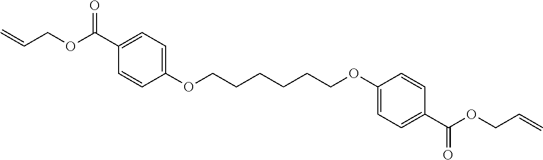 [SMILES: C=CCOC(=O)c1ccc(OCCCCCCOc2ccc(C(=O)OCC=C)cc2)cc1] | 48.52 @ 0 h 28.49 @ 7 h | 2.91 | −14.9 | 26.7 | 58.2 |
| 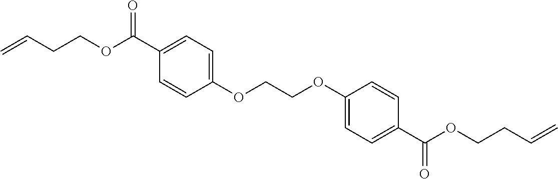 [SMILES: C=CCCOC(=O)c1ccc(OCCOc2ccc(C(=O)OCCC=C)cc2)cc1] | / | / | −16.7 | 30.9 4.2 | 92.8 81.9 |
| 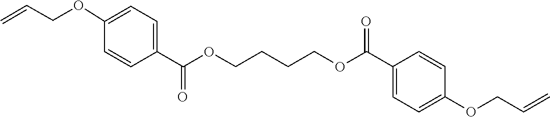 [SMILES: C=CCOc1ccc(C(=O)OCCCCOC(=O)c2ccc(OCC=C)cc2)cc1] | / | / | −14.6 | 56.1 | |
| 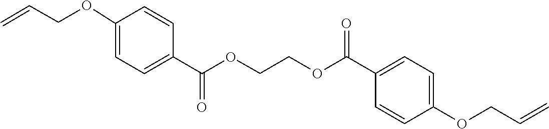 [SMILES: C=CCOc1ccc(C(=O)OCCOC(=O)c2ccc(OCC=C)cc2)cc1] | / | / | −15 | / | / |

*Tg, Tc, and Tm were measured using DSC at a heating rate of 10 °C./min

### Example 3

The effect of crosslinking density on the crystallinity of polymers formed from an asymmetric diene monomer of structure (IC) was studied by varying the amount of the crosslinker, triallyl isocyanurate. The Tg, Tc, and Tm of the resulting polymers were measured using DSC at a heating rate of 10° C./min, and the results are summarized in Table 6.

TABLE 6

| | | Tg | Tc | Tm |
|---|---|---|---|---|
| # | Formulation | (° C.) | (° C.) | (° C.) |
| 1 | Crosslinker (0 wt %) | −5.4 | 38.46 | 76.93 |
| | Diene (100 mol %) | | 10.04 | 92.24 |
| | Dithiol (100 mol %) | | | |
| 2 | Crosslinker (1.46 wt %) | −6.4 | 4.22 | 71.2 |
| | Diene (5.09 mol % of active ene groups) | | 10.6 | |
| | Dithiol (5.09 mol % of active thiol groups) | | | |
| 3 | Crosslinker (2.95 wt %) | −6.3 | −1.29 | 65.02 |
| | Diene (10.1 mol % of active ene groups) | | | |
| | Dithiol (10.1 mol % of active thiol groups) | | | |

In Table 6, the crosslinker has the following structure:

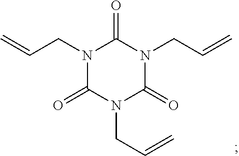 [SMILES: C=CCn1c(=O)n(CC=C)c(=O)n(CC=C)c1=O]

the diene is a monomer of structure (IC) having the following structure:

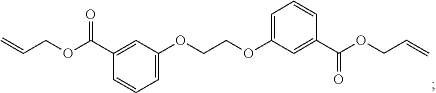 [SMILES: C=CCOC(=O)c1cccc(OCCOc2cccc(C(=O)OCC=C)c2)c1]

and
the dithiol has the following structure:

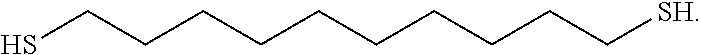 [SMILES: SCCCCCCCCCCS]

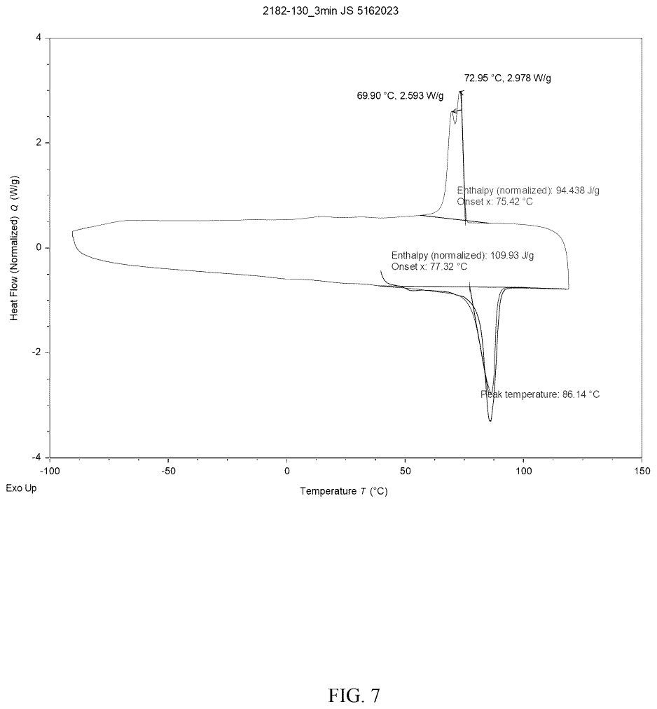

The effect of crosslinking density on the crystallinity of polymers derived from an asymmetric alkylene thiol-ene monomer, 9-decene-1-thiol, was studied by varied the amount of the crosslinker, pentaerythritol tetrakis(3-mercaptopropionate) (PETMP). The Tc and Tm of the resulting polymers were measured using DSC at a heating rate of 10° C./min, and the results are summarized in Table 7. FIG. 7 shows a DSC thermogram of a homopolymer of 9-decene-1-thiol. The Tc and Tm determined from the DSC heat flow curve of FIG. 7 are 73° C. and 86° C., respectively.

TABLE 7

| # | Formulation | Tc (° C.) | Tm (° C.) |
|---|---|---|---|
| 1 | 9-decene-1-thiol | 73 | 86-87 |
| 2 | 9-decene-1-thiol + | 73 | 87 |
| | 1 wt % PETMP | | |
| 3 | 9-decene-1-thiol + | 69.5 | 85.3 |
| | 5 wt % PETMP | | |

In Table 7, 9-decene-1-dithiol has the following structure:

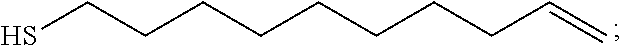

and
PETMP has the following structure:

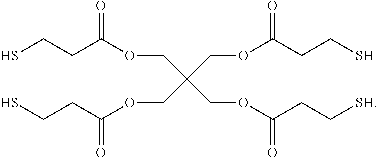 [SMILES: O=C(CCS)OCC(COC(=O)CCS)(COC(=O)CCS)COC(=O)CCS]

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A curable composition comprising a monomer having the following structure (I): 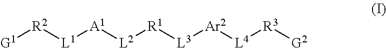
wherein:
Ar¹ and Ar² are independently an arylene or heteroarylene group;
L¹ and L² are independently an ether or ester linkage;
L³ and L⁴ are independently an ether or ester linkage;
R¹ is an alkylene, cycloalkylene, heteroalklyene or heteroatomic linker, wherein the alkylene or heteroalkylene is optionally interrupted by —OC(O)O—, —C(O)—, —C(O)O—, arylene or heteroarylene;
R² and R³ are independently an optional alkylene or heteroalkylene linker; and
G¹ and G² are independently a reactive functional group comprising an ethylenically unsaturated moiety or a thiol moiety.

2. The curable composition of claim 1, wherein:
(A) Ar¹ and Ar² are independently phenylene, naphthalene, thienylene or furanylene;
(B) L¹ and L² are each an ester linkage, L¹ is an ether linkage and L² is an ester linkage, or L¹ is an ester linkage and L² is an ether linkage; and
(C) L³ and L⁴ are each an ester linkage, L³ is an ether linkage and L⁴ is an ester linkage, or L³ is an ester linkage and L⁴ is an ether linkage.

3.-10. (canceled)

11. The curable composition of claim 2, wherein Ar¹ and Ar² are each phenylene and L¹, L², L³, and L⁴ are each an ester linkage, the monomer having the following structure (IA):

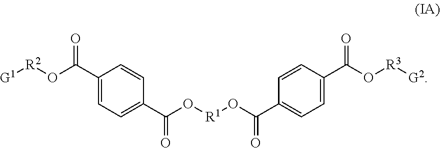

12. The curable composition of claim 2, wherein Ar¹ and Ar² are each phenylene, L¹ and L⁴ are each an ether linkage, and L² and L³ are each an ester linkage, the monomer having the following structure (IB):

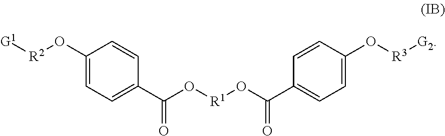

13. The curable composition of claim 2, wherein Ar¹ and Ar² are each phenylene, L¹ and L⁴ are each an ester linkage, and L² and L³ are each an ether linkage, the monomer having the following structure (IC):

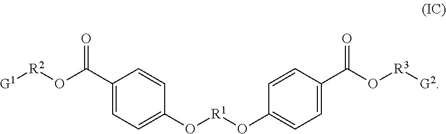

14. (canceled)

15. The curable composition of claim 1, wherein R¹ has one of the following structures:
—(CH₂)ₓ—; —(CH₂)_{y}—O—(CH₂)_{z}—; —(CH₂)_{y}—S—(CH₂)_{z}—; 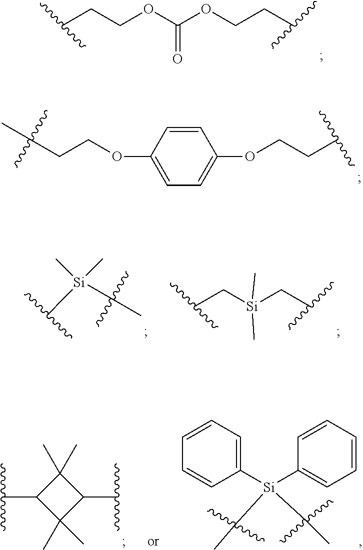
wherein x, y and z are independently an integer from 1 to 12.

16. The curable composition of claim 1, wherein R² and R³ independently have one of the following structures: 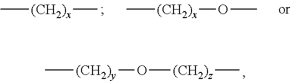
wherein x, y and z are independently an integer from 1 to 12.

17.-19. (canceled)

20. The curable composition of claim 1, wherein G¹ and G² independently have one of the following structures: 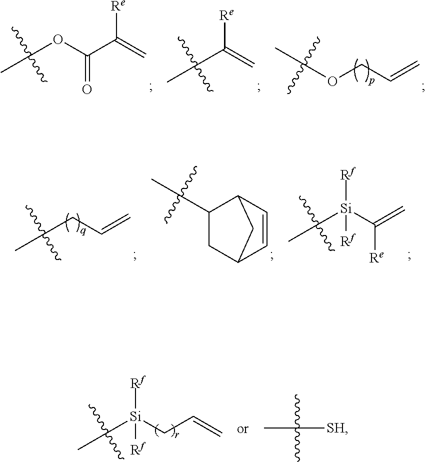
wherein:
R^{e}, at each occurrence, independently H, halogen or C₁-C₃ alkyl;
R^{f}, at each occurrence, independently H, halogen, C₁-C₃ alkyl, C₁-C₆ alkoxy and aryl; and
p, q and r are independently an integer from 1 to 6.

21.-23. (canceled)

24. The curable composition of claim 1, wherein the monomer of structure (I) is a compound having one of the following structures: 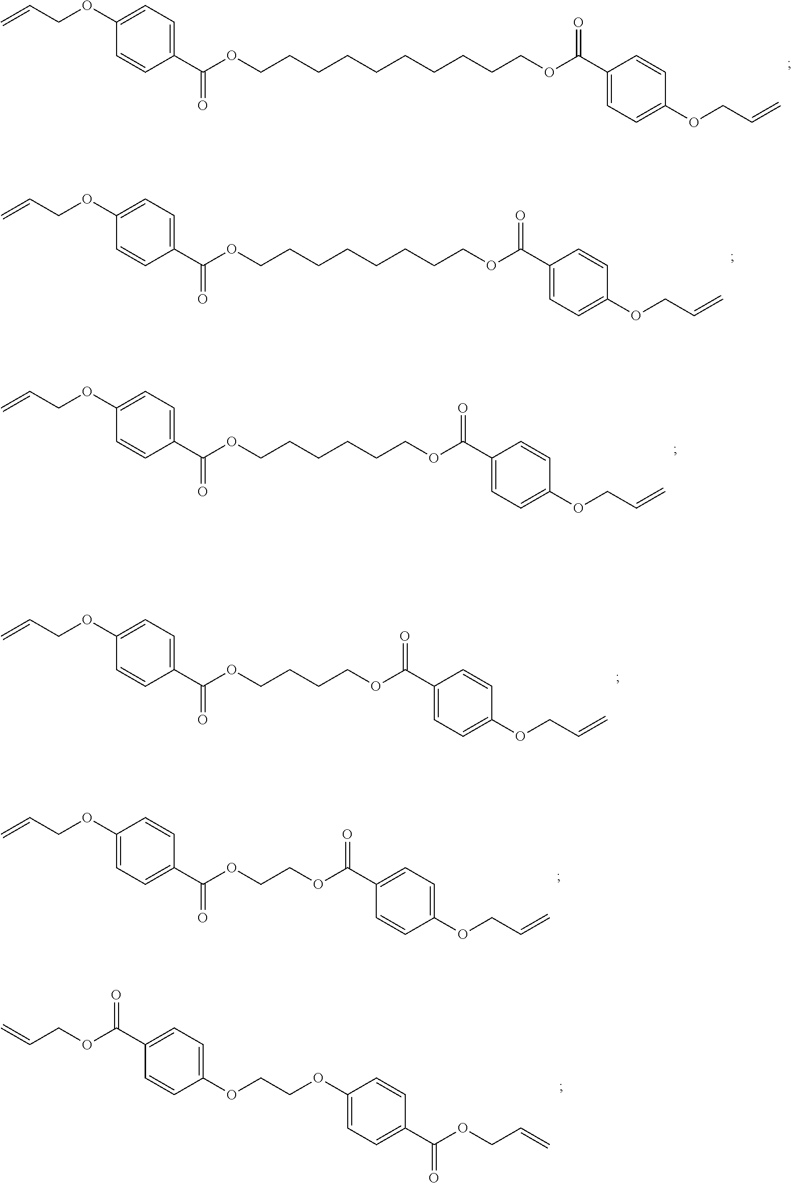 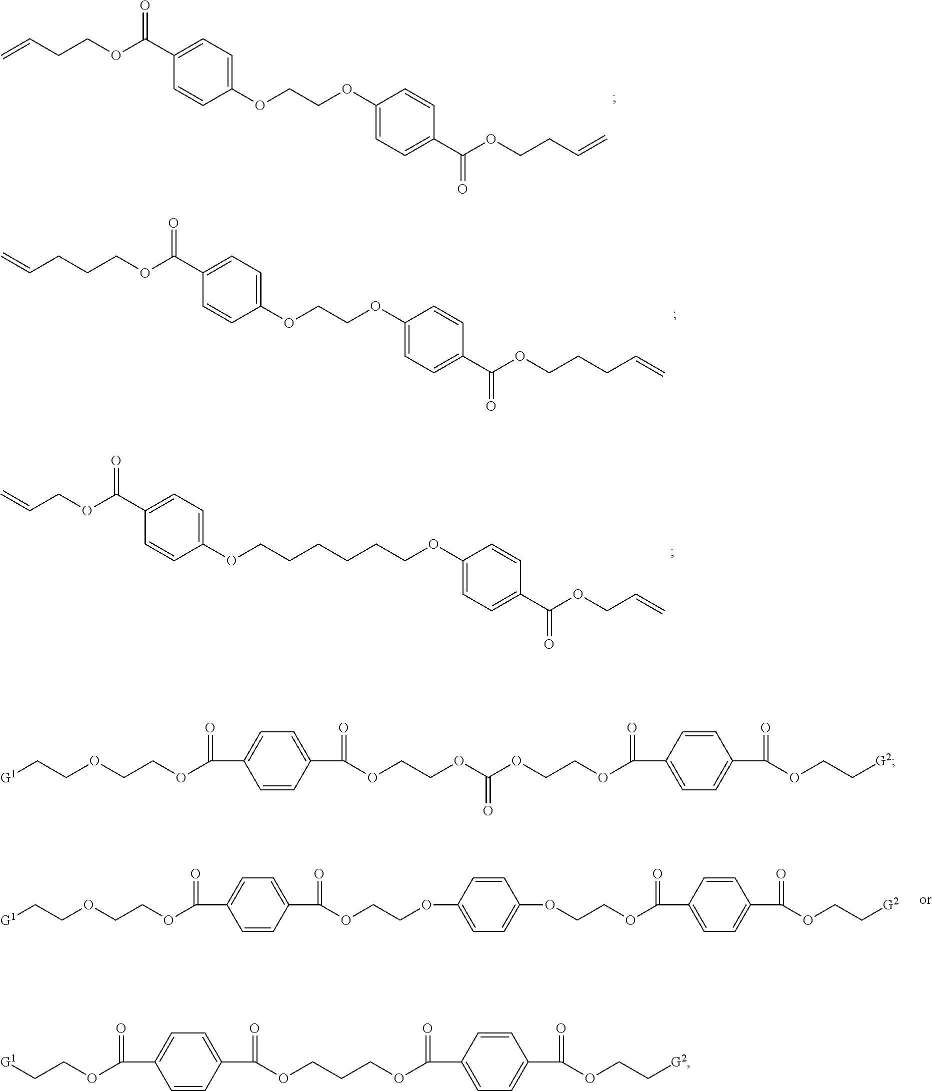
wherein G¹ and G² are 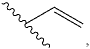 [SMILES: *C=C]
G¹ and G² are —SH, or G¹ is 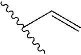 [SMILES: *C=C]
and G² is —SH.

25. The curable composition of claim 1, further comprising a monomer having the following structure (II): 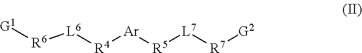
wherein:
Ar is an arylene or heteroarylene group;
R⁴ and R⁵ are independently an optional alkylene linker;
L⁶ and L⁷ are independently a carbonate, ether, or ester linkage;
R⁶ and R⁷ are independently an optional alkylene or heteroalkylene linker, wherein the alkylene or heteroalkylene is optionally interrupted by —OC(O)O—, —C(O)— or —C(O)O—; and
G¹ and G² are independently a reactive functional group comprising an ethylenically unsaturated moiety or a thiol moiety.

26. The curable composition of claim 25, wherein:
(A) Ar is phenylene, naphthalene, thienylene or furanylene;
(B) R⁴ and R⁵ are each a direct bond or R⁴ and R⁵ are each a linear or branched C₁₋₁₂ alkylene; and
(C) R⁶ and R⁷ independently have one of the following structures:
—(CH₂)ₓ—; —(CH₂)_{y}—O—(CH₂)_{z}—; 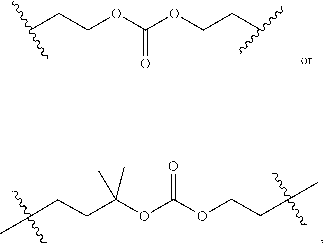
wherein x, y and z are independently an integer from 1 to 12.

27.-30. (canceled)

31. The curable composition of claim 26, wherein Ar is phenylene, R⁴ and R⁵ are each a direct bond, and L⁶ and L⁷ are each an ester linkage, the monomer having the following structure (IIA):

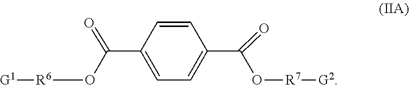

32. The curable composition of claim 26, wherein Ar is phenylene, R⁴ and R⁵ are each a direct bond, and L⁶ and L⁷ are each an ether linkage, the monomer having the following structure (IIB):

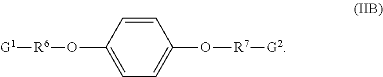

33. The curable composition of claim 26, wherein Ar is phenylene, R⁴ and R⁵ are independently an optionally substituted linear or branched C₁₋₄ alkylene, and L⁶ and L⁷ are each a carbonate linkage, the monomer having the following structure (IIC):

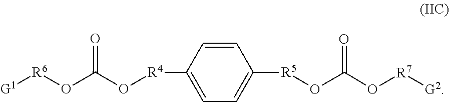

34.-41. (canceled)

42. The curable composition of claim 25, wherein the monomer of Structure (II) is a compound having one of the following structures: 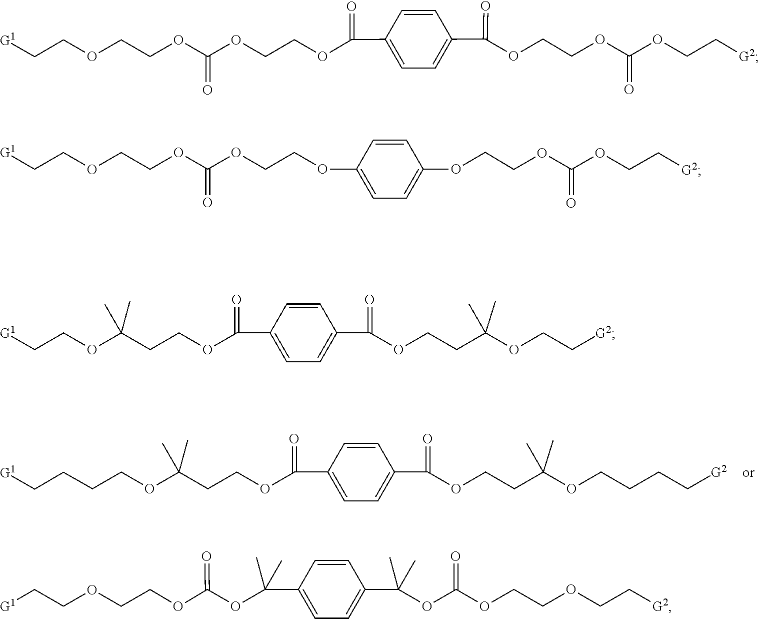
wherein G¹ and G² are 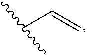 [SMILES: *C=C]
G¹ and G² are —SH, or G¹ is 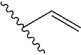 [SMILES: *C=C]
and G² is —SH.

43. (canceled)

44. The curable composition of claim 1, further comprising a monomer having the following structure (III): 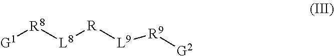
wherein:
R is an alkylene or heteroalkylene group;
L⁸ and L⁹ are independently an optional carbonate, ether, or ester linkage;
R⁸ and R⁹ are independently an optional alkylene or heteroalkylene linker; and
G¹ and G² are independently a reactive functional group comprising an ethylenically unsaturated moiety or a thiol moiety.

45. The curable composition of claim 44, wherein:
(A) R⁸ and R⁹ are each a direct bond, or R⁸ and R⁹ are independently C₁₋₁₂ alkylene; and
(B) R is an optionally substituted linear or branched C₁₋₁₂ alkylene.

46. (canceled)

47. The curable composition of claim 44, wherein L⁸ and L⁹ are each a carbonate linkage, and R⁸ and R⁹ are each a direct bond, the monomer having the following structure (IIIA):

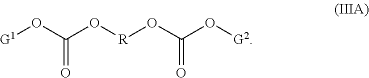

48. The curable composition of claim 44, wherein L⁸ and L⁹ are each an ether linkage, and R⁸ and R⁹ are each a direct bond, the monomer having the following structure (IIIB):

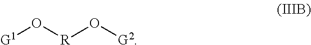

49.-57. (canceled)

58. The curable composition of claim 44, wherein the monomer of structure (III) is a compound having one of the following structures: 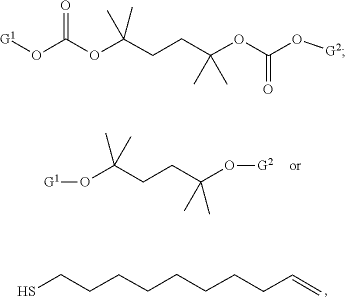
wherein G¹ and G² are 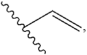 [SMILES: *C=C]
G¹ and G² are —SH, or G¹ is 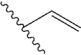 [SMILES: *C=C]
and G² is —SH.

59.-60. (canceled)

61. The curable composition of claim 1, further comprising at least one of:
a dithiol monomer, wherein the dithiol monomer is selected from an alkylene dithiol, a cycloalkylene dithiol, a heteroalkylene dithiol, an arylene dithiol, and a heteroarylene dithiol; and
a diene monomer, wherein the diene monomer is selected from an alkylene diene, a cycloalkylene diene, an heteroalkylene diene, an arylene diene, and a heteroarylene diene.

62. The curable composition of claim 61, wherein:
the dithiol monomer comprises 1,2-ethanedithiol (EDT), 1,3-propanedithiol, 1,4-butanedithiol, 1,5-pentanedithiol (PDT), 1,6-hexanedithiol (HDT), 1,10-decanedithiol (DDT), 2,2′-thiodiethanethiol (TDET), 2,2′-(ethylenedioxy)diethanethiol (EDDT), 1,4-bis(3-mercaptobutylyloxy)butane, poly(ethylene glycol) dithiol, or tetra(ethylene glycol) dithiol; and
the diene monomer comprises 1diallyl terephthalate (DAT), butanediol diacrylate, tricyclo[5.2.1.02.6]decanedimethanol diacrylate, poly(ethylene glycol) diacrylate, diallyl phthalate, diallyl maleate, trimethylolpropane diallyl ether, ethylene glycol dicyclopentenyl ether acrylate, diallyl carbonate, diallylurea, or 1,6-hexanediol diacrylate.

63.-68. (canceled)

69. The curable composition of claim 1, further comprising a reactive diluent, wherein the reactive diluent comprises homosalic methacrylate (HSMA), syringyl methacrylate (SMA), isobornyl methacrylate (IBOMA) or isobornyl acrylate (IBOA).

70.-83. (canceled)

84. A polymeric material formed from the curable composition of claim 1, wherein the polymeric material includes sulfur atoms incorporated into the polymer backbone.

85.-96. (canceled)

97. An orthodontic appliance comprising a polymeric material of claim 84.

98.-119. (canceled)
